(19) United States
(12) Patent Application Publication
(10) Pub. No.: US 2024/0051407 A1
(43) Pub. Date: Feb. 15, 2024

(54) INTEGRATED ELECTRIC CHARGING SYSTEMS AND METHODS OF OPERATING THEREOF

(71) Applicant: Electronic Grid Systems Inc., Edmonton (CA)

(72) Inventor: Zhongyi Quan, Edmonton (CA)

(21) Appl. No.: 18/448,191

(22) Filed: Aug. 11, 2023

Related U.S. Application Data
(60) Provisional application No. 63/396,977, filed on Aug. 11, 2022.

(51) Int. Cl. B60L 53/10; B60L 53/30; B60L 58/12; B60L 55/00; B60L 53/51; H02J 3/36; B60L 53/62; B60L 53/16

(52) U.S. Cl. CPC B60L 53/11; B60L 53/305; B60L 58/12; B60L 55/00; B60L 53/51; H02J 3/36; B60L 53/62; B60L 53/16; B60L 2210/30; B60L 2210/44

(57) ABSTRACT

Various example embodiments are provided herein relating to integrated electric charging systems and methods of operating thereof. In at least one example, there is provided an integrated electric charging system, comprising: an energy storage subsystem for storing direct current (DC) power; a charging subsystem coupled to the energy storage subsystem and comprising: a common DC bus; one or more power converters, each power converter having a DC side couplable to the common DC bus, the one or more power converters operable to maintain a voltage of the common DC bus at a pre-defined DC voltage level; and at least one operational switch interposed between the one or more power converters, wherein the operational switch varies an operational mode of the integrated charging system.

### CROSS-REFERENCE TO RELATED APPLICATIONS

This application claims the benefit of U.S. Provisional Patent Application No. 63/396,977, filed on Aug. 11, 2022. The entire contents of U.S. Provisional Patent Application No. 63/396,977 is hereby incorporated by reference.

### FIELD

The present disclosure generally relates to charging of electric devices and systems (e.g., electric vehicles), and in particular, to integrated electric charging systems and methods of operating thereof.

### BACKGROUND

The following is not an admission that anything discussed below is part of the prior art or part of the common general knowledge of a person skilled in the art.

Widespread adoption of electric vehicles (EVs), in recent years, has increased demand for supporting infrastructure. For this reason, EV charging stations are often commonly installed in various commercial locations, including public and private parking lots as well as many underground garages.

### SUMMARY OF THE VARIOUS EMBODIMENTS

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In at least one broad aspect, there is provided an integrated electric charging system, comprising: an energy storage subsystem for storing direct current (DC) power; a charging subsystem coupled to the energy storage subsystem and comprising: a common DC bus; one or more power converters, each power converter having a DC side couplable to the common DC bus, the one or more power converters being operable to maintain a voltage of the common DC bus at a pre-defined DC voltage level; and at least one operational switch interposed between the one or more power converters, wherein the operational switch varies an operational mode of the integrated charging system; and at least one port coupled to the charging subsystem and operable for discharging or receiving one or more of direct current (DC) and alternating current (AC) power.

In at least one example, the at least one port includes an AC port and one or more DC ports, wherein, the AC port is couplable to one of an AC power supply or AC load, and the one or more DC ports is couplable to one of a DC power supply or a DC load.

In at least one example, one or more DC ports include a charging DC port and a DC power sharing port.

In at least one example, the one or more power converters include at least one AC/DC converter, and one or more DC/DC converters.

In at least one example, the one or more power converters include at least one AC/DC converter, one or more first DC/DC converters and a second DC/DC converter.

In at least one example, the at least one AC/DC converter comprises an AC side and a DC side, wherein, the AC side is coupled to the AC port, and the DC side is coupled to the at least one operational switch.

In at least one example, the one or more first DC/DC converters comprises a first DC side and a second DC side, wherein, the first DC side is coupled to the common DC bus, and the second DC side is coupled to the charging DC port via a charger-specific DC bus.

In at least one example, the one or more first DC/DC converters comprise two or more first DC/DC converters each coupled to a respective charging DC port via the charger-specific DC bus.

In at least one example, a switch network couples together the charging-specific DC busses for one or more charging DC ports, and wherein, the switch network has a switch network configuration that is adjustable to re-route DC power from a second DC side of one or more of the plurality of first DC/DC converters to another charger-specific DC bus.

In at least one example, the one or more ports further includes a switch port coupled to the switch network, and the switch port is couplable to the switch network of other integrated electric charging systems.

In at least one example, the second DC/DC converter comprises a first DC side and a second DC side, wherein, the first DC side is coupled to the energy storage subsystem, and the second DC side is coupled to the common DC bus.

In at least one example, the operational switch is adjustable between a first closed position and a second closed position, wherein, in the first closed position, the operational switch couples the at least one AC/DC converter to the common DC bus; and in the second closed position, the operational switch couples the at least one AC/DC converter in parallel to the energy storage subsystem.

In at least one example, the system is operational in one of: (i) one or more DC charging modes, (ii) an AC charging mode, and (iii) a re-charging mode.

In at least one example, the one or more DC charging modes comprise: (i) a first DC charging mode using a high input AC voltage, and (ii) a second DC charging mode using a low input AC voltage mode.

In at least one example, in the first DC charging mode, the charging subsystem receives input AC power from the AC port, and discharges DC power from the one or more DC ports, the system operating in the first DC charging mode when the input AC voltage is above a pre-determined threshold.

In at least one example, the first DC charging mode, the operational switch is in the first closed position.

In at least one example, the first charging mode includes one or more configurations which use DC power stored in the energy storage subsystem to compensate for low input AC power.

In at least one example, in the second DC charging mode the charging subsystem discharges DC power from the one or more DC ports, the system being operated in the second DC charging mode when the input AC voltage is below a pre-determined threshold.

In at least one example, in the second DC charging mode the operational switch is in one of the second closed position or an open position.

In at least one example, in the AC charging mode, the charging subsystem discharges AC power from the at least one AC port.

In at least one example, the DC sharing port is coupled to external DC loads and DC power sources.

In at least one example, the DC sharing power couples the system to other integrated charging systems via a DC link to allow for DC power sharing.

In at least one example, the DC link is coupled to one or more photovoltaic (PV) systems.

In at least one example, the energy storage subsystem comprises one or more rechargeable battery cells.

In at least one example, the system further comprises a controller coupled to the one or more power converters and the at least one operational switch.

In another broad aspect, there is provided an integrated electric charging system, comprising: an energy storage subsystem for storing direct current (DC) power; a charging subsystem coupled to the energy storage subsystem and comprising: a common DC bus; one or more power converters, each power converter having a DC side couplable to the common DC bus, the one or more power converters being operable to maintain a voltage of the common DC bus at a pre-defined DC voltage level; and at least one operational switch interposed between the one or more power converters, wherein the operational switch varies an operational mode of the integrated charging system; and at least one port coupled to the charging subsystem and operable for discharging or receiving one or more of direct current (DC) and alternating current (AC) power; and a controller coupled to the one or more power converters and the at least one operational switch.

In another broad aspect, there is provided an integrated electric charging system, comprising: one or more energy storage subsystems for storing direct current (DC) power; a charging subsystem coupled to the one or more energy storage subsystems and comprising: a common DC bus; one or more power converters, each power converter having a DC side couplable to the common DC bus, the one or more power converters being operable to maintain a voltage of the common DC bus at a pre-defined DC voltage level; and at least one operational switch interposed between the one or more power converters, wherein the operational switch varies an operational mode of the integrated charging system; and at least one port coupled to the charging subsystem and operable for discharging or receiving one or more of direct current (DC) and alternating current (AC) power; and a controller coupled to the one or more power converters and the at least one operational switch.

In at least one example, the common DC bus comprises a stable DC voltage bus.

In at least one example, at least one energy storage subsystem of the one or more energy storage subsystems is coupled to the charging subsystem via the common DC bus.

In at least one example, the system is operable to inject power into an electric grid, wherein the electric grid comprises one of a single phase 240V supply and a three-phase supply supplying voltage operating in a range comprising of 120V to 600V.

In at least one example, the at least one port coupled to the charging subsystem comprises one or more AC ports and the system is operable to discharge AC power from at least one energy storage subsystem from the one or more energy storage subsystems to the electric grid via the one or more AC ports.

In at least one example, the at least one port coupled to the charging subsystem comprises one or more DC ports, and at least one DC port of the one or more DC ports comprises DC power sharing port coupled to one or more photovoltaic systems via a DC link.

In at least one example, the system is operable to draw DC power from a battery of an electric vehicle, convert the DC power via the one or more power converters and supply an AC power to an electric grid via the one or more AC ports.

In another broad aspect, there is provided a method for operating an integrated electric charging system comprising: determining if an input alternating current (AC) voltage is above a pre-determined threshold; and if the input AC voltage is above the pre-determined threshold, operating the integrated electric charging system in a high AC input voltage mode, otherwise, operating the integrated electric charging system in a low AC input voltage mode.

In at least one example, if the input AC voltage is above the pre-determined threshold, the method further comprises: determining if the input AC power level meets a power demand requirement; and if the input AC power level meets a power demand requirement, then operating the integrated charging system in an exclusive AC power supply configuration, otherwise, operating the integrated charging system in a configuration using more than one input power supply.

In at least one example, the input AC power level does not meet the power demand requirement, the method further comprises selecting a configuration that uses more than one input power supply based on one or more configuration selecting factors.

In at least one example, the configuration selecting factors comprise one or more of: (i) determining if there is sufficient power stored in a battery, of the integrated charging system, to supplement a deficiency in input AC power, (ii) determining whether the battery is depleted, and (iii) determining whether a DC port, of the integrated charging system, is coupled to any DC power supplies.

In at least one example, operating the integrated electric charging system in a low AC input voltage mode, further comprises: determining if input AC power is available; and if input AC power is available, then operating the integrated charging system in an input AC supply configuration, otherwise, operating the integrated charging system in a non-AC power supply configuration.

In at least one example, the method further comprises: selecting one of the input AC supply configurations and the non-AC power supply configurations, based on one or more configuration selection factors.

In at least one example, the method further comprises: operating the integrated charging system in an initial configuration mode; monitoring input AC supply parameters for an input AC power supply coupled to the integrated charging system; in response to detecting a change in the input AC voltage, modifying an operational mode of the integrated charging system; and in response to detecting a change in one or more of the input AC power supply and output power demand: selecting an updated configuration for the integrated charging system; and operating the integrated charging system in the updated configuration mode.

In at least one example, the method is performed in real-time or near real-time.

In at least one example, the method further comprises: monitoring for an activation condition for activating an AC charging mode for the integrated charging system; in response to detecting the activation condition, selecting an AC charging mode configuration; and operating the integrated charging system in the selected AC charging mode configuration.

In at least one example, the method further comprises: monitoring a battery state of an energy storage subsystem of the integrated charging system; in response to determining the battery state is below a pre-determined threshold, selecting a configuration for a battery re-charging mode for the integrated charging system; and operating the integrated charging system in the selected configuration.

In at least one example, the method further comprises: operating the integrated charging system in an initial configuration mode that does not use DC power sharing; monitoring for a trigger event for DC power sharing; and in response to detecting the trigger event, operating the integrated charging system in an updated configuration corresponding to a DC power sharing mode.

In another broad aspect, there is provided an integrated electric charging system, comprising two or more electric charging systems according to the embodiments described herein, wherein the DC common bus of each of the two or more electric charging systems couples to the DC common bus one or more other electric charging systems.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is example environment for electric vehicle (EV) charging;

FIG. 1B is a simplified block diagram of an example EV charging system;

FIG. 2A is another example EV charging system;

FIG. 2B is still another example EV charging system;

FIG. 3A is an example integrated electric charging system, in accordance with the teachings herein;

FIG. 3B is an example integrated electric charging system, coupled to one or more external energy sources and/or loads;

FIG. 4A is an example simplified hardware circuit architecture for an integrated electric charging system;

FIG. 4B is another example simplified hardware circuit architecture for an integrated electric charging system;

FIG. 4C is another example simplified hardware circuit architecture for an integrated electric charging system;

FIG. 4D is another example simplified hardware circuit architecture for an integrated electric charging system;

FIGS. 5A-5Y show different configurational modes for the integrated electric charging system of FIGS. 4A and 4B;

FIGS. 5Z-5AA show different configurational modes for the integrated electric charging system of FIG. 4D;

FIGS. 6A and 6B show different example input alternating current (AC) voltages received at an AC port of an integrated charger;

FIG. 7A is a simplified hardware circuit architecture for another example integrated charger;

FIG. 7B is a simplified hardware circuit architecture for still another example integrated electric charging system;

FIG. 7C is a simplified hardware circuit architecture for still yet another example integrated electric charging system;

FIG. 7D is a simplified hardware circuit architecture for another example integrated electric charging system;

FIG. 7E is a simplified hardware circuit architecture for another example integrated electric charging system;

FIG. 8A is an example method for operating an integrated charger in one or more DC charging modes;

FIG. 8B is an example method for dynamically modifying the configuration mode of an integrated charger;

FIG. 8C is an example method for operating an integrated charger in an AC charging mode;

FIG. 8D is an example method for operating an integrated charger in a battery re-charging mode;

FIG. 8E is an example method for operating the integrated charger in a DC power sharing configuration;

FIG. 8F is an example method for operating the integrated charger in one or more operation modes;

FIG. 9A is a schematic diagram for an example multi-integrated electric charging system;

FIG. 9B is a schematic diagram for another example multi-integrated electric system;

FIG. 9C is a simplified block diagram for an example multi-integrated electric charging system;

FIG. 9D shows the multi-integrated electric charging system of FIG. 9A, wherein each AC port, of each system, is coupled to a different AC power supply;

FIG. 9E is an example simplified hardware circuit architecture for the multi-integrated electric charging system of FIG. 9C;

FIG. 10 is a simplified hardware circuit architecture for an example integrated electric charging system, which includes a switch port;

FIG. 11A is a simplified block diagram for another example multi-integrated electric charging system;

FIG. 11B is simplified hardware circuit architecture for the multi-integrated electric charging system of FIG. 11A;

FIG. 11C shows an example configuration for hardware circuit architecture of FIG. 11B;

FIG. 12A is a simplified block diagram of still another example multi-integrated electric charging system;

FIG. 12B is a simplified block diagram of still yet another example multi-integrated electric charging system;

FIG. 13 is a process flow for an example method for operating multiple integrated charging systems;

FIG. 14A is an example multi-integrated electric charging system that directly connects solar panels in series to form a photovoltaic (PV) string;

FIG. 14B is another example multi-integrated electric charging system coupled to PV systems via power converters;

FIG. 14C is another example multi-integrated electric charging system coupled to solar PV systems;

FIG. 14D is another example multi-integrated electric charging system coupled to solar PV systems;

FIG. 15A is an example controller system for multiple integrated chargers;

FIG. 15B is another example controller system for multiple integrated chargers; and

FIG. 16 is a simplified block diagrams of an example integrated charger controller.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION

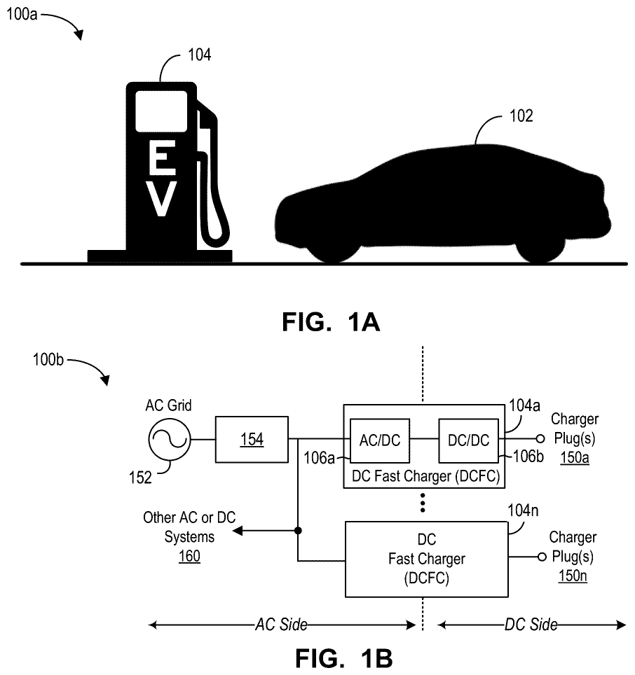

Reference is now made to FIG. 1A, which shows an example environment 100a for electric vehicle (EV) charging.

EVs 102 typically require re-charging for continued operation. Charging is enabled through EV charging infrastructure, including charging stations 104. Charging stations 104 are often located in public and private parking lots, including underground garages.

EV charging stations can be of different types, and include level ‘1’, level ‘2’ and level ‘3’ chargers. Different EVs can require different types of EV chargers depending on the EV's charging requirements, among other considerations. To this end, level ‘3’ EV chargers offer the greatest amount of charging power, and in the lowest time interval, and are typically used for fast EV charging. Level ‘3’ EV chargers are also known as direct current (DC) fast chargers (DCFCs).

Reference is now made to FIG. 1B, which shows a simplified hardware block diagram for a DCFC charging system 100b.

As shown, DCFC charging system 100b includes one or more DCFCs 104a-104n. Each DCFC 104 includes an associated charger plug 150a-150n. Charger plugs 150 electrically couple to EVs, such as EV 102.

In DCFC 104, charger plug 150 outputs direct current (DC) power to charge an EV 102. Other types of chargers, such as level ‘2’ chargers, alternatively output AC power.

In these cases, the AC power is received by the EV, and converted back into DC power by an AC/DC converter, located inside the EV.

In addition to outputting DC power, charger plug 150 can also receive and transmit data signals. For example, charger plug 150 can include data cables that enable communication with an on-board EV computer.

Examples of data signals received from an EV include, for instance, a request to charge the EV, as well as state data about the EV's battery state-of-charge (SoC). In contrast, examples of data signals transmitted to an EV from the DCFC 104, include various control and request signals. For example, DCFC 104 may request specific data from the on-board EV computer.

Each DCFC 104 can interface with an external AC power supply 152, such as an electrical distribution grid. AC power, from AC power supply 152, is converted into output DC power which is used by the DCFC 104.

In some examples, DCFC 104 couples to the AC grid 152, via a transformer subsystem 154. Transformer subsystem 154 is interposed between the AC grid 152 and the AC/DC converter 106a. Transformer subsystem 154 typically includes a service transformer and a breaker panel. The transformer 154 steps-down the voltage, from the high power grid, to a lower voltage more suitable for consumption by a DCFC 104. It is noted that in some cases the transformer may operate as a voltage adapter between two different low voltage levels, e.g. 480V to 600V.

The transformer subsystem 154 may not be necessarily unique to the charging system 100b. For example, transformer 154 may be installed inside a facility, and may service the entire facility (e.g., other AC or DC systems 160 inside the facility), in addition to servicing the DCFCs 104. In these cases, DCFCs 104 consumes a portion of the output power of the transformer 154.

Referring still to FIG. 1B, conventional DCFCs 104 include: (i) an AC/DC converter 106a, and (ii) a DC/DC converter 106b.

AC/DC converter 106a converts AC power into DC power, which is fed to the DC/DC converter 106b. In turn, DC/DC converter 106b boosts-up, or bucks-down the input DC voltage to accommodate the specific charging requirements of coupled EVs. Charger plug 150 outputs DC power generated by DC/DC converter 104a.

Here, it has been appreciated that conventional EV charging systems—such as the DCFC charging systems 104 exemplified in FIG. 1B—suffer from important drawbacks.

First, transformers 154 located inside the charging system 100b must be designed to accommodate for large fluctuations in peak power demand. More particularly, peak power demand fluctuates in response to the number of EVs 102 plugged-into DCFCs 104 (FIG. 1B), as well as the charging demands of each EV. A well-designed transformer 154 should accommodate for both the highest and lowest demand. Further, if the transformer 154 services other systems 160 concurrently, it must additionally accommodate these systems at the peak EV power demand level.

For newly built facilities, peak demand is easily accommodated by properly designing and sizing the transformer 154. In other words, transformer 154 is simply sized, and designed to accommodate for expected peak demand, based on the number of DCFCs 104 installed in the new building.

However, challenges emerge when new DCFCs 104 are installed in existing and old facilities. These facilities typically include pre-existing transformers 154, which are designed with limited capacity. Installing new DCFCs necessitates upgrading this existing service infrastructure, including upgrading the transformer. In particular, upgrading the transformers is necessary to accommodate for the higher peak demand caused by newly installed DCFCs.

Upgrading existing infrastructure is, nevertheless, an extremely costly undertaking. The probative high costs are owing primarily to the required civil construction work and new equipment required to undertake the upgrade. For example, upgrading existing infrastructure in a car parking lot, from 1,000 Amp to 2,000 Amp service, may cost up to a few hundred thousand dollars. In addition, the time required to complete construction work may vary between a few months to a few years to complete.

Problems with upgrading infrastructure also result from space constraints. For example, the electrical room in many car parking lots—where the service infrastructure is located—has limited physical space. This physical space does not accommodate for new or larger transformers. Accordingly, installing new DCFCs becomes impossible, as new transformers cannot fit into the electrical room.

In view of the foregoing, the first significant drawback of existing charging systems 100b is poor scalability for existing facilities. The poor scalability is a consequence of the high costs, long construction periods and space challenges required to upgrade underlying infrastructure to accommodate a larger number of DCFCs with higher peak power demand.

A second drawback is the additional cost to install new DCFCs in locations with unmatched AC grid voltages. For example, various jurisdictions (e.g., countries, regions and localities) designate different voltage levels to power different load types. For instance, in China, many locations include 220 V single phase voltage to service smaller loads. In contrast, larger loads may require three-phase 380V grid voltage, which are not available in all locations. Similarly, in the United States and Canada, single-phase 230V/240V grid voltage or three-phase 208V grid are common place to power small loads, while larger loads may require three-phase 480V grid voltage.

To this end, many DCFCs have higher power demands, and in turn, require three-phase input AC voltages, at a higher voltage level. For example, a DCFC may require 380V in China, 480V in the US, or 600V in Canada. Nevertheless, many installation locations do not offer these higher voltage supplies, and only provide lower voltage supplies. In view of this, installing DCFC chargers at these locations demands a new set of service infrastructure. This service infrastructure (e.g., transformer subsystem 154) functions to increase the low voltage supply, to a higher voltage supply. The higher voltage supply is then fed to the DCFC. As noted earlier, installing this new service infrastructure is expensive and costly.

A third drawback with existing DCFC systems is the difficulty in integrating these systems with level two ‘2’ AC chargers. While DCFCs output DC power, level ‘2’ AC chargers output AC power. Many commercial locations require both DCFCs and level ‘2’ AC chargers to satisfy both types of customers. The challenge, however, is that level ‘2’ AC chargers normally adopt lower voltages than DCFCs. For example, level ‘2” AC chargers typically adopt single-phase 220V, single-phase 230V/240V, or one phase of a three-phase 208V grid.

To mitigate this drawback, existing solutions simply install two sets of service infrastructure: one for DCFC, and another for level ‘2’ AC charging. Yet, to scale these solutions for more EVs, it is necessary to either: (i) upgrade both infrastructures for locations that already have both types of chargers, or otherwise (ii) add new infrastructure, and upgrade the existing infrastructure for locations that only have one voltage level. For either case, the cost is still prohibitively expensive.

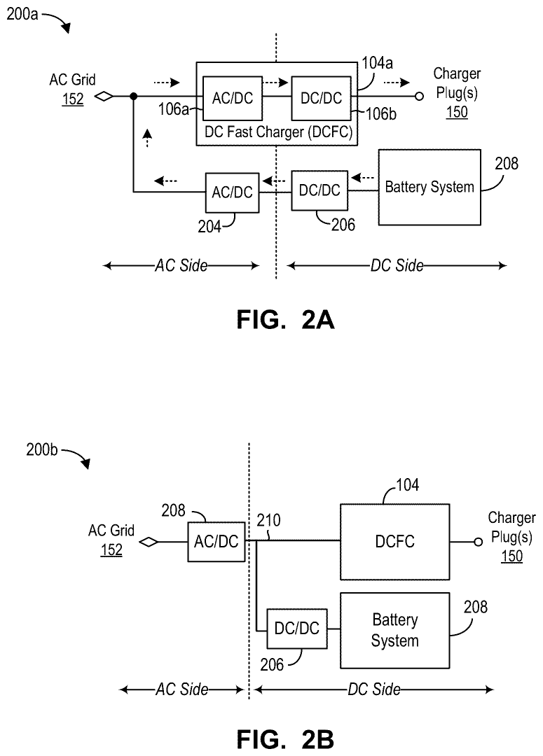

Reference is now made to FIGS. 2A-2B, which illustrate simplified block diagrams for further example hardware architectures for DC fast charging (DCFC) systems 200a-200b.

DCFCs 200a-200b represent example prior attempts at mitigating existing problems with the conventional DCFC architecture. As explained, these attempts also suffer from shortcomings, and still fall short of providing an ideal solution.

As shown, in both charging systems 200a-200b, a new battery system 208 is provided. Battery system 208 stores power and mitigates above-noted problems with existing DCFCs 104. In particular, when new DCFCs are installed in an existing facility—it is no longer necessary to incur costly upgrades to the service infrastructure (e.g., transformers) to accommodate larger peak power demand. Rather, in systems 200a, 200b, the battery 208 simply discharges stored power. The discharged power compensates for the sudden increases in power demand and reduces reliance on the AC grid infrastructure 152. Accordingly, battery 208 functions as a workaround to accommodate for larger peak demands consequent of new DCFC infrastructure.

FIG. 2A illustrates a first architecture using the battery 208. In this example, battery 208 couples to the DCFC 104 from the AC grid side, via two converters 204 and 206. The two converters include an AC/DC converter 204 which interfaces with the AC grid 152, as well as a DC/DC converter 206.

When battery system 208 is operated, the following power flow occurs: (i) DC power—stored in battery system 208—is boosted to higher DC voltage, via DC/DC converter 206, (ii) the output DC power is converted into AC power, via AC/DC converter 204, (iii) the AC power is converted back to DC power via AC/DC converter 106a, and (iv) the DC power is converted up, or down (as required) by DC/DC converter 106b to accommodate for the charging requirements of the EV, via charger plug 150.

Accordingly, during peak power demand—power is discharged from the battery 208, and circles around to discharge from charger plug 150.

Nevertheless, the key disadvantages of system 200a include: (a) low efficiency, (b) increased cost, (c) increased system footprint; and (d) narrow AC grid voltage range.

More particularly, the low efficiency results from the use of two AC/DC converters 106a, 204. That is, the power conversion chain includes a duplication of DC/AC and AC/DC conversion, using converters 106a, 204, each time the battery system 208 is operated. This results in an overall low conversion efficiency.

The duplication of DC/AC and AC/DC conversion also results in increased cost and footprint, which can be significant if the system capacity is large. The system footprint is normally large as a large centralized battery system 208 is often built within larger containers. The footprint is also increased due to the additional AC/DC converter 206.

Still further, system 200a typically requires higher AC voltages from the AC grid 152. This is to reduce the input AC current, as the power supply from battery 208 must be able to match the power required by DCFC 104. Accordingly, the AC coupled design is not usable with lower voltage, single phase grid supplies, or three-phase 208V grid supplies.

FIG. 2B illustrates an alternative architecture for a DCFC system 200b. System 200b alleviates some of the issues with the AC coupled design of system 200a. For example, the battery 208 and DCFC 104 are now coupled on the DC side. With DC coupling, only one AC-DC conversion stage 208 is required. That is, a common AC/DC converter 208 is now available for both the battery 208 and DCFC 104. Accordingly, the overall battery to DCFC 104 output conversion efficiency is improved.

Still, however, system 200b does not address all drawbacks. For example, system 200b still requires a higher AC voltage, from AC grid 152. This is because the DCFC 104 and the DC/DC battery converter 206, are coupled to a common DC bus 210. Common DC bus 208 must have a sufficiently high voltage, from the AC grid 152, if the charger 104 is to output high voltages, e.g., a standard 1,000V charging voltage. As noted previously, the higher AC voltage may not be available in all locations, depending on the geographic locality. Accordingly, if only a low AC grid voltage is available—the charger 104 may not be operational.

A further drawback of the system 200b is that the battery 208 is coupled externally. Therefore, a centralized design is still required for the battery system 208, and the footprint of the system cannot be reduced. Various designs bury the battery system 208 underground, which increases the maintenance costs and results in safety issues.

In view of the foregoing, there is a desire for a charging system that mitigates at least some of the shortcomings of conventional charging systems, including conventional DCFC charging systems. For example, there is a desire for a charging system that offers enhanced scalability, cost-effectiveness and an efficient DCFC architecture.

### I. General Overview of Example Integrated Electric Charging System

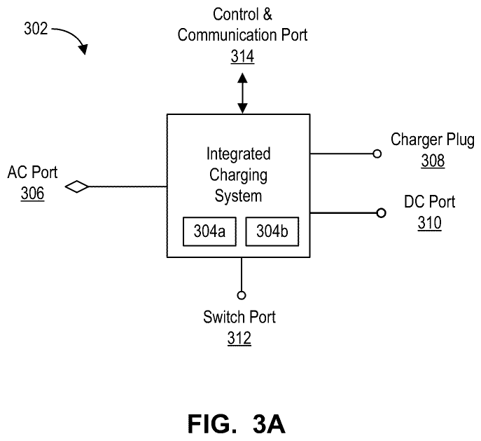

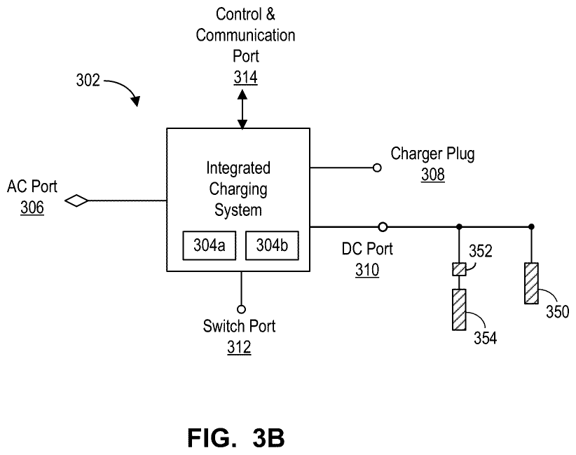

Reference is now made to FIG. 3A, which shows an example integrated electric charging system 302 (also referred to herein as integrated charger 302), in accordance with the teachings herein.

In some examples, integrated charger 302 is deployable at various locations where EV charging services may be required. For example, this includes commercial parking lots, underground parking lots, etc. Integrated charger 302 also has various other use applications, as discussed in greater detail herein.

At a general level, integrated charger 302 provides an integrated design combining: (i) a charging subsystem 304a, and (ii) an energy storage subsystem 304b (e.g., a battery system). Charging subsystem 304a enables AC and/or DC charging, while the energy storage subsystem 304b provides stored power for charging support (e.g., during peak power demand). In some embodiments, the integrated electric charging system 302 can discharge the stored power from the energy storage subsystem 304b and inject power to an electric grid and/or electrical grid supply (e.g., during outages or peak power demand).

In at least one example, subsystems 304a, 304b are integrated into a single hardware enclosure. In this manner, the system footprint is significantly reduced as contrasted to existing charging designs (FIGS. 2A-2B). That is, the energy storage or battery 304b is not located separately from the charging subsystem and does not necessarily occupy separate physical space. In other examples, however, the integrated charger may not be disposed in a single hardware enclosure.

As shown, integrated charger 302 can include one or more ports 306-314. Ports 306-314 enable interfacing integrated charger 302 with various external devices and systems. For example, at least some ports 306-310 enable AC and DC output charging. Other ports 310-312 enable power sharing, and greater scalability of the integrated charger 302.

In the illustrated example, integrated charger 302 includes five different port types. These port types include: (i) an AC port 306, (ii) a charger plug 308, (iii) a DC port 310, (iv) a switch port 312 and (v) a control and communication port 314 (also referred to herein simply as a control port 314).

While only a single instance of each port type is exemplified, in other examples, integrated charger 302 can include any number of each port type. Integrated charger 302 can also include less than the five port types. For example, the switch port 312 and/or control 314 port may not always be provided.

In more detail, AC port 306 couples the integrated charger 302 to external AC power supplies. The external AC supply can provide input AC power to the integrated charger 302, which is converted into output DC power charge. For example, AC port 306 can couple to an AC electric grid 152 (FIG. 1B). The connection to the AC grid can occur directly, or indirectly (e.g., via a transformer subsystem 154). For example, AC port 306 can connect directly (i.e., without transformer subsystem 154) to an AC electric grid 152 supplying a single phase 240V supply, a three-phase supply supplying voltage in the range of 120V to 600V or any other voltage supply that can be supplied by an AC electric grid 152.

In some examples, AC port 306 can also output AC power. For example, an AC load can couple to the AC port 306, to receive AC power therefrom. In one example application, AC port 306 can charge (or power) EVs compatible with level “2” AC charging systems. In another example, AC port 306 can supply AC power support to an electric grid or other AC power source, e.g., to accommodate for outages or peak demand.

Integrated charger 302 also includes the charger plug 308. Charger plug 308 is generally analogous to charger plug 150 (FIGS. 1A, and 2A-2B). Charger plug 308 can supply DC power to external DC systems. For example, charger plug 308 can couple to an EV, and supply DC power to charge the EV. In at least one example, charger plug accommodates a wide array of voltage and power output, such as to facilitate high-power DCFC charging. Charger plug 308 can also include one or more data communication links (e.g., cables) to receive and transmit data signals. For example, the data communication links can allow integrated charger 302 to communicate with an on-board EV computer to exchange data.

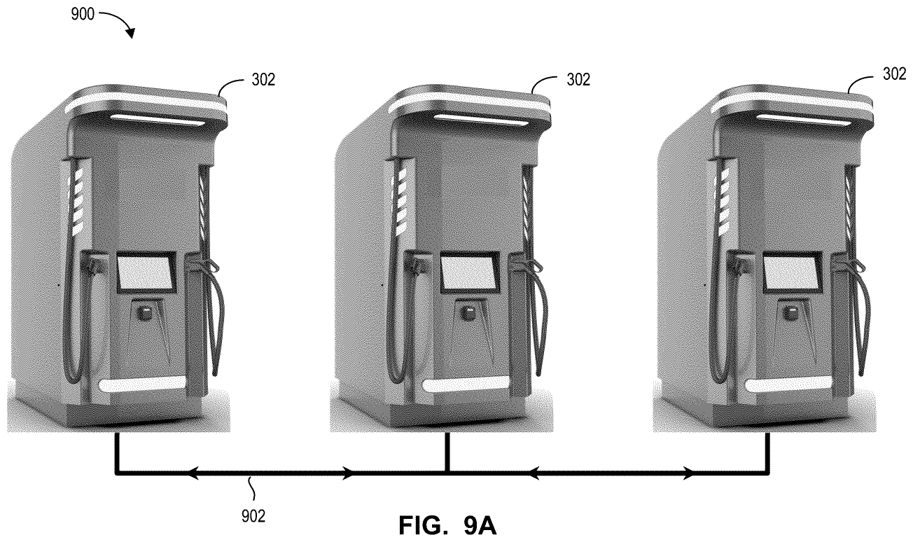

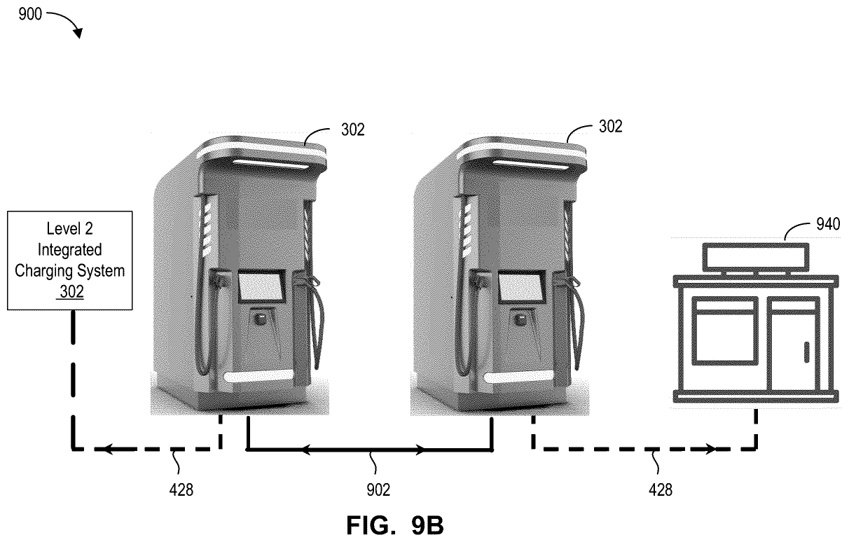

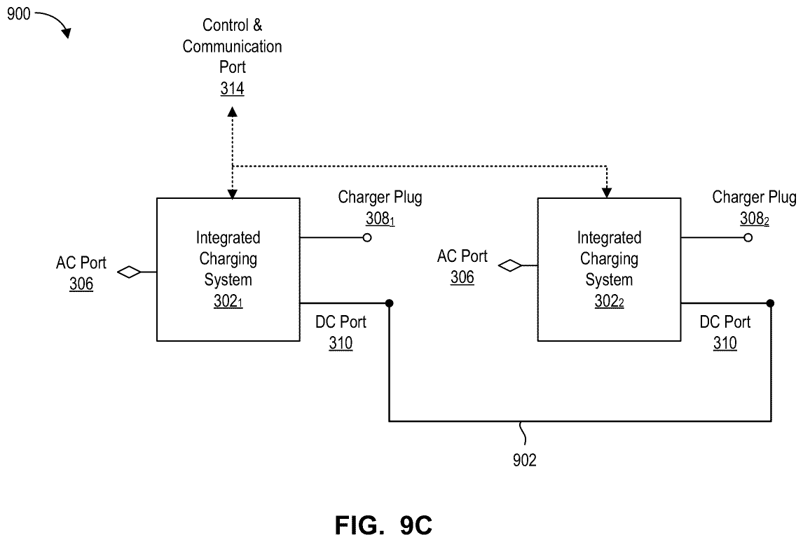

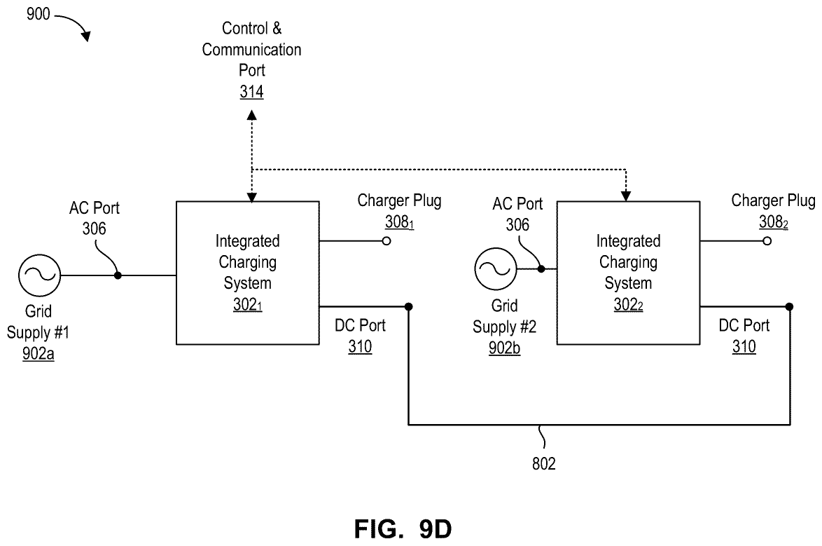

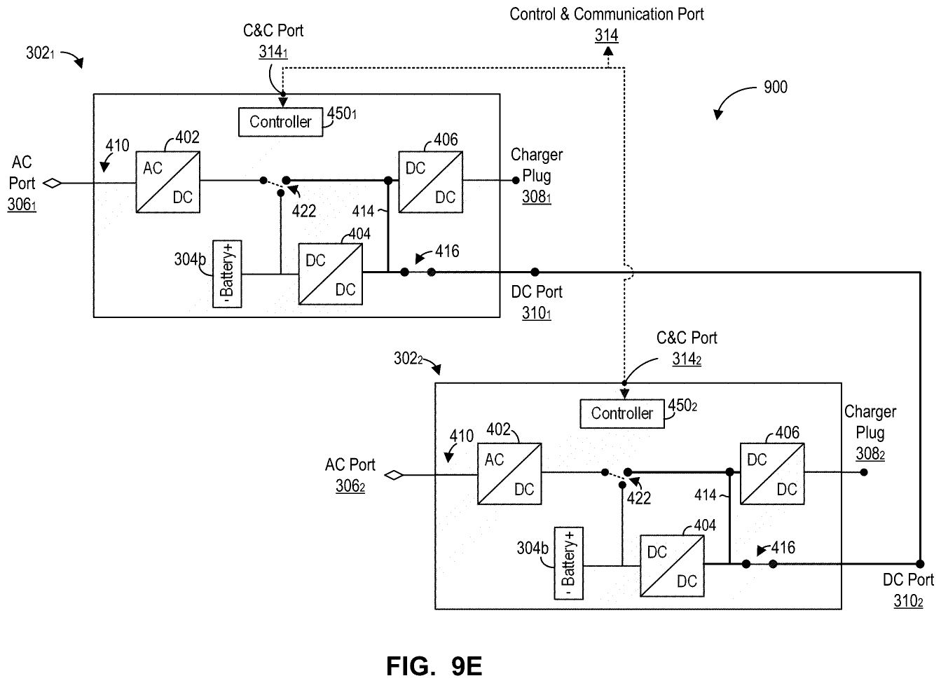

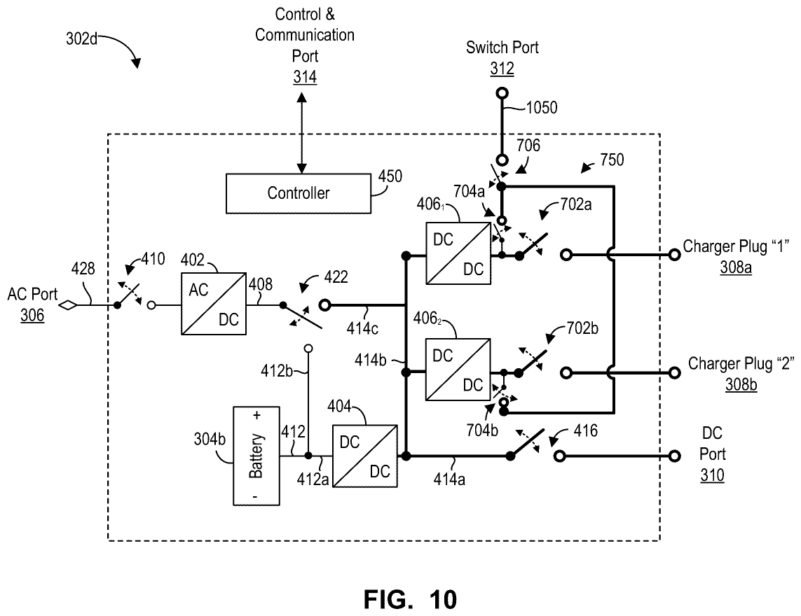

DC port 310 provides various power sharing functions. More generally, DC port 310 allows exchanging DC power between the integrated charger 302 and other external DC systems. For instance, DC port 310 can interface with other integrated chargers 302. In this manner, multiple integrated chargers 302 couple together via the DC port 310 for DC power sharing (see e.g., FIGS. 9A-9E, 11A-11B and 12A-12B). By way of example, one integrated charger 302 may not have sufficient power to accommodate DC or AC power charging. Accordingly, DC power flow can be received and shared from other integrated chargers 302 as back-up support.

DC ports 310 can also couple to other energy loads and source. For example, as shown in FIG. 3B, additional battery subsystems 304b can couple via the DC port 310. These battery subsystem 304b can provide additional stored, reserve energy to complement the battery subsystem 304b. Other types of systems that can couple to DC port 310 include solar photovoltaic (PV) sources 352, 354, as well as other power sources. In turn, this expands the energy capabilities of the integrated charger 302 to accommodate for greater peak power and energy demand.

In some examples, using the additional energy sources, the integrated charger 302 can also supply more energy to connected EVs and reduce the power demand from the electric grid. For example, the power from PV and battery can be combined to charge EVs so the power from the electric grid can be minimized.

Switch port 312 is also provided for additional power sharing functionality, as between multiple integrated chargers 302. Operation of the switch port 308 is explained in greater detail herein.

Control port 314 provides for an external control link. For instance, control port 314 can interface with an external controller, or otherwise a remote control system (e.g., an operator computer terminal). In some examples, control port 314 is used to receive control signals, for controlling operation of the integrated charger 302. Control port 314 can also transmit data signals. For instance, the transmitted data signals can include monitoring data, or otherwise various state data in respect of the integrated charger 302.

As explained below, a unique feature of the integrated charger 302 is that it has a variable hardware circuit configuration. In other words, the charger's circuit configuration is variably modified to operate in different modes and configurations. This allows the integrated charger 302 to accommodate different use applications and is contrasted to chargers defined by a static circuit configuration. To this end, the variable hardware configuration offers a number of appreciated advantages:

First, the variable configuration allows integrated charger 302 to accommodate different output charging requirements. For example, this includes different DC voltage and power charge level outputs (e.g., from charger plug 308 and/or DC port 310). For example, integrated charger 302 can accommodate different EVs, having different voltage and power demands. In one example, integrated charger 302 can effectively scale-up to function as a DCFC. Many conventional chargers may offer compatibility with only a single type of EV.

Second, the variable configuration allows integrated charger 302 to interface with both high and low input AC voltage supplies (i.e., at AC port 306). As noted earlier, a challenge with existing DCFC systems is they only operate with high input AC voltage supplies (e.g., 480V and 600V). However, depending on the locality, high input AC voltage supplies are not always readily available at all locations. This, in turn, necessitates costly upgrades to the existing service infrastructure to accommodate new DCFC installations. However, a unique feature of the integrated charger 302 is that the variable configuration enables integrated charger 302 to flexibly interface with both low and high AC supplies. The integrated charger 302 is therefore deployable in existing facilities with only low AC voltage supplies (e.g., 208V and 240V), without costly upgrades to the service infrastructure.

Third, using the variable configuration—integrated charger 302 can provide AC charging, in addition to DC charging. In the AC charging mode, charger 302 can also output AC power, from AC port 306. This is contrasted to existing systems which only operate in either AC or DC charging modes. In one example, the AC charging mode allows integrated charger 302 to effectively operate as a level “2” charger for compatible EVs. Accordingly, integrated charger 302 can provide combined, dual DC (e.g., DCFC) and level ‘2’ AC charging. This overcomes the need to install different DC and AC charging systems at the same location.

In other examples, the AC charging mode also enables charging of other types of AC systems, including an AC power grid. For example, if the AC port 306 is coupled to an AC grid—AC charging can provide AC grid support. In other words, integrated charger 302 can provide reverse, back-up support to the AC grid (e.g., in the case of a grid fault). In at least one example, the integrated charger 302 enables vehicle-to-grid (V2G) operation for reverse grid support. V2G allows charger 302 to draw DC power from an EV, and supply this back as AC power via AC port 306. Existing charging systems may not offer similar functionality.

Related to the variable hardware configuration, integrated charger 302 also provides more general appreciated advantages. For example, integrated charger 302 easily interfaces with other integrated chargers 302 via DC port 310 and/or switch port 312. In this manner, multi-integrated charger systems are possible. The multi-integrated charging systems facilitate easy, and cost-effective scalability. For example, if one integrated charger is unable to accommodate increased power demand, energy support from other integrated chargers in the system is available, and vice-versa.

Integrated charger 302 can also interface with other external DC loads and DC power supplies for similar power sharing schemes.

### II. Example Hardware Circuit Architectures for Integrated Charger

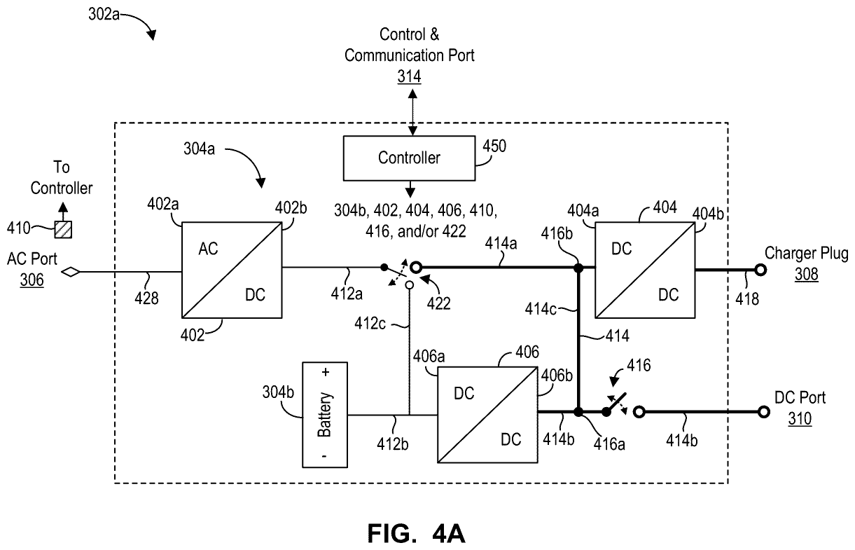

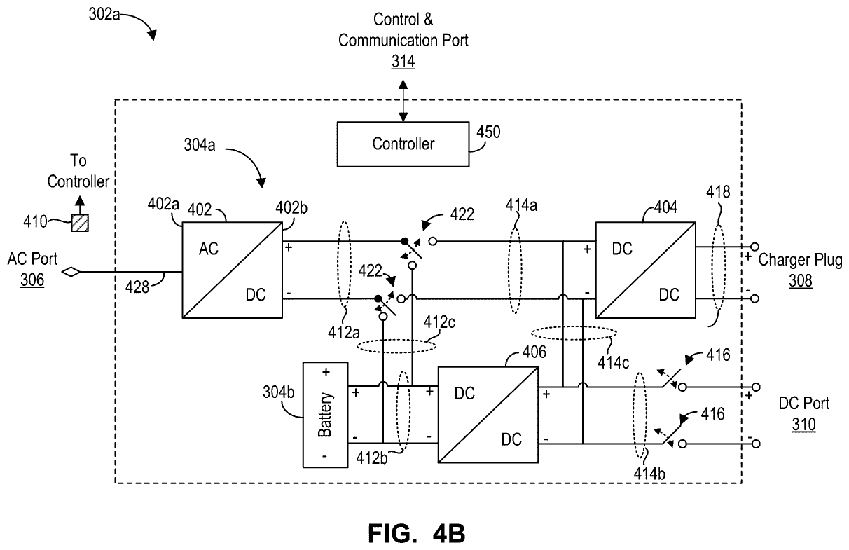

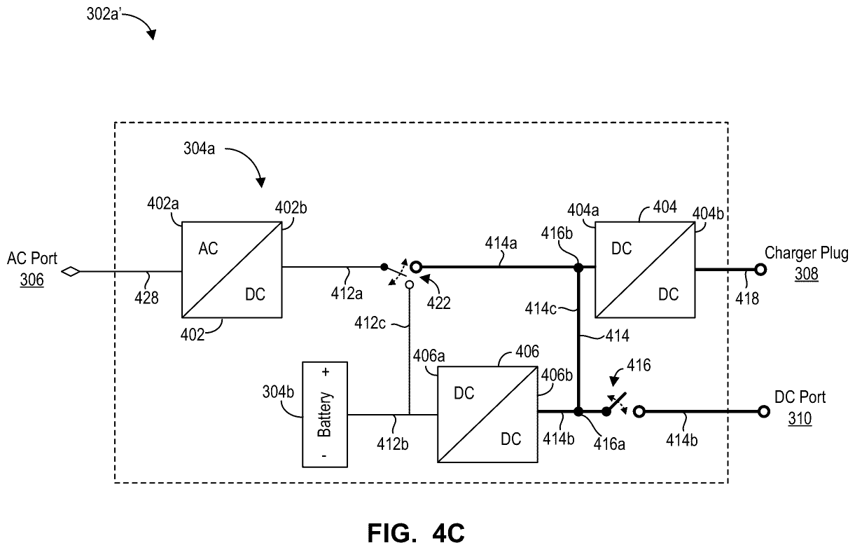

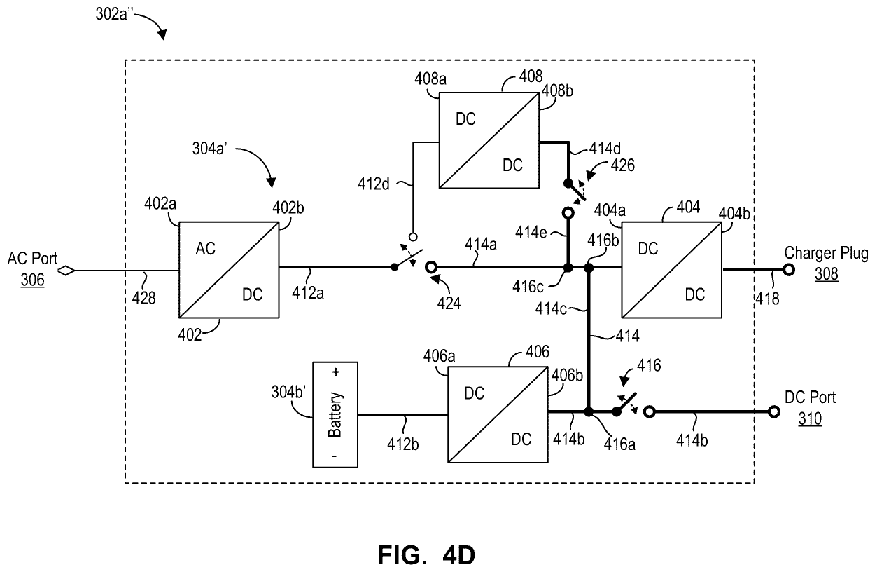

Reference is now made to FIG. 4A, which shows a simplified hardware circuit architecture for an example integrated electric charging system 302a. Concurrent reference is also made to FIG. 4B, which illustrates an analogous hardware architecture, but includes relevant positive and negative circuit connections.

As shown, integrated charger 302a includes the energy storage subsystem 304b. Energy storage subsystem 304b can store and discharge direct current (DC) power. As explained herein, this allows for the subsystem to act as a back-up reserve of power, to mitigate high power demands on integrated charger 302a.

In at least one example, the energy storage subsystem 304b includes one or more battery cells 304b. The battery cells can include NMC (nickel, manganese and cobalt) batteries, LFP (lithium ferro phosphate) batteries, and the like. Accordingly, for ease of reference, the energy storage subsystem 304b is simply referred to herein throughout as a battery subsystem 304b, or battery 304b. It will be understood, however, that subsystem 304b can comprise any other type of energy storage system (e.g., fuel cells). Further, while only one energy storage subsystem 304b is shown, one or more additional energy storage subsystems 304b may be added to the integrated electric charging system 302a via a DC bus, which will be described in further detail below.

In various examples herein, battery subsystem 304b can be rechargeable, such that it constitutes a rechargeable battery subsystem (or a rechargeable energy storage subsystem 304b). This allows the battery to be recharged for sustain, continued operation.

While not explicitly illustrated, battery 304b may include one or more internal processors. The processors can control operation of the battery 304b. For example, the processors may control the rate of charging or discharging by battery subsystem 304b.

Alternatively, or in addition, battery 304b can also include a monitoring mechanism, such as a battery management system (BMS). As is generally known in the art, a BMS provides a number of automated internal functions. These functions include preventing the battery from operating outside its safe operating zone. More generally, the BMS can also monitor different battery state parameters (e.g., state of charge, voltage, current, temperature, etc.), and calculate various forms of secondary data. In some cases, the battery's internal processor may be part of, or externally connected to, the BMS. The battery's internal processor and/or BMS may communicate battery state data to controller 450, as well as receive control signals from controller 450.

Integrated charger 302a also includes, (i) the charging subsystem 304a, and in some examples, (ii) controller 450.

Charging subsystem 304a comprises the remaining hardware components which facilitate DC and/or AC charging. As provided, controller 450 can automate control of various hardware components in the integrated charger 302a. Controller 450 can also transmit or receive data signals, from external systems (e.g., an external controller), via control and communication port 314. In other examples, the controller 450 is not provided inside the integrated charger 302a, and is externally located.

In still other examples, the integrated chargers described herein may operate without a controller 450 (see e.g., 302a′ in FIGS. 4C and 302a″ in FIG. 4D). In these cases, the integrated charger 302 is a pre-configured circuit (e.g., switches are pre-configured), or a circuit in which adjustable components (e.g., switches) are manually modifiable. Accordingly in all examples described or illustrated herein, it will be understood that the same examples can be provided without the controller 450.

Charging subsystem 304a is now described herein at a greater level of detail. As shown, charging subsystem 304a includes one or more power conversion devices 402-406. Power conversion devices 402-406 facilitate operation of the integrated charger 302a, and include various AC/DC and DC/DC converters. In at least one example, one or more power conversion devices are bi-directional, which provides greater functionality for the integrated charger, as explained below.

While multiple power converters are illustrated in integrated charger 302a—all of the converters, or any subset of converters, can be combined into a single converter module. The single converter can, in turn, provide multi-converter functionality. For example, this can be done to simplify manufacturing and/or the assembly process of the integrated charger 302a. Still further, each converter 402-406 can, itself, be designed as multiple converters. For instance, a single converter can be designed from multiple sub-converters, e.g., arranged in parallel, and providing analogous functionality.

In more detail, integrated charger 302a includes an AC/DC converter 402 which interfaces with, and is associated with, AC port 306. In operation, AC/DC converter 402 converts AC power, from AC port 306, into DC power. In some examples, AC port 306 interfaces directly, or indirectly with an external electric input AC supply coupled to the AC port 306, such as an electric power grid (e.g., via transformer subsystem 154). The AC/DC converter 402 generates DC power, which is output from charger plug 308 and/or DC port 310. For example, the DC power can be output to an EV coupled to charger plug 308. In some examples, as explained herein, AC/DC converter 402 can also boost-up or buck-down the peak input AC voltage to generate a higher or lower DC voltage.

To this end, the AC/DC converter 402 can have one of a number of designs. These designs can accommodate different types of AC power supplies. For example, AC/DC converter 402 can be a three-phase, three-leg converter. Otherwise, AC/DC converter 402 can also be a three-phase, four-leg converter, or single-phase three-leg converters. The different designs allow integrated charger 302a to interface and couple to either three-phase grid and single-phase grid, for example, a single phase 240V supply, or a three-phase 120V to 600V supply. In other examples, the AC/DC converters can be 2-level converters and multiple converters.

AC/DC converter 402 can also be a bi-directional converter. In other words, AC/DC converter 402 can operate in reverse, to convert DC power into AC power. The converted AC power is output from AC port 306.

An advantage of this configuration is that integrated charger 302a can be used for AC charging, i.e., in addition to DC charging. For example, integrated charger 302a can provide level “2” AC charging capabilities for compatible EVs. In other examples, integrated charger 302a can provide electric grid support. For example, integrated charger 302a can inject AC power to support a connected electric grid, e.g., during a grid fault. In particular, energy storage subsystem 304b or the battery or batteries 304b of energy storage subsystem 304b may discharge AC power to inject AC power to support a connected electric grid.

As shown in FIGS. 4A and 4B, AC/DC converter 402 includes an AC side 402a, and a DC side 402b. AC side 402a couples to AC port 306 via AC bus 428 and receives and/or outputs AC power. DC side 402b couples to internal DC bus 412a and receives and/or output DC power.

While not shown, in some examples, AC/DC converter 402 can include an associated switch. For example, this can be a relay or solid-state switch. The switch can be closed or opened to connect, or disconnect, AC/DC converter 402 from AC port 306. In turn, the switch can connect or disconnect the integrated charger 302a, from AC port 306. For example, during a grid fault, the integrated charger 302a can be disconnected from AC port 306 using the switch. The switch can be located inside, or external to AC/DC converter 402.

In at least one example, AC/DC converter 402a is controlled by controller 450. For example, controller 450 can control the associated switch, to activate or de-activate the converter 402a. Controller 450 can also, more generally, control the extent to which converter 402a boosts-up (or bucks-down) the input AC voltage. During reverse, bi-directional operation—controller 450 can also control the extent to which converter 402a boosts-up (or bucks-down) the input AC voltage.

Integrated charger 302a also includes the first DC/DC converter 404. DC/DC converter 404 interfaces with, and is associated with, output charger plug 308. DC/DC converter 404 outputs DC power for charging a connected DC systems (e.g., an EV), coupled to charger plug 308. The DC/DC converters, described herein, can be CLLC converters, LLC, converters, dual active bridge (DAB) converters.

As shown, DC/DC converter 404 includes a first DC side 404a, and a second DC side 404b. First DC side 404a couples to DC bus segment 414a, of a common DC link bus 414. Second DC side 404b couples the charger plug 308, via DC bus 418.

During operation of integrated charger 302a— input DC voltage is received at the first DC side 404a. The input DC voltage can be received at the DC/DC converter 404 from: (i) AC port 306, via AC/DC converter 402, (ii) battery 304b, via DC/DC converter 406, and/or (iii) DC port 310. DC/DC converter 404 can then operate as either a boost-up and/or boost-down converter. Accordingly, DC/DC converter 404 can increase or decrease the input DC voltage, as required. For example, input DC voltage may be increased or decreased, depending on the requirements of the DC system being charged (e.g., the EV). Output DC voltage is then output or discharged from the DC/DC converter 404 from charger plug 308.

Analogous to AC/DC converter 402, DC/DC converter 404 can also be a bi-directional converter. This allows converter 404 to receive input DC power from charger plug 308, and output boosted-up or bucked-down DC power to the common DC bus 414.

In some examples, DC/DC converter 404 is also controlled by controller 450. For instance, controller 450 can control the degree to which the converter 404 boosts-up or bucks-down the input DC voltage. For instance, controller 450 can determine the charging requirements of a connected EV, and can adjust the DC/DC converter 404 to output DC voltage to meet these requirements. The control can be bi-directional, depending on the operation mode of integrated charger 302a. Controller 450 can also activate and/or de-activate the DC/DC converter 404 (e.g., by controlling through current flow through the converter, or controlling an associated external or internal switch).

Referring still to FIGS. 4A-4B, integrated charger 302a additionally includes a second DC/DC converter 406. Second DC/DC converter 406 interfaces with the, and is associated with, battery subsystem 304b.

In more detail, battery DC/DC converter 406 receives DC input power, which is discharged from battery 304b. Converter 406 may boost-up, or buck-down the DC power, to generate output DC power. Output DC power is fed to the common DC bus 414. Depending on the operation mode of the charger, as explained below, this DC power can then flow to charger plug 308, via converter 404. Otherwise, the DC power can flow to DC port 310, or to the AC/DC converter 402.

As explained herein, in operation—power stored in battery 304b can be discharged in order to inject additional power into charger 302a. This additional power can help meet power demand requirements of the charger, as needed.

DC/DC converter 406 can also be bi-directional converter. This bi-directionality enables converter 406 to receive DC power from DC bus 414 and generate output DC power. The output DC power is fed back into battery subsystem 304b. Accordingly, the bi-directionality facilitates re-charging of the battery subsystem 304b.

More particularly, DC/DC converter 406 includes a first DC side 406a and a second DC side 406b. First DC side 406a couples to the battery 304b through a second intermediate DC bus 412b. While only one battery 304b is shown in FIGS. 4A and 4B, integrated charger 302a can include one or more additional batteries 304b that may be connected directly to the integrated charger 302a, through intermediate DC bus 412b. Second DC side 406b couples the common DC bus 414, via second DC bus segment 414b. At connection node 416a, common DC bus 414 can bifurcate into a third DC bus segment 414c. Third DC bus segment 414c couples to first DC bus segment 414a at connection node 416b.

In at least one example, DC/DC converter 406 is integrated into the battery 304b. That is, rather than forming separate hardware units—converter 406 and battery 304b can comprise a single integrated hardware module. In this example, the second intermediate DC bus 412b is merely an internal connection within the augmented battery subsystem 304b.

Controller 450 can also again control the DC/DC converter 406. For example, controller 450 may activate or de-activate the DC/DC converter 406, or otherwise control the voltage boost-up or buck-down functionalities of converter 406.

A novel feature of the design of integrated charger 302a is the ability to provide a stable, constant, and pre-defined voltage at common DC bus 414. The voltage at DC bus 414 can be sustained at a pre-defined level, notwithstanding variations in the input voltage supply. For instance, the voltage at DC bus 414 can be sustained, even if the integrated charger 302a is connected to a low, or faulty input AC supply, at AC port 306.

As explained herein, a stable DC bus 414 voltage is possible through controlling each of converters 402-406, as well as the various switches inside the charger 302a. More particularly, it can be observed that each of converters 402-406 connects directly, or indirectly, to the common DC bus 414. Converters 402-406 act as a buffer between the DC bus 414, and each input/output port 306-310, as well as battery 304b. Converters 402-406 therefore regulate the input AC or DC voltage into DC bus 414. In one example, converters 402-406 regulate the DC bus voltage at a constant 800 VDC. To this end, controller 450 can vary and modify the pre-defined DC bus voltage, by controlling one or more converters 402-406, as well as the switches inside the charger.

The provision of a stable DC bus 414 voltage has a number of appreciated advantages. First, the stable voltage supports efficient operation of the DC/DC converter 404, associated with charger plug 308. In more detail, with a DC bus having a steady voltage—an efficient and wide output voltage range is possible with DC/DC converter 404. For example, if the DC link voltage is set to 800 VDC, the DC/DC converter 404 can efficiently buck-down and/or boost-up the voltage, to output a desired DC voltage from charger plug 308.

The desired output DC voltage, from DC/DC converter 404, can depend on the requirements of an EV connected to charger plug 308. For example, with increasing adoption of the 800V EV architecture, an output voltage up to 1000V is typically required for DC fast charging. Accordingly, DC/DC converter 404 may boost-up the 800 VDC, DC bus voltage 414, to generate the desired 1,000 VDC output. In this example, converter 404 would only need to boost the voltage by 200 VDC to accommodate the 1,000 VDC output. The DC/DC converter 404 can also buck-down the voltage by any extent, to satisfy lower voltage outputs.

In particular, a similar advantage is not necessarily available with designs that having a non-stable and variable DC bus 414 voltage. For example, if the DC bus 414 is susceptible to sudden decreases in its voltage potential—e.g., due to a sudden drop in the input AC voltage supply from port 306—operation of the DC/DC converter 404 is correspondingly affected. For instance, if the DC bus 414 experiences a sudden drop in potential from 800 VDC to 400 VDC—the DC/DC converter 404 will experience corresponding difficulties boosting the lower, input 400 VDC back up to a 1,000 VDC output, for DC fast charging. In this case, the DC/DC converter 404 will have very low efficiency due to the large voltage conversion ratio (e.g., 1,000 VDC:400 VDC as compared to 1,000 VDC:800 VDC).

By a similar token, a stable DC bus 414 voltage also supports AC charging using the integrated charger 302a. As stated previously, integrated charger 302a not only enables DC charging, but also enables a reverse AC charging mode. In the reverse AC charging mode, AC charge is output from AC port 306. In this case, a stable DC bus voltage 414 also allows the AC/DC converter 402 to operate efficiently in reverse to boost-up or buck-down the DC bus voltage to a desired output AC voltage magnitude.

Still yet further, a stable DC bus voltage also supports power sharing between multiple integrated chargers 302. For example in FIGS. 9A-9D, multiple integrated chargers 302 can couple via DC port 310, using DC link 902. As shown in FIG. 4A, each DC port 310 connects to the respective DC bus 414 (via bus segment 414b). Coupling integrated chargers in this manner facilitates exchange of DC power between chargers, for enhanced operation. Coupling integrated chargers 302 via the DC port 310 necessitates, however, that each charger has the same DC bus voltage. If there is a mismatch between DC bus voltages, there will also be a mismatch at the DC port 310. Accordingly, systems having a variable, or non-controllable DC bus voltage, do not enable power sharing between integrated chargers 302.

Continuing reference to FIGS. 4A and 4B, an operational switch 422 is interposed between AC port 306, charger plug 308 and battery 304b. More generally, operational switch 422 is also interposed between each of the three power converters 402-406.

Operational switch 422 can be varied to operate integrated charger 302a in different operational modes. As explained in greater detail herein, controlling the state of operational switch 422 facilitates maintaining the stable voltage, in DC bus 414.

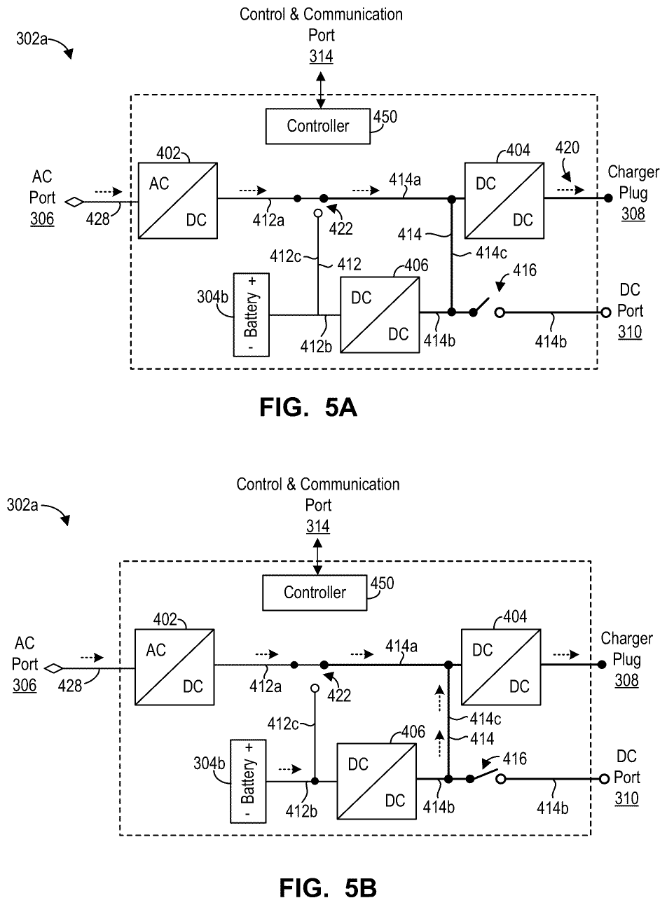

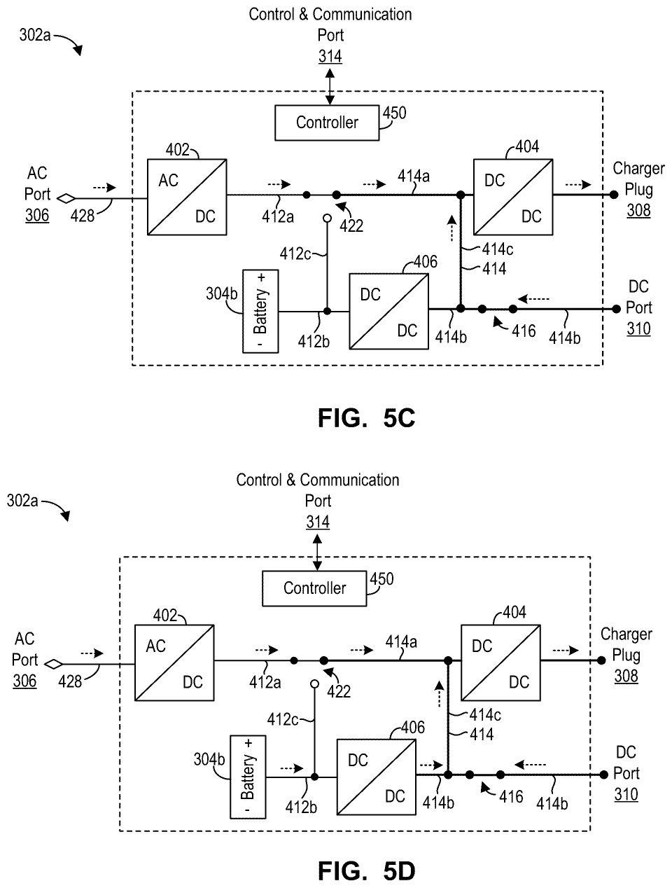

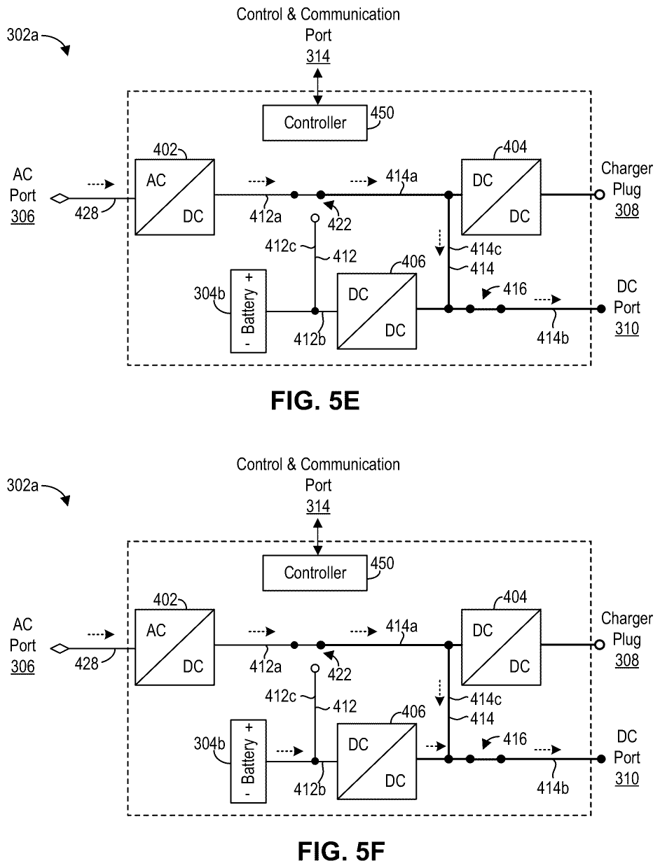

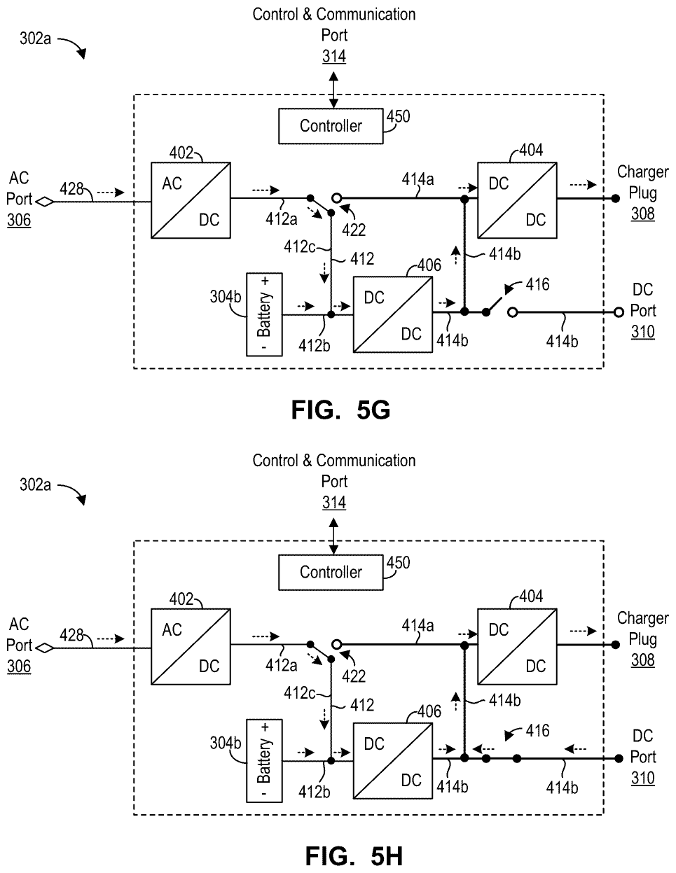

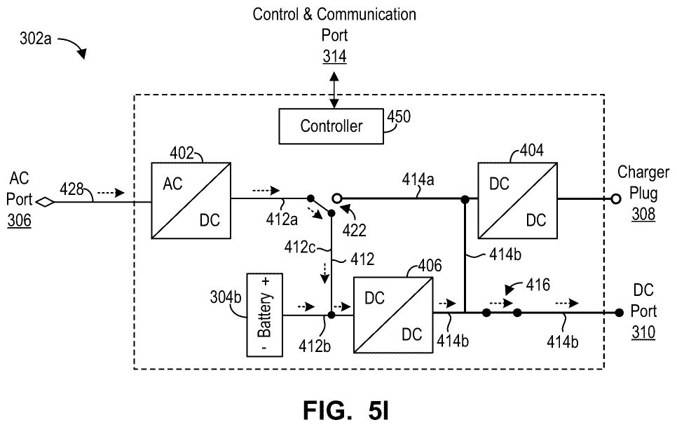

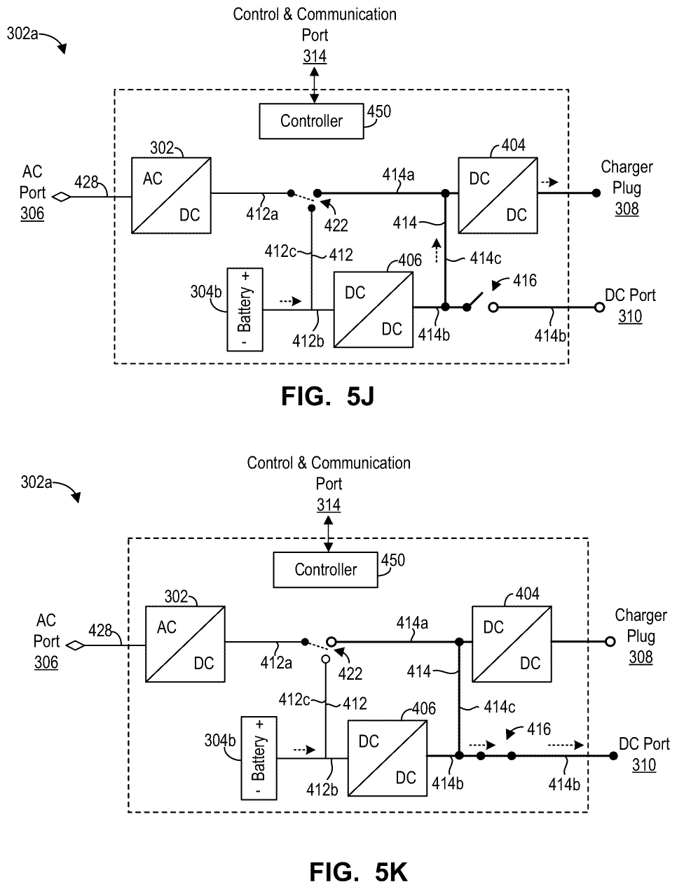

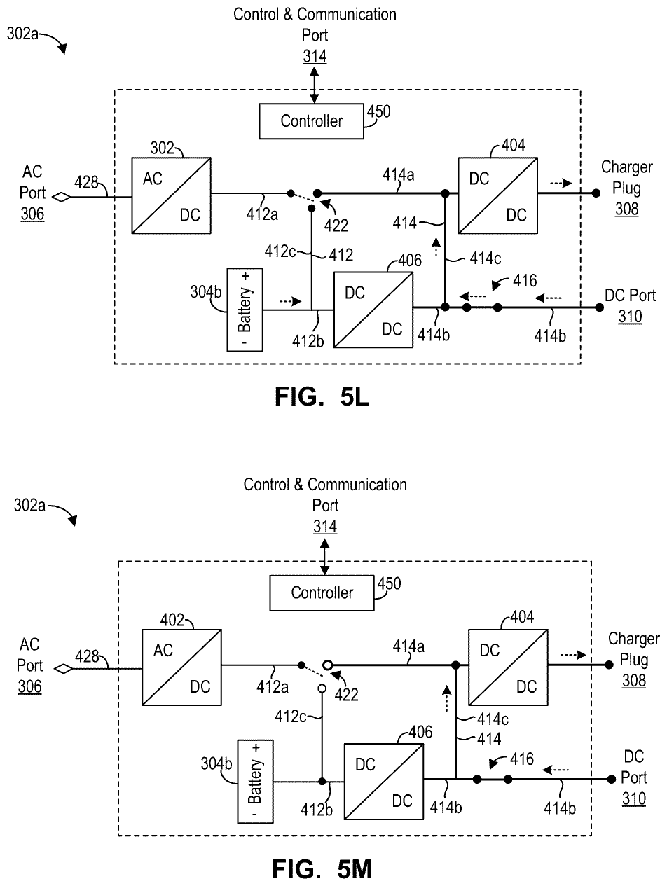

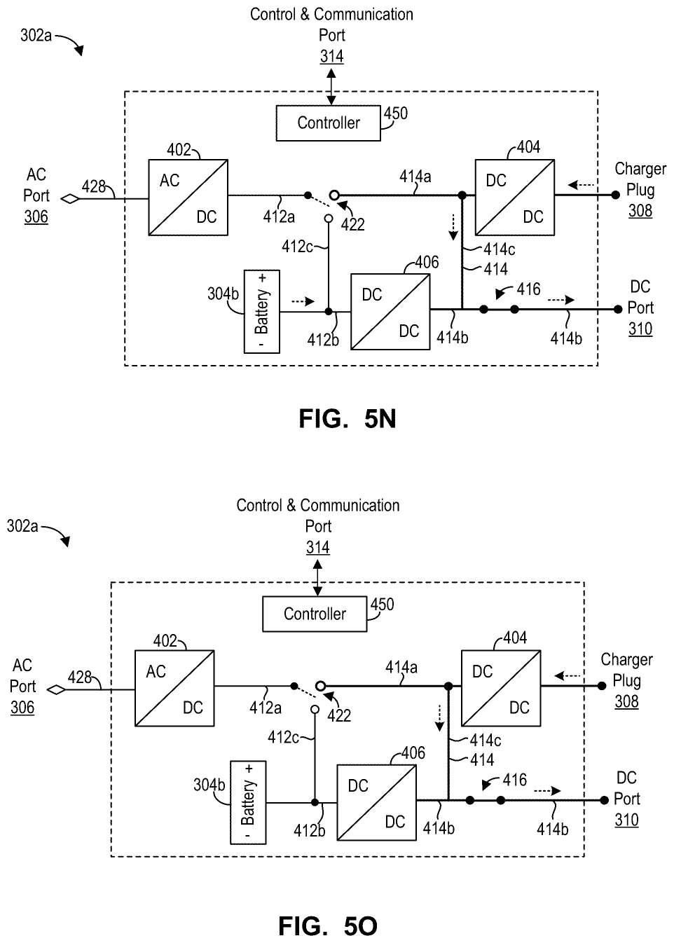

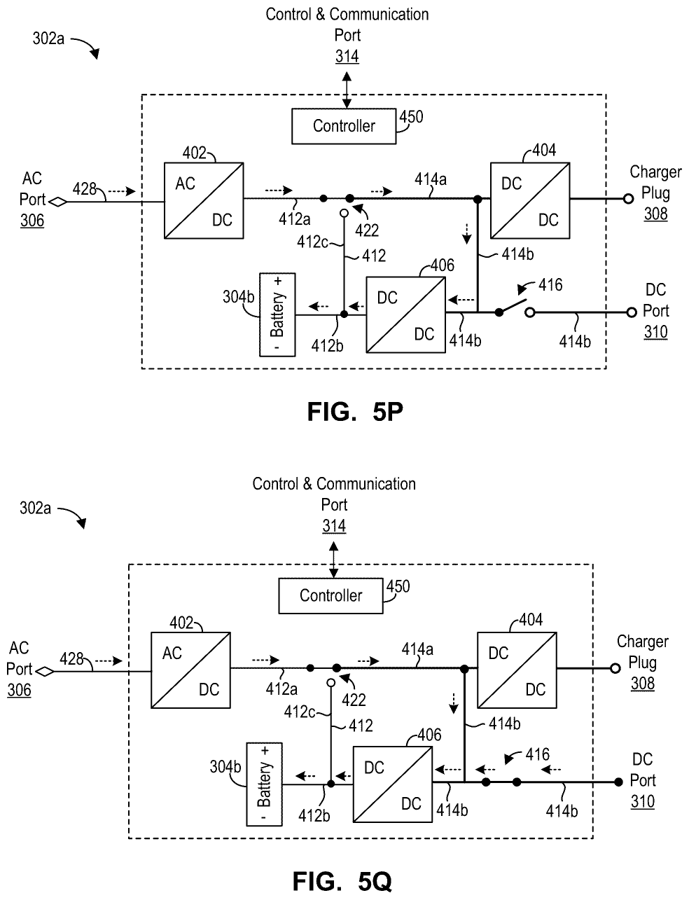

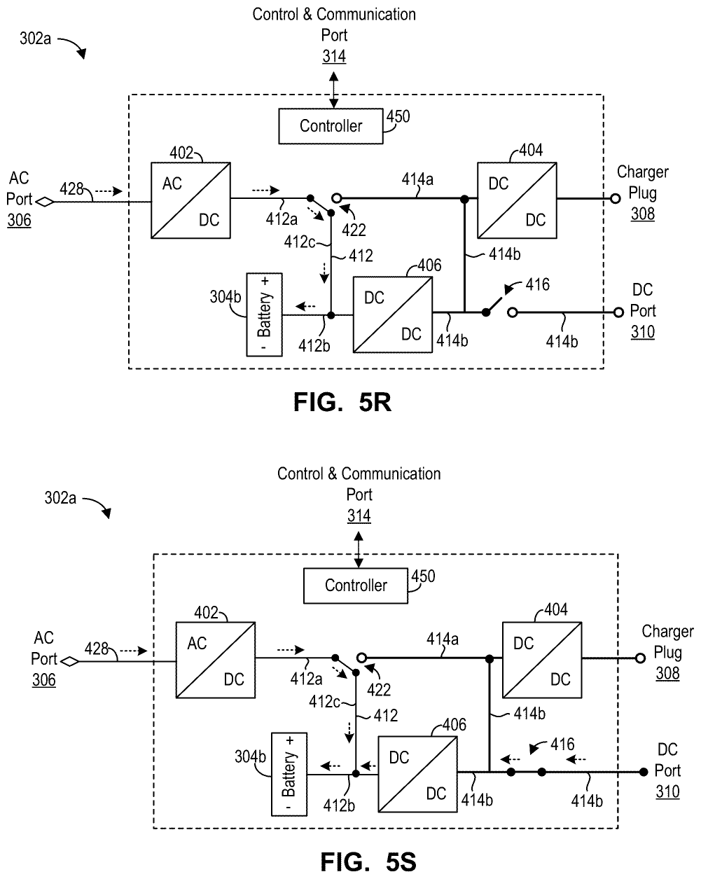

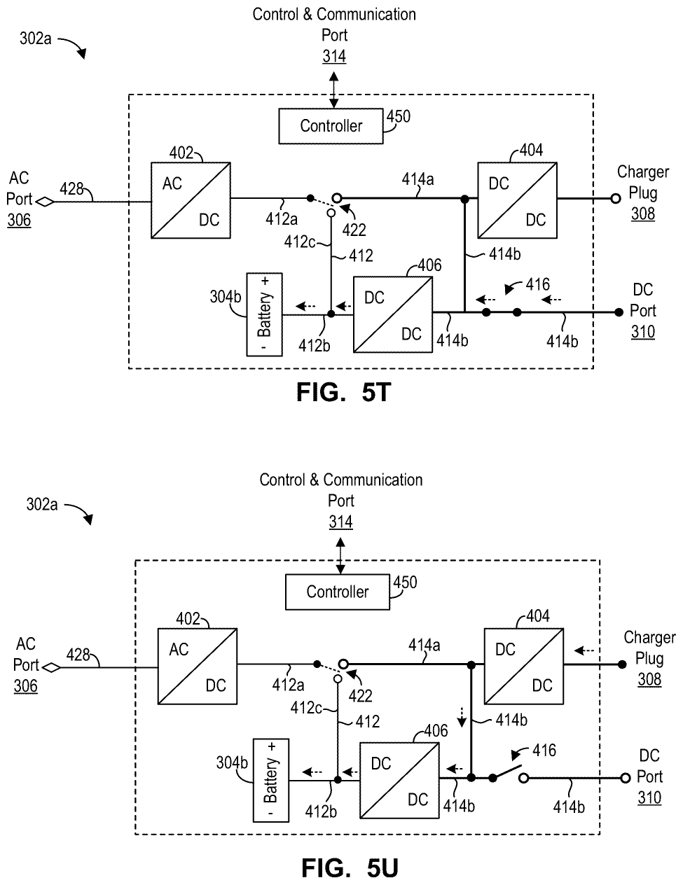

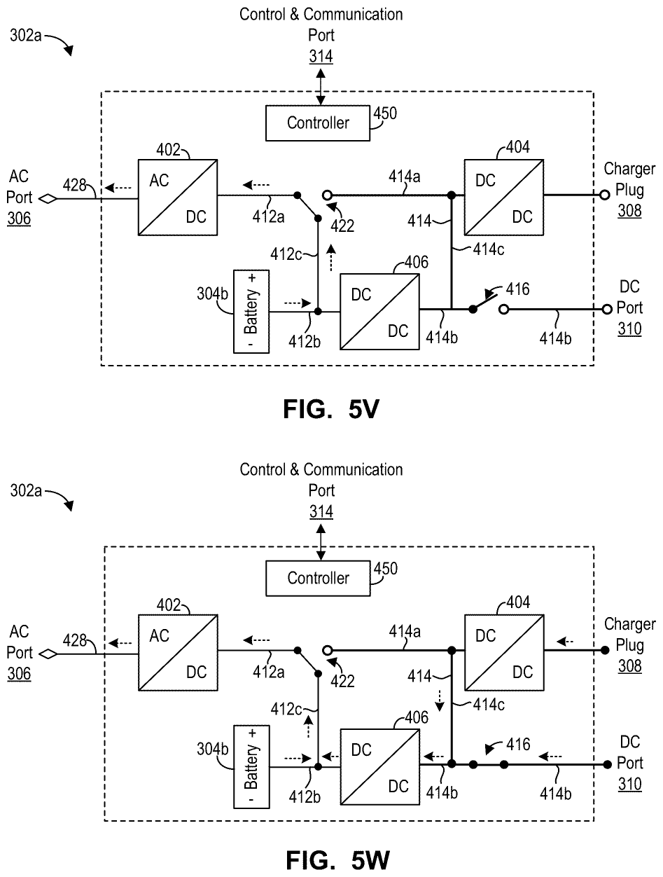

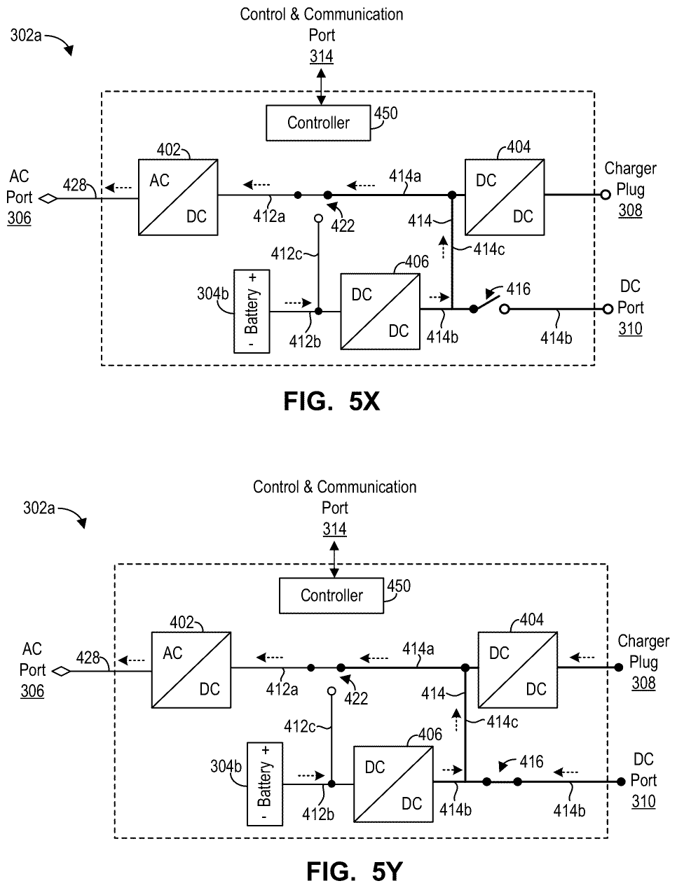

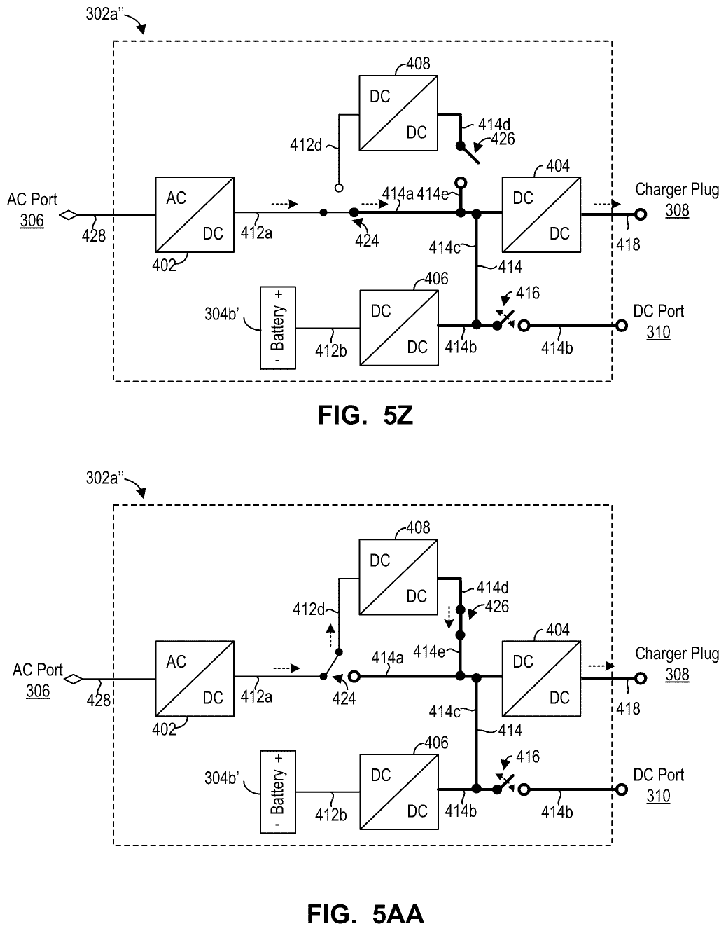

At a general level, however, operational switch 422 is configurable in one of three states: (a) a first closed state (e.g., FIGS. 5A-5F)—in this state, switch 422 couples first intermediate DC bus 412a to common DC bus 414. In turn, switch 422 couples AC port 306 to charger plug 308 and/or DC port 310; (b) a second closed state (e.g., FIG. 5G-5I)—in this state, switch 422 couples first intermediate DC bus 412a to third intermediate DC bus 412c. In turn, switch 422 couples AC port 306 to battery 304b; and (c) an intermediate, open state (e.g., FIGS. 5J-5O)—in this state, switch 422 does not couple intermediate DC bus 412a to any other of the DC busses.

In some examples, a DC port switch 416 is interposed along the second DC bus segment 414b. DC port switch 416 connects or disconnects the integrated charger 302a from external DC supplies and loads. In other cases, the DC port switch 416 may not be provided.

Integrated charger 302a may also include the controller 450. Controller 450 is operable to control operation of various components of the integrated charger 302a. For example, controller 450 can control operation of the power converters 402-406, as well as the state of various switches. Controller 450 can interface with these various devices using any suitable method, including using wired connections (not shown for simplicity of illustration).

Control and communication port 314 interface with external input signals. For example, these input signals can be received from an external controller, computing device or processor.

Reference is now made to FIG. 4D, which shows another example hardware architecture for an integrated charger 302a″. Similar to the integrated chargers of FIGS. 4A-4C, integrated charger 302a″ includes an energy storage subsystem 304b′ and a charging subsystem 304a′. The energy storage subsystem 304b′ may be generally analogous to the energy storage subsystem 304b of FIGS. 4A-4C.

Similar to charging subsystem 304a, charging subsystem 304a′ includes one or more power conversion devices 402-408 facilitating operation of the integrated charger 302a″. Power conversion devices 402-408 include various AC/DC and DC/DC converters. Charging subsystem 304a′ may be generally analogous to charging subsystem 304a but include a third DC/DC converter 408 and not include intermediate DC bus 412c. Similar to power conversion devices 402-406, DC/DC converter 408 can be a bi-directional converter.

DC/DC converter 408 includes a first DC side 408a which can couple to the DC side 402b of AC/DC converter 402 via the intermediate DC bus 412a when operational switch 424 is in a second closed state—in this state, switch 424 couples with intermediate DC bus 412a with intermediate DC bus 412d (e.g., FIG. 5AA). DC/DC converter 408 includes a second DC side 408b which can couple to the DC bus 414 when operational switch 426 is in a closed state (e.g., FIG. 5AA)—in this state, switch 426 couples bus segment 414d to bus segment 414e via connection node 416c. Connection node 416 can bifurcate common DC bus 414 into a fourth segment 414e.

When operational switch 424 is in a first closed state, intermediate DC bus 412a couples with bus segment 414a (e.g., FIG. 5Z), analogous to the first closed state of switch 422 as described with reference to FIGS. 4A-4C. When operational switch 424 is in an intermediate, open state, switch 424 does not couple intermediate DC bus 412 to any other of the DC busses.

Similarly, when switch 426 is in an open state, switch 426 does not couple bus segment 414d to bus segment 414e. When both switch 424 and switch 426 are in the open state, DC/DC converter 408 is disconnected from the remainder of charging subsystem 304a′.

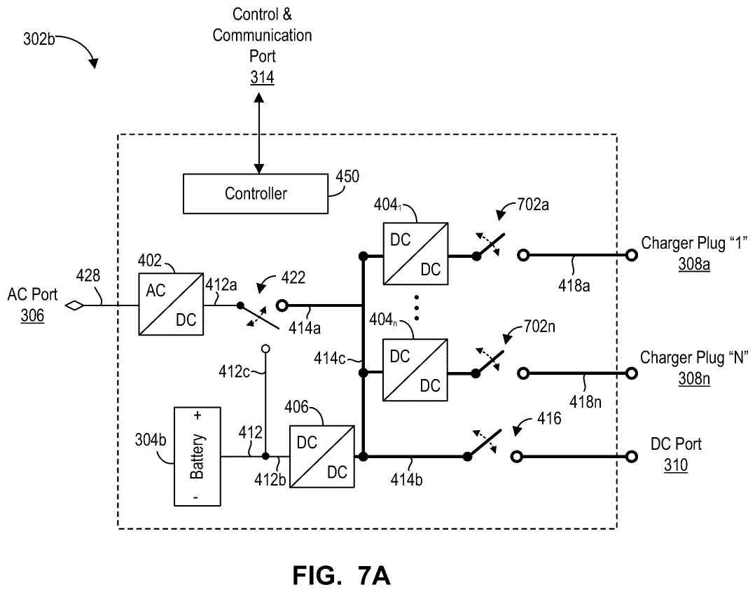

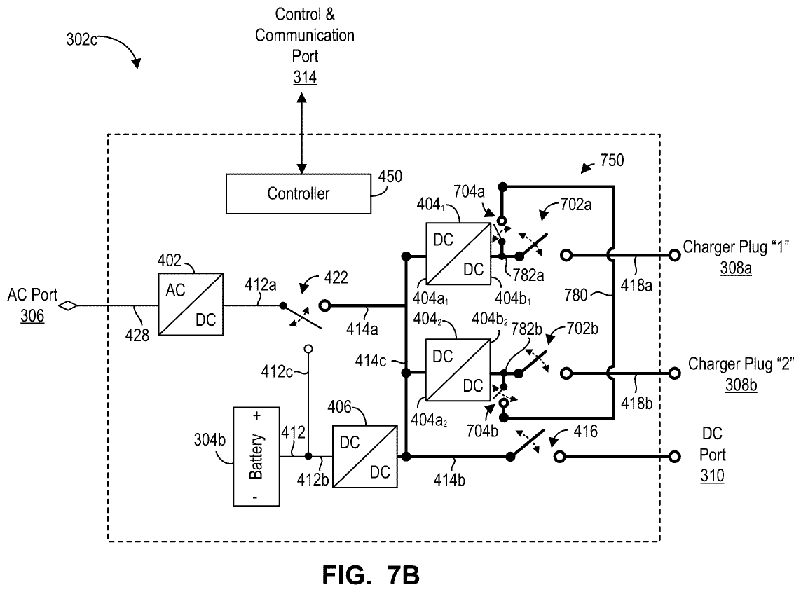

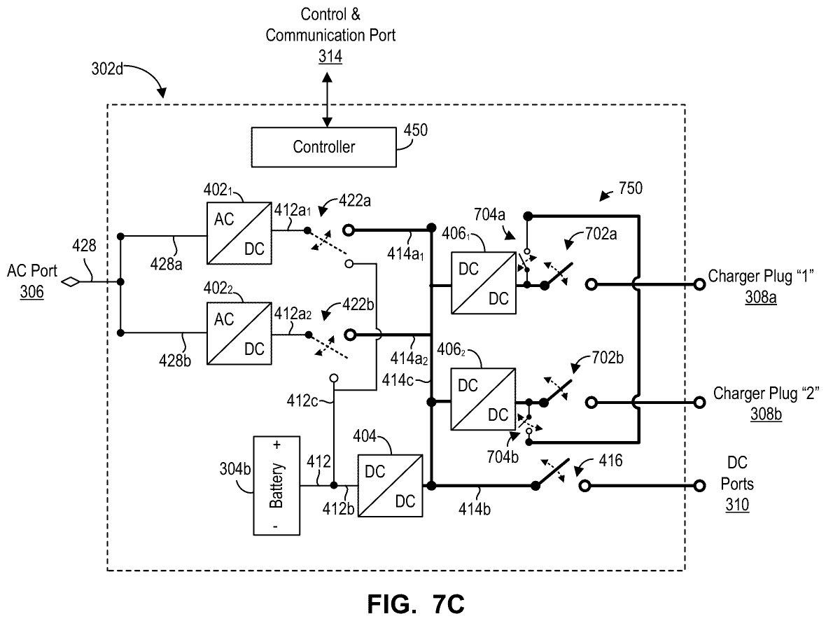

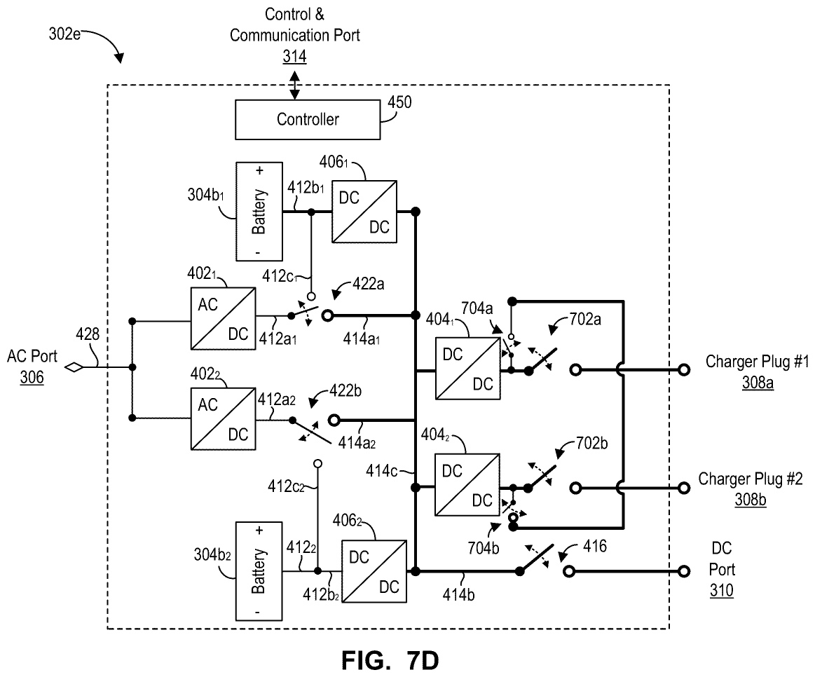

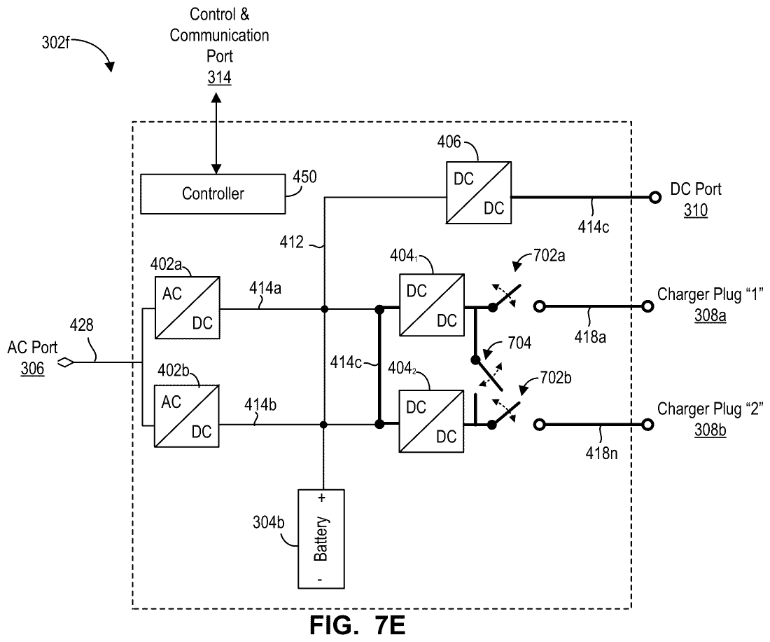

Reference is now made to FIG. 7A, which shows another example hardware architecture for an integrated charger 302b.

Integrated charger 302b is generally analogous to integrated charger 302a, with the exception that charger 302b includes more than one charger plug 308a-308n. Accordingly, integrated charger 302b can accommodate more than one DC system load coupled for charging. For example, multiple EVs can be coupled to the same integrated charger.

As shown, each charger plug 308a-308n may have a corresponding DC/DC power converter 404₁-404ₙ. The DC/DC converters 404 are interposed between the common DC bus 414, and a charger-specific DC bus 418a-418n.

In some examples, each DC/DC converter 404a-404n is independently controllable to boost-up, or buck-down, the input DC voltage from the common DC bus 414, as necessary. This allows each integrated charger to flexibly accommodate different charging requirements for different connected DC systems (e.g., Evs). In at least one example, DC/DC converters 406 are controlled by the controller 450. DC/DC converters 404 can also be controlled in the reverse direction, during bi-directional operation, to boost-up or buck-down input voltage from a charger plug 308.

As shown, in the integrated charger 302b, the battery 304b can act as a common battery subsystem for all charger plugs 308.

Reference is now made to FIG. 7B, which shows another example hardware circuit architecture for an integrated charger 302c.

Integrated charger 302c is generally analogous to integrated charger 302b (FIG. 7A), but further includes a switch network 750. Switch network 750 provides a degree of redundancy within the integrated charger 302c. As shown, switch network 750 includes a number of switches 702-704. In the illustrated example, the switch network 750 includes four switches 702a, 702b, 704a, 704b.

Each switch 702-704 can comprise, for example, a relay or a solid state switch. The switches can be controllable between a closed, activated state and an open, inactivated state.

In more detail, the switch network 750 connects together the second DC side 404b₁, 404b₂ of each DC/DC converter. In turn, this enables re-routing of output (or input) power flow between the two converters 404. Accordingly, if a charger plug 308 is coupled to a faulty or in-operational DC/DC converters 404, power flow from the other DC/DC converter 404 can be re-routed to that charger plug 308.

It will be appreciated that while the switch network 750 is illustrated in association with two converters 404, the network can be scaled to accommodate any number of connected converters 404.

As shown, the switch network 750 includes charger plug switches 702a, 702b. Charger plug switches 702a, 702b are interposed along each of the charger plug DC busses 418a, 418b. These switches operate to connect or disconnect a charger plug from a respective DC/DC converter 406.

Switch network 750 also includes a linking DC bus 780, which connects together the two DC/DC converters 404. The linking DC bus 780 can connect to the respective charge plug bus 418a, via a connection node 782a, 782b. Connection nodes 782a, 782b are located between the second DC side of each converter 404b₁, 404b₂ and the respective charge plug switch 702a, 702b.

The linking DC bus 780 can itself, include two DC connecting switches 704a, 704b. For example, a separate connecting switch 704a, 704b is associated with each DC/DC converter 404. In other examples, only one of the connecting switches is provided. In some examples, the charger plug switches 702a, 702b may not be provided.

To this end, by opening and closing switches 702-704, the switch network configuration can be varied to achieve different outcomes.

For example, the switch network configuration can be modified to mitigate for a fault in one of the DC/DC chargers 404. For example, it may be desired to use charger plug “1” 308a. However, first DC/DC converter 406₁ may be in-operational due to a fault. Accordingly, second DC/DC converter 406₂ can be used as an alternative backup to feed power to charger plug “1” 308a.

In this example, the configuration of the switch network 750 is modified to couple the DC/DC converter 406₂ to the charger plug “1” 308a. For example, switch 702b is opened, while switches 704a, 704b and 702a are closed. This re-routes DC power from converter 404₂ to charger plug 308a. Switch 702b can also be closed, such that the DC/DC converter 406₂ feeds both charger plugs 308a, 308b.

A similar concept is applied to couple the first DC/DC converter 404₁ to the charger plug “2” 308b, in case of a fault in the DC/DC converter 404₂.

In some examples, the switch network configuration is controlled by controller 450. For example, controller 450 can monitor for switch network re-configuration events, that prompt controller 450 to modify the switch network configuration. For example, as noted, this can involve detecting that one of the DC/DC converters 404₁, 404₂ is faulty. This can be determined, for example, using one or more sensors positioned around the converter and monitoring the output voltage and/or current.

Reference is now made to FIG. 7C, which shows still another example hardware circuit architecture for an integrated charger 302d.

Adding a further level of redundancy, integrated charger 302d includes two parallel sets of grid-interfacing AC/DC converters 402₁, 402₂. In this example, where one AC/DC converter 402a, 402b experiences a fault, the other AC/DC converter 402 can be activated for fault mitigation.

As shown, each AC/DC converter 402₁, 402₂ is coupled at the AC-side to the AC port 306, via a corresponding AC bus 428a, 428b. While not explicitly shown, an AC port switch may be provided in association with each AC/DC converter 402. This can be an internal or external switch. The switch is used to connect, or disconnect a converter 402 to the AC port 306. In at least one example, only one of the AC port switches is activated, at a given time, in order to use a corresponding converter 402₁, 402₂.

On the DC-side, each converter 402 is further coupled to the common DC bus 414 (e.g., via respective DC bus segments 414c₁ and 414c₂). Additionally, a different operational switch 422a, 422b is provided, in association with each AC/DC converter 402₁, 402₂. The operational switches 422a, 422b are configurable for the activated AC/DC converter 402a. If one of the AC/DC converters is not in-use, then the respective switch 422 can be modified to the open state.

While only two parallel grid-interfacing AC/DC converters 402₁, 402₂ are illustrated, it will be understood that any number of parallel AC/DC converters 402a, 402b can be provided using an analogous replicated configuration. Further, while the integrated charger 302d is illustrated with a switch network 750—in other cases, the switch network 750 may not be included.

Reference is now made to FIG. 7D, which shows still another example hardware circuit architecture for an integrated charger 302e.

Integrated charger 302e is generally analogous to the integrated charger 302d, but includes more than one battery subsystems 304b₁ and 304b₂. Each battery 304b₁, 304b₂ is associated with a different branch of the AC/DC converters 402₁, 402₂. This, in turn increases the redundancy of the system, as one battery subsystem 304b can function as a back-up in case of a fault with the other battery subsystem. The discharge from the battery subsystem can be controlled through their respective DC/DC converters 406₁, 406₂.

In other examples, the provision of two batteries 304b can also enable configurations where additional power is injected from both the batteries, as opposed to only one battery. For example, additional power may be required to meet power demand requirements for the integrated charger 302e.

Again, while the integrated charger 302e is illustrated with the switch network 750—in other cases, the switch network 750 may not be necessarily included.

Reference is now made to FIG. 7E, which shows still another example hardware circuit architecture for an integrated charger 302f.

Integrated charger 302f is generally analogous to integrated charger 302b but includes a second AC/DC power converter 402b. As shown, in the integrated charger 302e, the battery 304b is also directly connected to the common DC bus 414, without an operational switch.

DC/DC power converter 404₁ and DC/DC power converter 404₂ can also be connected via operational switch 704. When the operational switch 704 is in the open state, and operational switches 702a and 702b are in the closed state, DC/DC power converter 404₁ is connected to charger plug 308a and DC/DC power converter 404₂ is connected to charger plug 308b. When operational switch 704 is in the closed state and operational switch 702b is in the closed state, DC/DC power converter 404₁ can couple to charger plug 308b, for example if operational switch 702a is in the open state. Similarly, when operational switch 704 is in the closed state and operational switch 702a is in the closed state, DC power converter 404₂ can couple to charger plug 308a, for example if operational switch 702b is in the open state.

Though only two AC/DC power converters 402 are shown for ease of illustration, each AC/DC power converter 402 illustrated can correspond to a group of AC/DC power converters connected in parallel. Similarly, each DC/DC power converter 404, 406 illustrated can correspond to a group of DC/DC power converters connected in parallel.

### III. Example Operational Modes for an Example Integrated Charger

Reference is now made to FIGS. 5A-5AA, which illustrate different operational modes for an example integrated charger.

For ease of explanation, the operational modes are exemplified using the hardware circuit architecture of integrated chargers 302a (FIGS. 4A and 4B) and 302a″ (FIG. 4D). It will be understood, however, that the same operational modes can be replicated with any other analogous integrated charger circuit architecture, which share at least some of the same, common circuit elements (e.g., 302b-302f in FIGS. 7A-7E).

In more detail, integrated chargers 302a and 302″a have a variable hardware circuit configuration which allows for different operational modes. The different operational modes of the integrated charger 302a are enabled by modifying operational switch 422 and/or DC port switch 416, among other switches. The different operational modes of the integrated charger 302a″ are enabled by modifying operational switches 424 and 426 and/or DC port switch 416, among other switches.

As provided herein, operational modes of the integrated charger 302a include, by way of non-limiting examples: (i) a DC charging mode using high input AC voltage (FIGS. 5A-5F), and (ii) a DC charging mode using low input AC voltage (FIG. 5G-5O). These modes are also referenced herein simply as the “high AC mode”, and the “low AC mode”, respectively. These modes can be used for DC charging via charger plug 308 and/or DC port 310. Other example modes provided herein include a battery re-charging mode (FIGS. 5P-5U), and an AC output charging mode (FIGS. 5V-5Y). Operational modes of the integrated charger 302a″ include, by way of non-limiting examples: (i) a DC charging mode using high input AC voltage (FIG. 5Z), and (ii) a DC charging mode using low input AC voltage (FIG. 5AA).

At a general level, the high AC mode (FIGS. 5A-5F, 5Z) is used when the input AC voltage, from AC port 306, is sufficiently high to maintain the desired, pre-defined stable DC bus 414 voltage (e.g., 800 VDC). In contrast, the low AC mode (FIG. 5G-5O,5AA) accommodates for lower input AC voltages, from AC port 306. Low AC voltages are caused, for example, by the input AC supply grids only supporting single phase supplies or three-phase 208V (e.g., as is common in certain geographic locations). Low input AC voltages are also caused, more generally, by a temporary or permanent grid fault, or the entire absence of any input AC supply.

In at least one example, and as used herein throughout, a high AC input (or output) voltage can refer to a 380 VAC, 400 VAC, 480 VAC and/or 600 VAC. Further, a low AC voltage (e.g., input or output) can refer to a 208 VAC, 210 VAC, 220 VAC and/or 240 VAC. In some examples, the threshold between high and low AC voltage is around 300 VAC (±20 VAC).

The ability to operate in either a high or low AC mode allows the integrated chargers 302a, 302a″ to maintain a stable and constant DC bus 414 voltage, irrespective of the available input AC voltage supply. As previously discussed, the stable DC bus voltage has a number of appreciated advantages, including efficient operation of the integrated charger 302.

In more detail, in the high AC mode—the integrated charger 302a can connect directly to the AC input supply, via AC port 306. In some examples, the high AC mode is the default mode. In the low AC mode, the integrated charger 302a cannot rely exclusively on the input AC voltage supply. This is because the input voltage is low, and the AC/DC converter 402 cannot efficiently convert the low input voltage to the desired high DC bus 414 voltage (e.g., 800 VDC).

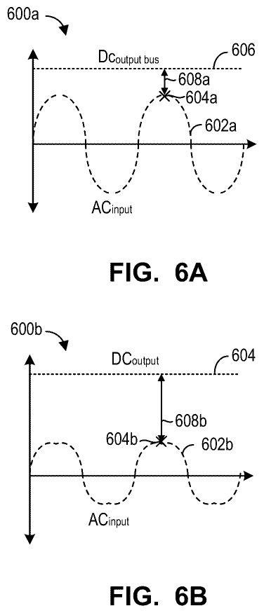

To further clarify this concept, reference is briefly made to FIGS. 6A and 6B. These figures show two example cases for different input AC voltages at the AC port 306.

In plot 600a (FIG. 6A), a high input AC voltage 602a has a high maximum peak voltage 604a. If the DC voltage 606 represents the desired DC bus 414 voltage (e.g., 800 VDC)— then AC/DC converter 402 must operate to: (i) convert the input AC voltage to output DC voltage; and also (ii) boost-up the DC voltage by 608a to maintain the higher stable DC voltage. If the input AC voltage 602a is already high, then the boost-up difference 608a is nominal. Accordingly, the AC/DC converter 402 may easily, and efficiently boost-up by the difference 608a, while operating a “high AC mode”.

In contrast, plot 600b (FIG. 6B) shows an example for a low input AC voltage 602b. As shown, the input AC voltage 602b has a lower peak magnitude 604b than peak magnitude 604a (plot 600a). Accordingly, in this example, AC/DC converter 402 must additionally boost-up the voltage by a larger difference of 608b, to maintain the same stable DC bus voltage 604 (e.g., 800 VDC). That is, 608b is greater than 608a, to achieve the same DC bus voltage 604. However, boosting the voltage by the larger extent 608b can compromise the efficiency of the AC/DC converter 402. For example, if the AC/DC converter 402 is connected to a DC bus 414 potentially at 800 VDC—the harmonics and power quality of the AC side can be poor due to the large voltage mismatch 608b.

In view of the foregoing, the low AC mode (FIG. 5G-5O, 5AA) functions to mitigate, or lessen, the burden on the AC/DC converter 402 to boost-up the voltage to the desired DC bus 414 voltage during DC charging.

(i) Example Configurations for the DC Charging Mode Using a High Input AC Voltage

Reference is now made to FIGS. 5A-5F, which illustrate different configurations for the integrated charger 302a operating in the high AC mode.

In general, high AC mode configurations are characterized by the operational switch 422 being in the first, closed position. In this position, the AC port 306 is directly connected to the common DC bus 414. This allows the input AC voltage to directly power the integrated charger.

In more detail, the high AC mode configurations include: (a) one or more configurations that rely exclusively on input AC power, from AC port 306 (FIGS. 5A and 5E); and (b) one or more configurations that rely on one or more input power sources (FIGS. 5B-5D, and 5F).

The choice between the two configuration types depends on the level of input AC power, from AC port 306. That is, while the input AC voltage is always high in both cases—the input AC power may not always be sufficient to meet power demands of the integrated charger 302a. Accordingly, different configurations accommodate for different, or fluctuating levels of input AC power.

At a high level, the “exclusive” input AC power configurations (FIGS. 5A and 5E) rely only on input AC power, from AC port 306, to provide DC charging. These configurations are used when there is sufficient input AC power to accommodate charging requirements of the integrated charger 302a.

In contrast, the configurations using more than one input power supply (FIGS. 5B-5D, and 5F) are used when the level of input AC power, from AC port 306, is insufficient to accommodate charging requirements of the integrated charger 302a. In these cases, other power sources are activated (e.g., battery 304b) to mitigate for low input AC power. The shortage of input AC power can result, from example, from an overloaded AC grid. For example, the AC grid may be overloaded if it supplies other loads in a building, in addition to integrated charger 302a (see e.g., systems 160 in FIG. 1B).

Reference is now made to FIGS. 5A and 5E, which show example “exclusive” input AC power configurations, in the high AC operating mode. These include configuration for outputting DC power: (a) from charger plug 308 (FIG. 5A); and (b) from DC port 310 (FIG. 5E).

FIG. 5A shows the integrated charger 302a in a first exclusive input AC power configuration. In this configuration, AC power—from port 306—supplies output DC power directly to charger plug 308. Accordingly, the configuration of FIG. 5A can be used to charge EVs coupled to charger plug 308.

As shown, input AC power flows from AC port 306 through AC/DC converter 402. AC/DC converter 402 transforms the AC power into DC power, and the DC power flows into the common DC bus 414. AC/DC converter 402 may also boost-up (or buck-down) the output DC power to the pre-defined DC bus 414 voltage (e.g., 800 VDC).

In this configuration, the operational switch 422 is in the first, closed state. This couples the AC port 306 directly to the common DC bus 414. DC/DC charger plug converter 404 receives the DC voltage, from DC bus 414, and either boosts-up (or bucks-down) the DC bus voltage 414, to discharge from charger plug 308.

In FIG. 5A, DC/DC battery converter 406 is controlled to prevent current flow. In turn, this stops—or minimizes—power discharge from battery 304b. For example, an internal or external switch, associated with DC/DC converter 406, is opened to disconnect power flow. DC port switch 416 is also opened, to prevent DC power flow therethrough.

FIG. 5E shows the integrated charger 302a in a second exclusive input AC power configuration. In contrast to FIG. 5A, input AC power from port 306 now supplies output DC power, to DC port 310. For example, this configuration can be used to charge a load coupled to the DC port 310.

As shown, DC port switch 416 is closed to allow power flow therethrough. Additionally, DC/DC converter 404 is also controlled to prevent current flow to charger plug 308. Accordingly, all power is directed to the DC port 310.

In other examples, the DC/DC converter 404 can be operated such as to realize a configuration where DC power flow is output from both the charger plug 308 and DC port 310.

Reference is now made to FIGS. 5B-5D and 5F, which show example configurations using more than one input power source, in the high AC power mode.

As noted earlier, these configurations are used where the input AC voltage is high, but the input AC power is insufficient to meet power demands of the integrated charger 302a.

FIG. 5B shows a first example of such a configuration. This configuration is generally analogous to FIG. 5A, with the exception that stored battery power is now discharged via battery DC/DC converter 406. Discharged battery power can supplement power from AC port 306. For example, power from AC port 306 may be insufficient to accommodate the charging requirements of an EV coupled to charger plug 308. Accordingly, power from the battery 304b is drawn to supplement power from AC port 306. In this example, the DC/DC converter 406 may boost-up the output battery voltage to the DC bus voltage 414.

FIG. 5C shows a second example of a configuration using more than one input power source. This configuration is also generally analogous to FIG. 5A, with the exception that DC power, from DC port 310, now supplements power from AC port 306.

As shown, DC port switch 416 is closed to enable power flow. The DC port 310 may couple one or more upstream DC power sources. For example, this can include other integrated charger 302a, or other sources of DC power (e.g., PV panels). A DC/DC converter (not shown) may ensure that DC power, from DC port 310, is boosted-up or bucked-down, to the pre-defined DC bus 414 voltage. In this configuration, no power is discharged from battery subsystem 304b. For instance, the battery DC/DC converter 406 can be controlled to prevent power flow.

The configuration in FIG. 5C can be used in different example applications. For example, this configuration can be used where there is insufficient power stored in the battery 304b. Accordingly, power sharing is necessary via the DC port 310. In other examples, this configuration is used where it is simply not desired to discharge stored power from battery 304b. For example, it can be desired to only use the battery power as a last resort back-up, if power sharing is not available.

FIG. 5D shows a third example configuration using more than one input power source. This configuration represents a combination of FIGS. 5B and 5C. As shown, power is now discharged out of charger plug 308 through a combination of power from AC port 306, battery 304b, and DC port 310. This can be used where power from all inputs is required to satisfy the charging demand, from charger plug 308.

While configurations in FIGS. 5B-5D supply output to charger plug 308, configurations can also supply output to DC port 310 (FIG. 5E). Other example configurations using more than one input power source are also possible, although not explicitly illustrated. In FIG. 5F, a combination of output power from AC port 306 and battery subsystem 304b can meet charging requirements for DC loads, coupled to DC port 310.

Reference is now made to FIG. 5AA which illustrates the integrated charger 302a″ operating in the high AC mode. In the high AC mode configuration, operational switch 424 is in the first closed position and operational switch 426 is in the open position, disconnecting DC/DC converter 408 from the remainder of the integrated charger 302a″. In this position, AC port 306 is directly connected to the common DC bus 414, allowing the input AC voltage to directly power the integrated charger and directly supply output DC power to charger plug 308. The configuration in FIG. 5AA is analogous to the configurations shown in FIGS. 5A-5F.

Similar to the configurations in FIGS. 5A-5F, input AC power flows from AC port 306 through AC/DC converter 402. AC/DC converter 402 transforms the AC power into DC power, and the DC power flows into the common DC bus 414. AC/DC converter 402 may boost-up the output DC power to the pre-defined DC bus 414 voltage. For example, for a 3-phase 480V supply, the AC/DC converter 402 may boost the output DC to 800 VDC. As another example, for a 3-phase 600V supply, output DC may be boosted to 900 VDC and accordingly, the DC bus 414 voltage may be 900 VDC.

In some cases, battery 304b′ may be activated, analogous to FIGS. 5B-5D and 5F). Discharged battery power can supplement power from AC port 306. For example, power from AC port 306 may be insufficient to accommodate the charging requirements of an EV coupled to charger plug 308. Accordingly, power from the battery 304b′ is drawn to supplement power from AC port 306. In this example, the DC/DC converter 406 may boost-up the output battery voltage to the DC bus voltage 414.

Switch 416 may be in the closed or open position depending on the configuration selected, analogous to FIGS. 5A-5Y. When switch 416 is in the closed position, similar to, for example, FIGS. 5C-5F, power flow may be enabled and, no power may be discharged from battery subsystem 304b′.

In some examples, the high AC charging mode can also include outputting power only from the battery 304b. For example, this can be used where there is no available input AC power.

(ii) Example Configurations for the DC Charging Mode Using a Low Input AC Voltage

Reference is now made to FIGS. 5G-5O, which illustrate different configurations for the integrated charger 302a operating in the low AC mode.

The low AC mode can be used where the input AC voltage is below a pre-determined threshold. Alternatively, or in addition, these configurations are used where there is no input AC voltage (e.g., in off-grid locations or during a grid fault).

Low AC mode configurations are generally characterized by the operational switch 422 being either in the second close state, or alternatively, the open intermediate state. In these positions, AC port 306 is disconnected from the DC common bus 414. This prevents the AC/DC converter 402 from operating inefficiently, to boost-up the input voltage to the DC bus 414 voltage (FIG. 6B). In these examples, output voltage from the battery 304b is used to meet the voltage threshold for the DC common bus 414.

In further detail, the low AC mode configurations include, by way of example: (a) configurations which use input AC power, as well as power from other input power sources (FIGS. 5G-5I); (b) configurations using only stored battery power (FIG. 5J-5K); (c) configuration which do not use input AC power, but use other input power sources (FIGS. 5L-5O). These configurations, as well as their purposes, are explained in greater detail below.

Reference is now initially made to FIGS. 5G-5I, which show configurations which use a combination of input AC power, with power from other input power sources.

FIG. 5G shows a first example of such a configuration. This configuration uses a combination of power from AC port 306 and battery 304b. The combined power is output from the charger plug 308. Advantages of this configuration are explained shortly herein.

In this configuration, operational switch 422 is in the second, closed state. In this state, AC/DC converter 402 couples in parallel, to battery 304b, via intermediate DC bus 412c.

AC/DC converter 402 can boost-up (or buck-down) voltage from AC port 306 to output DC voltage at the battery voltage level. That is, as contrasted to the high AC mode—AC/DC converter 402 is not required to boost-up its output DC voltage to the higher DC bus 414 voltage (e.g., 800 VDC). Rather, AC/DC converter 402 is controlled to only boost its output to the lower DC battery voltage (e.g., 450 VDC). As such, AC/DC converter 402 can operate more efficiently to avoid example plot 600b in FIG. 6B. Converter 402 may accordingly operate to boost the lower input AC voltage, to a lower output DC voltage—corresponding to the parallel battery voltage.

To this end, battery 304b is selected to have an output DC voltage that is lower than the DC bus voltage. For example, battery 304b can have a voltage that is higher than the low input AC voltage, but lower than the DC bus voltage (e.g., 450 VDC rather than 800 VDC).

In some examples, an internal or external switch—associated with AC/DC converter 302—is closed. This enables power flow through the AC/DC converter 302.

During operation, battery DC/DC converter 406 can boost-up the battery voltage to the pre-defined, DC bus 414 voltage. For example, DC/DC converter 406 can boost-up the voltage from 450 VDC to 800 VDC. In this manner, the DC bus 414 receives a stable 800 VDC voltage, and also receives combined power flow from battery 304b and AC port 306. This power flow is then fed to the DC/DC converter 406, and then further output from charger plug 404.

It is therefore appreciated that, in FIG. 5G, when the AC voltage is low—it is the higher voltage from the battery 304b that ensures a high, stable DC bus 414 voltage. This lessens the burden on the AC/DC converter 402 to boost-up the low input AC voltage to the higher, DC bus 414 voltage. Further, the combination of power flow from AC port 306 and battery 304b accommodates for the charging requirements at charger plug 308.

FIG. 5H shows a second example of a configuration, also using the AC power supply as well as other input power sources. This configuration is analogous to FIG. 5G, but additionally includes power draw from DC port 310. This configuration can be used when additional power is required from DC port 310 for charger plug 308.

In this configuration, DC port switch 416 is in the closed state. This allows DC power to flow from external DC sources, coupled to the DC port 310.

In another example configuration (not shown), FIG. 5H can be used without battery 304b. For example, if the battery is empty—or it is not desired to use the battery—then only DC power from port 310 is used.

FIG. 5I shows a third example of a configuration, using the AC power supply as well as other input power sources. This configuration is analogous to FIG. 5G, but now outputs power from DC port 310 (i.e., rather than charge plug 308).

For example, as shown, DC loads can couple to DC port 310 to receive power therefrom. The DC loads can be external DC loads, or other integrated chargers 302 that benefit from power sharing. The DC loads are serviced by the combined power from AC port 306, and battery 304b. In this configuration, charger plug DC/DC converter 404 is controlled to prevent power flow therethrough. As such, all power is re-routed to the DC port 310.

In other example configurations, the DC/DC converter 404 is activated, such that power flow is directed to both the DC port 310 and charger plug 308.

While not explicitly shown, FIGS. 5G, 5H and 5I may also exclude the battery subsystem 304b. For example, it is possible that the battery 304b is depleted from charge, or otherwise disconnected. In this case, DC power may still flow from the AC/DC converter 402 to the battery DC/DC converter 404, via operational switch 422 (e.g., as shown in FIGS. 5G, 5H and 5I). The power can flow to one or both of the charger plug 308 and DC port 310.

In these examples, where battery 304b is not used—the AC/DC converter 402 and DC/DC converter 406 can operate, together, to boost-up voltage. In other words, the converters 402, 406 boost-up the low input AC voltage, to the high DC bus voltage—without using battery 304b. By way of example, (i) first, AC/DC converter can boost-up the low input AC voltage to a first pre-defined voltage (e.g., 450 VDC), while (ii) DC/DC converter 406 can further boost-up the voltage to 800 VDC. This is another way of accomplishing the same function of boosting up low input AC voltage.

Reference is now made to FIGS. 5J-5K, which show further configurations for the low AC mode. As contrasted to previously described configurations, these configurations rely only on stored power in battery 304b, and additionally, do not rely on operational switch 422 having a specific positional state.

In more detail, the exemplified configurations can be used if no input AC power is available (i.e., from AC port 306). For example, this includes example cases where the AC supply is disconnected from AC port 306. Alternatively, a temporary or permanent grid fault can make the input AC supply unavailable. In these examples, stored battery power is relied on to charge external systems.

FIG. 5J shows a first example of such a configuration. This configuration allows discharging power from charger plug 308.

In this example, AC/DC converter 402 is disconnected from the remainder of the integrated charger 302a. The disconnection can occur in different ways. For example, the operational switch 422 is modified to the intermediate, open state. Otherwise, a switch associated with the AC/DC converter 302 (e.g., an internal or external switch), is opened to disconnect power flow. If this converter switch is opened, then operational switch 422 can be in any positional state. Additionally, DC port switch 416 is also open to prevent power flow therethrough.

As shown in FIG. 5J, battery DC/DC converter 406 is controlled to discharge DC power. The converter 406 boosts-up the output battery voltage to the DC bus 414 voltage.

FIG. 5K shows a second example configuration relying only on power discharged from battery 304b. This configuration is analogous to FIG. 5J, with the exception that power is discharged from DC port 310 (i.e., as opposed to charger plug 308). DC loads—including other integrated chargers 302—can be coupled to DC port 310.

In this example, the DC port switch 416 is closed. Further, charger plug DC/DC converter 404 is controlled to prevent current flow therethrough.

A configuration comprising the combination of FIGS. 5J and 5K is also possible. For example, stored battery power is dischargeable from both charger plug 308 and DC port 310. In this example, DC port switch 416 is closed. Further, charger plug DC/DC converter 404 is controlled to enable power flow therethrough.

Reference is now made to FIG. 5L, which shows still a further configuration for the low AC mode. This configuration uses more than one power source for DC charging. However, in contrast to FIGS. 5G-5I, this configuration does not rely on available input AC power (i.e., from AC port 306)

In more detail, FIG. 5L uses a combination of the battery 304b and DC port 310. The combined input power allows discharging DC power from charger plug 308. This configuration can be used as an alternative to FIG. 5J. For example, if power supply from the battery alone in FIG. 5J is insufficient to meet charging demand—the configuration of FIG. 5L can be used to draw additional power from DC port 310.

As shown, the DC port switch 416 is closed in this configuration. DC power is received from an external DC power supply, which can include another external integrated charger 302.

Reference is now made to FIG. 5M, which show still a further configuration for the low AC mode. In this configuration, only power from DC port 310 is used to discharge power from charger plug 308.

This configuration is generally analogous to the configuration in FIG. 5L, but relies only on DC power from DC port 310. In some examples, this configuration is used where there is no available stored DC power in battery 304b. It can also be used where it is not desired to discharge power from battery 304b.

In this example, the DC port switch 416 is closed to receive power therefrom. DC/DC converter 406 is also operated to prevent power flow from battery subsystem 304b.

FIGS. 5N and 5O show additional configurations for the low AC mode, and for discharging from DC port 310. These include using only the charger plug 308 and battery 304b (FIG. 5N), or using only the charger plug 308 (FIG. 5O).

Reference is now made to FIG. 5AA which illustrates the integrated charger 302a″ operating in the low AC mode. The low AC mode can be used where the input AC voltage is below a pre-determined threshold (e.g., a 208V supply). Alternatively, or in addition, these configurations are used where there is no input AC voltage (e.g., in off-grid locations or during a grid fault). In the low AC mode configuration, operational switch 424 is in the second closed position and operational switch 426 is in the closed position, connecting DC/DC converter 408 to the remainder of the integrated charger 302a″ and disconnecting AC port 308 from the DC common bus 414. Connecting DC/DC converter 408 can boost up the voltage from intermediate bus 412 to meet the voltage threshold for the DC common bus 414. In this configuration, AC/DC converter 402 can boost-up voltage from AC port 306 to output DC voltage at the intermediate DC bus 412 in the range of about 400 VDC-480 VDC and DC/DC converter 408 can boost-up the voltage at the intermediate DC bus 412 to the voltage threshold for the DC common bus (e.g., 800 VDC). By using DC/DC converter 408, AC/DC converter 402 is not required to boost its output DC voltage to the higher DC bus 414 voltage. Converter 402 may accordingly operate to boost the lower input AC voltage, to a lower output DC voltage.

Analogous to the configurations in FIG. 5G-5I, the configuration in FIG. 5AA can use a combination of power from AC port 306 and battery 304b′ and DC/DC converter 406 can boost-up the battery voltage to the pre-defined, DC bus 414 voltage. The configuration in FIG. 5AA can additionally include power drawn from DC power 310. In this configuration, DC port switch 416 is in the closed state, allowing DC power to flow from external DC sources, coupled to the DC port 310. The configuration in FIG. 5AA can also output power from DC port 310.

In other example configurations, the DC/DC converter 404 is activated such that power flow is directed to both the DC port 310 and the charger plug 308. Analogous to FIGS. 5G-5I, the configuration in FIG. 5AA may also exclude the battery subsystem 304b′.

(iii) Example Configurations for Battery Re-Charging Mode

In addition to the high and low AC modes used for DC charging, which are explained above—integrated charger 302a can also operate in a battery re-charging mode.

The battery re-charging mode allows re-charging the rechargeable battery 304b if it is depleted, or otherwise, the battery has state of charge below a pre-determined threshold (e.g., below 10%). For example, in the course of operating the integrated charger 302—the battery charge may be depleted overtime. Accordingly, the battery re-charging mode can replenish the battery charge for continued operation.

Reference is now made to FIGS. 5P-5U, which show example configurations for a battery re-charging mode. The illustrated configurations include: (i) high input AC voltage, battery re-charging configurations (FIGS. 5P and 5Q); and (ii) low input AC voltage, battery re-charging configurations (FIGS. 5R-5U).

For FIGS. 5T and 5U, the operational switch 422 may have any of a number of positional states. In some examples, the configuration of FIG. 5U can also be used for the high input AC voltage case.

Referring initially to FIGS. 5P and 5Q, which show example high input AC voltage, battery re-charging configurations. These configurations can re-charge the battery 304b using an input AC supply (i.e., coupled to AC port 306), where the AC supply has a high input voltage.

FIG. 5P shows a first example of such a configuration. This configuration uses only input AC power, from port 306, to re-charge battery 304b.

In this example, operational switch 422 is in the first, closed state. Accordingly, AC/DC converter 402 feeds directly to the common DC bus 414. The AC/DC converter 402 boosts-up (or bucks-down) the input AC voltage to the pre-defined DC bus voltage. DC power may then travel through the bi-directional battery DC/DC converter 406. The DC/DC converter 406 may buck-down the DC voltage to the pre-defined battery voltage, so as to re-charge the battery 304b.

In this configuration, an external (or internal) switch of the AC/DC converter 402 is closed to allow power flow. Further, the DC port switch 310 can be opened. Charger plug DC/DC converter 404 can be controlled to prevent current flow therethrough.

FIG. 5Q shows a second example of such a configuration, using a hybrid power flow from AC port 306 and DC port 310.

This configuration is generally analogous to FIG. 5P, with the exception that the DC port switch 416 is closed. This can facilitate power flow from external DC supplies, coupled to DC port 310. In some examples, this configuration is used where the power from the input AC supply is insufficient power to re-charge battery 304b. Integrated charger 302a″ may also operate in a high input AC voltage, battery re-charging mode, using configurations analogous to the configurations in FIGS. 5P-5Q.

Referring now to FIGS. 5R and 5S, which show example low input AC voltage, battery re-charging configurations. These configurations can re-charge battery 304b, using an input AC supply coupled to port 306, where the AC supply has a low input voltage.

FIG. 5R shows a first example of such a configuration, using only the input AC supply. In this configuration, the operational switch 422 is in the second, closed state. Accordingly, AC/DC converter 402 connects directly to battery 304b, via intermediate DC bus 412.

In this example, AC/DC converter 402 is controllable to receive the low input AC voltage and output a DC voltage equal to the battery voltage. Similar to the low AC mode configuration—in this example, AC/DC converter 402 is not required to output at the higher DC bus 414 voltage (FIG. 6B).

FIG. 5S shows a second re-charging configuration using low input AC power. This configuration uses more than one power source to re-charge the battery 304b.

In this example, the battery 304b is recharged from both the AC port 306, as well as the DC port 310. In some examples, this configuration is used where power from AC port 306 is insufficient to re-charge the battery 304b. Accordingly, additional power is supplied from DC port 310.

In more detail, the DC port switch 416 is closed to receive external DC power. DC power flows through the bi-directional battery DC/DC converter 406. Battery converter 406 down-converts the DC power from DC bus 414 voltage to the battery voltage.

Referring now to FIGS. 5T and 5U, which show further configurations for the battery re-charging mode.

As contrasted to the previous configurations, these configurations re-charge the battery without using the input AC supply (i.e., from AC port 306). For example, these configurations can be used if the input AC supply is unavailable, or otherwise, there is a grid fault. Using these configurations, the battery can still be re-charged.

FIG. 5T shows a first example of such a configuration. In this example, power from the DC port 310 is used to re-charge battery 304b. In this example, the DC port switch 416 is closed. Accordingly, DC power from external DC supplies are used to re-charge battery 304b.

In this example, the AC port 306 can be disconnected from the charger. For example, the operational switch 422 is positioned in the open, intermediate state. Additionally, or in the alternative, an external or internal switch—associated with AC/DC converter 402—is opened, to prevent power flow.

FIG. 5U shows a second example of such a configuration. This configuration is generally analogous to FIG. 5T, with the exception that battery 304b is charged using power from charger plug 308. For example, DC power is drawn from a DC system (e.g., EV) plugged into charger plug 308, and re-charges battery 304b. In this case, DC/DC converter 404 boosts-up, or bucks-down volage from charger plug 308 to the pre-defined DC bus 414 voltage.

In some examples, this configuration is used as a back-up configuration if no AC supply or DC port supply is available.

While not explicitly shown, it will be understood that other configurations are possible. For example, a combination of FIGS. 5T and 5U is possible whereby the battery 304b is re-charged using combined power from the charging plug 308 and DC port 310.

(iv) Example Configurations For AC Output Charging Mode

Integrated charger 302a can also operate in a reverse, AC charging mode. In this mode, the integrated charger 302 can charge AC loads coupled to AC port 306. For example, this can include Evs requiring level two AC charging.

More generally, the AC charging mode can also provide AC grid support. For example, where an AC grid—coupled to AC port 306—is under duress, this mode can provide AC power support to the grid. This is particularly useful for emergency energy support during blackouts, or utility demand response support.

Reference is now made to FIGS. 5V-5Y, show example configurations for the AC charging mode.

The AC charging mode configurations include: (i) one or more low AC output AC voltage configurations (FIGS. 5V-5W), and (ii) one or more high AC output voltage configurations (FIGS. 5X-5Y).

Reference is initially made to FIGS. 5V-5W, showing the one or more low AC output voltage configurations.

These configurations can be used where it is desired to output AC voltage below a pre-determined threshold. These configurations are generally characterized with the operational switch 422 being in the second, closed position. In this position, the AC/DC converter 402 is not connected to the higher voltage, common DC bus 414. Rather, the AC/DC converter 402 is connected to the intermediate bus 412 and can receive low DC voltage power therefrom. AC/DC converter 402 may then operate efficiently to only upconvert (or down convert) the input DC voltage by a minimal amount. This can be regarded as the reverse situation of FIG. 6B.

FIG. 5V shows a first example low AC output power configuration. In this example, stored DC power from battery 304b is used to discharge AC power. The operational switch 422 is in the second, closed state. Accordingly, the battery 304b is directly coupled to the AC/DC converter 402. AC/DC converter 402 operates bidirectionally to convert DC power into output AC power. The AC/DC converter 402 can also boost-up, or buck-down, the lower battery voltage into output AC power.

FIG. 5W shows a second example low AC output power configuration. In this configuration output AC power is generated based on both power discharged from the battery subsystem 304b, as well as one or more of the DC port 310 and charger plug 308. This configuration can be used where additional output AC power is required (e.g., based on the output AC power demand). In this example, power discharged from battery subsystem 304b may be insufficient.

While not shown, additional low AC output power configurations are also possible. These configurations may be analogous to FIG. 5W, but can exclude the battery 304b. For example, only power from charger plug 308 and/or DC port 310 can be used to output AC power, depending on availability. These configurations can be useful, for example, where the battery 304b is depleted from stored power. The operational switch 422 would still be in the second, closed state.

Reference is now made to FIGS. 5X-5Y, showing the one or more high output AC voltage configurations.

In contrast to FIGS. 5V and 5W, these configurations can be used where it is desired to output AC voltage above a pre-determined threshold. These configurations are generally characterized by the operational switch 422 being in the first, closed position. In this position, the AC/DC converter 402 is connected to the higher voltage, common DC bus 414. As such, the AC/DC converter 402 can convert (e.g., boost-up or buck-down) the DC bus voltage, to a higher output AC voltage. This is regarded as the reverse situation of FIG. 6A.

FIG. 5X shows a first example high AC output configuration. In this example, battery DC/DC converter 406 up-converts battery voltage to the higher DC bus 414 voltage. DC power flows through the bus 414, and is output from AC port 306, via AC/DC converter 402. AC/DC converter 402 may boost-up the DC bus 414 voltage, to the desired output AC voltage.

Accordingly, the combination of the DC/DC converter 406, and AC/DC converter 402, generate the higher output voltage. In other examples, AC/DC converter 402 can also buck-down the DC bus 414 voltage, if necessary.

FIG. 5Y shows a second example high AC output voltage configuration. This configuration is a hybrid configuration, based on a combined power discharge from the battery subsystem 304b, as well as one or more of the DC port 310 and charger plug 308.

In some examples, this configuration is used where additional output AC power is required. For instance, power discharged from battery subsystem 304b may be insufficient.

While not shown, additional high AC output power configurations are also possible. These configurations may be analogous to FIG. 5Y, but can exclude the battery 304b. For example, only power from charger plug 308 and/or DC port 310 can be output as AC power, based on availability. For example, these configurations can be useful where battery 304b is depleted from stored power. The operational switch 422 may still be in the first, closed position in these configurations.

In an example case where FIGS. 5W and 5Y are used for AC grid support, these configuration can enable a vehicle to grid (V2G) function using charger plug 308. With V2G operation, vehicle battery information is transferred to controller 450. Controller 450 can determine if it is necessary to export the vehicle battery energy for grid support. FIG. 5O shows an example configuration where a system coupled to charger plug 308 (e.g., an EV), can also be used to supply power to DC loads coupled to DC port 310.

### IV. Example Methods for Operating Example Integrated Charger

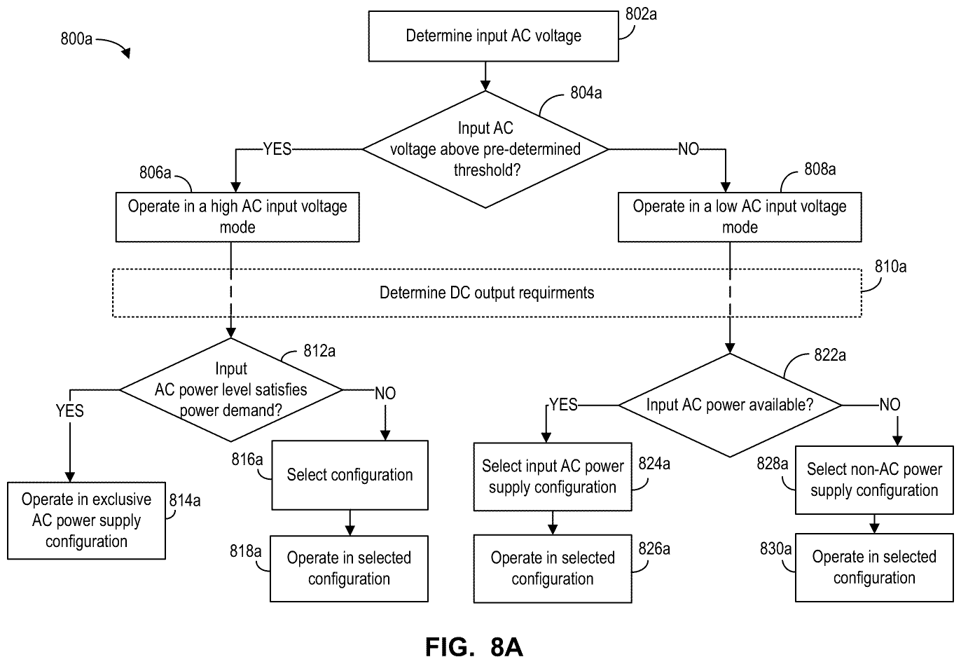

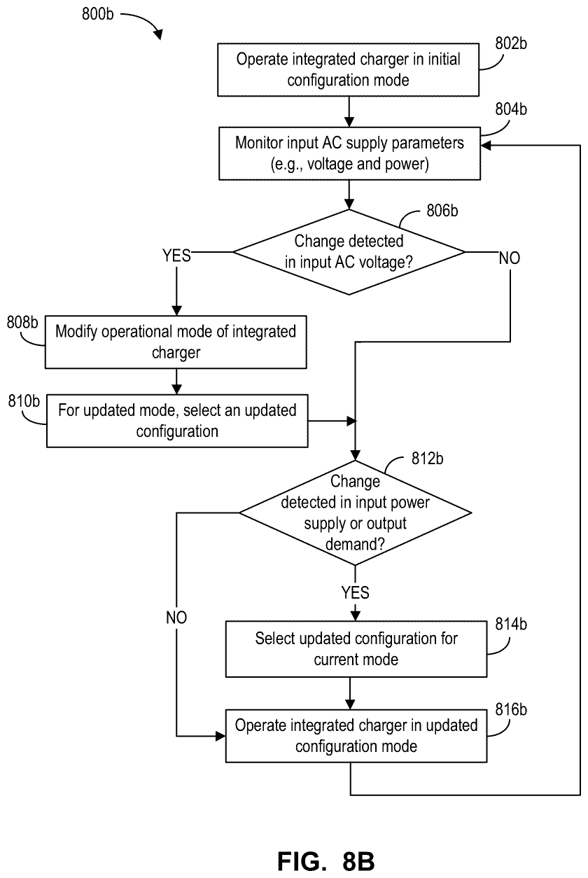

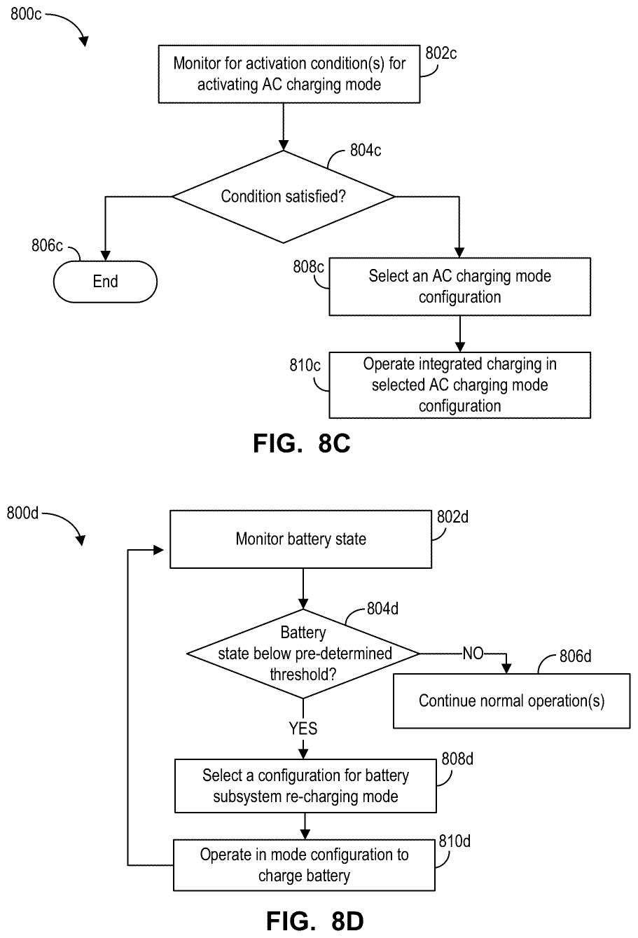

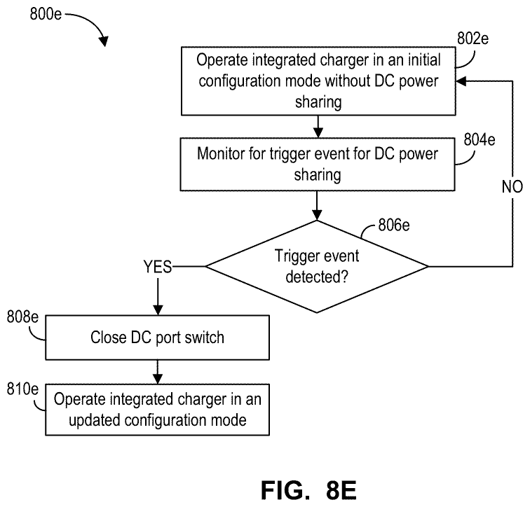

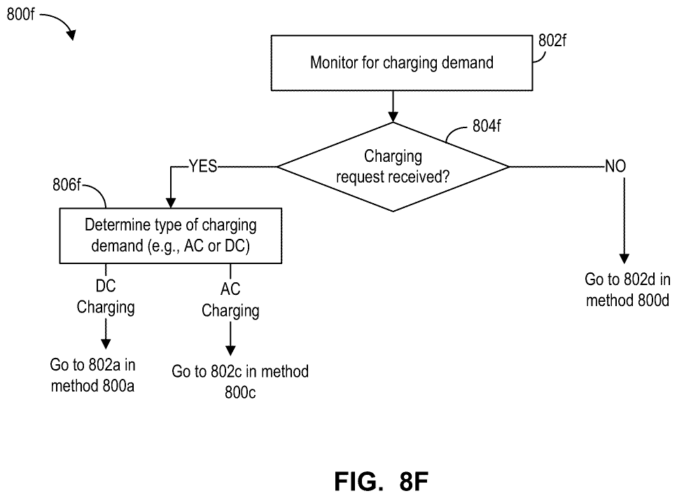

FIGS. 8A-8E show various process flows for example methods for operating the example integrated charger 302a. It will be understood that analogous methods can be used for other hardware architectures of the integrated charger 302.

(i) Example Method of Operating Integrated Charger in DC Charging Modes

Reference is now made to FIG. 8A, which shows an example method for operating the integrated charger 302a in one or more DC charging modes (FIGS. 5A-5O).

At 802a, the peak magnitude for the input AC voltage, at AC port 306, is determined. For example, this can correspond to 604a, 604b in FIGS. 6A and 6B. The peak magnitude can be determined using various methods. In at least one example, the peak magnitude is simply known ahead of time. For example, the integrated charger 302 can be coupled to an AC grid supply having a known peak voltage.

In other examples, the peak magnitude is measured using one or more sensors. For example, sensors are coupled to the AC supply to measure the input AC voltage. These are shown as sensors 410 in FIGS. 4A and 4B. For example, the sensors can include voltage sensors, for measuring input AC voltage data. The sensors can transmit sensor data (e.g., voltage data) to controller 450. In other cases, a human operator can read the sensor data, and input/transmit the data to controller 450.

At 804a, a determination is made as to whether the input AC voltage is above a pre-determined threshold (e.g., it is a high input voltage, as previously defined). In some examples, the determination is made automatically by the controller 450. In other cases, this can be a manual determination.

If the input AC voltage is above the threshold, then at 806a, the integrated charger 302a is operated in a high input AC voltage mode (FIGS. 5A-5F, 5Z). Otherwise, at 808a, the integrated charger 302a is operated in a low input AC voltage mode (FIGS. 5G-5M, 5AA).

At 810a, in some examples, irrespective of the determination at 804a— the DC output requirements for the integrated charger 302a and/or DC port 310 are determined. The DC output requirements correspond to the required output voltage, power, etc. from the integrated charger 302a. The DC output requirements can be determined for one, or both, of the charger plug 308 and DC port 310. For example, each of the charge plug 308 and DC port 310 are couplable to external DC loads, that can be serviced by the integrated charger.

In respect of the charger plug 308, the DC output requirements can correspond to the charging requirement of a system coupled to charger plug 308. For example, if an EV is coupled to the charger plug 308—at 810a, the charging requirements for the EV are determined. The charging requirements can include, for example: the EV battery voltage, maximum energy required, EV battery temperature, EV battery state of charge. The charging requirements can be communicated automatically, or upon request, by the EV on-board computer to the controller 450.

In some examples, at 810a, it can also be determined, more precisely, which of the charger plug 308 and/or the DC port 310 requires power discharge. In some examples, this is determined by monitoring any charging requests received from plug 308 or port 310. This can assist in determining the correct configuration for the integrated charger 310.

Although shown as being performed after acts 806a and 808a, act 810a can also be performed at any time prior acts 806a and 808a.

At 812a, if operating in a high AC voltage mode, a determination is made as to whether the input AC power level—from AC port 306—satisfies the required output power demand (e.g., at charger plug 308 and/or DC port 310). The output power demand is determined, for example, based on information at 810a. The input AC power satisfies the output demand if it is equal to, or greater than, the power demand.

The input AC power level can be determined in various manners. For example, it can be determined by controller 450 based on sensor data, generated by sensors 410 (FIGS. 4A and 4B). In other examples, the input AC power level can be externally communicated to controller 450. For instance, a global controller—that monitors AC grid power level—can communicate this information to the controller 450.

If the input AC power level satisfies the required demand—then at 814a, the integrated charger 302a can be operated in an exclusive AC power supply configuration (FIGS. 5A and 5E), in the high AC power mode.

To this end, the configuration in FIG. 5A is selected if it is determined (at act 810a) that the integrated charger 302a is only servicing the charger plug 308. Otherwise, the configuration in FIG. 5E is selected if the integrated charger 302a is determined to only service the DC port 310.

As noted before, a combined configuration can also be used to service both the charger plug 308 and DC port 310, concurrently. In any case, at act 814a controller 450 may automatically configure and operate the integrated charger 302a in the appropriate exclusive AC power supply configuration.

Otherwise, at 812a, if the input AC power level does not satisfy the required power demand—then the integrated charger 302a is operated in a configuration using more than one input power source, in the high AC mode (FIGS. 5B-5D and 5F). As noted previously, these configurations supplement the input power from AC port 306, with power from one or both of the battery 304b and DC port 310. In other examples, the charger can be used only with the battery 304b.

Accordingly, at 816a, an appropriate configuration, that uses more than one input power supply, is determined for the integrated charger 310a.

For example, if the integrated charger 302a is servicing only the DC port 310—then at 816a, the configuration of FIG. 5F is selected. In this example, the battery 304b supplements the input power from AC port 306. In FIG. 5F, DC power from charger plug 308 can also be drawn, if available, to supplement the input AC power. This can be used in addition to, or in the alternative of, DC power from battery 304b. For example, if battery 304b is depleted of stored power, DC power can be drawn from a system coupled to charger plug 308, via bi-directional DC/DC converter 404.

Otherwise, at act 816a, if the integrated charger 302a is serving the charger plug 308—then one of the configurations in FIGS. 5B-5D are selected.

The determination as to which of the configurations in FIGS. 5B-5D to select can be based on a number of configuration selection factors, including: (a) determining if there is sufficient power stored in battery 304b to supplement the deficiency in input AC power—if so, the configuration in FIG. 5B is selected. Otherwise, one of FIGS. 5C-5D is selected; (b) determining whether the battery 304b is depleted—if so, then the configuration of FIG. 5C is selected, otherwise the configuration of FIG. 5D is selected. Other selection factors can include, for example, whether the DC port 310 is coupled to any DC power supply, and whether there are any prioritization criteria between using the battery 304b versus using power from DC port 310.

In some examples, the configuration selection factors can be pre-programmed into the controller 450.

At 818a, the integrated charger 302a is operated in the configuration mode, selected at 816a.

Returning to 804a, if the input AC voltage is below the pre-determined threshold—then at 808a, the integrated charger 302a is operated in a low AC input voltage mode (FIGS. 5G-5M).

At 822a, it is determined whether input AC power is available, from AC port 306. For example, input AC power may not be available if there is a permanent or temporary grid fault. In some examples, this is determined based on sensor data from sensors 410 (FIG. 4A). In other examples, this information is externally communicated to the local controller 450.

If input AC power is available, then at 824a, a configuration is selected which uses power from the input AC supply (i.e., via port 306), as well as from one or more other input power sources (FIGS. 5G-5I).

The selection of the configuration, at 824a, is also based on one or more configuration selection factors. These factors can include, for example, (a) determining whether there is sufficient power from the input AC supply to meet the DC output requirements—if so, then a configuration analogous to FIGS. 5G and 5I is selected, but without operating battery 304b. For example, a configuration analogous to FIG. 5G is selected to service charger plug 308, and/or a configuration analogous to FIG. 5I is selected to service the DC port 310; (b) if the input AC power supply is not sufficient—a further determination can be made as to whether the battery 304b has sufficient stored power to supplement the input AC power—if so, then the configurations of FIGS. 5G and 5I are selected; (c) otherwise, if there is insufficient stored DC power in battery 304b—a determination is made as to whether any DC source is coupled to the DC port 310. If so, the configuration of FIG. 5H is selected. In FIG. 5H, power from DC port 310 supplements power from battery 304b and/or input AC power.

At 826a, the integrated charger 302a is configured and operated in the selected low input AC voltage configuration mode.

Returning to act 822a, if input AC power is not available—then at 828a, one of the configurations in FIGS. 5J-5O is selected. These include: (i) configurations that use only power discharged from battery 304b (FIG. 5J-5K); (ii) configurations that use more than one input power source, but do not otherwise rely on an input AC power supply (FIGS. 5L and 5N); and (iii) configurations using only power from DC port 310 (FIGS. 5M and 5O).

Again, configuration selection factors can be used at 828a to select the correct configuration. The configuration selection factors can include, for example: (a) determining whether there is sufficient stored DC power in battery 304b to meet the DC output charging requirements—if so, then one of the configurations of FIGS. 5J and 5K is selected. For example, FIG. 5J is selected to service charger plug 308, and/or the configuration of FIG. 5K is selected to service the DC port 310; (b) if there is Insufficient stored DC power in battery 304b—then a determination can be made as to whether any external DC supplies are coupled to DC port 310 and/or charger plug 308—if so, then the configuration at FIG. 5L is selected to service the charger plug 308 using supplementary power from DC port 310, or configuration of FIG. 5N is selected to service the DC port 310; and (c) if external DC power is coupled to DC port 308, and the battery 304b is depleted—then the configurations of FIG. 5M or 5O are selected, as necessary.

At 830a, the integrated charger 302a is operated in the selected low input AC voltage configuration mode.

Reference is now made to FIG. 8B, which shows an example method 800b for modifying the operation mode and/or configuration of an integrated charger 302a in real-time, or near real-time, during DC charging.

In some examples, method 800b enables “on-the-fly” modification to the configuration mode of the integrated charger 302, in response to changes in the input AC voltage and/or power. Method 800b can be performed, in whole or in part, by controller 450.

At 802b, the integrated charger 302a is operated in an initial configuration mode. For example, this can be one of the configurations in the high or low input AC voltage modes used for DC charging.

At 804b, input AC supply parameters are monitored. Input AC supply parameters relate to any measurable parameter of the input AC power, from AC port 306. For example, this can include the peak AC voltage magnitude, the peak AC power, etc. This can be monitored using one or more of the sensors 410.

At 806b, a determination is made as to whether a change in the input AC voltage is detected. For example, this can include determining whether the input AC voltage has decreased below a pre-determined threshold (e.g., below 60% of the normal voltage) to become a low input AC voltage. Alternatively, it can include determining whether the input AC voltage has increased above a pre-determined threshold to become a high input AC voltage. In some examples, the change should be detected for a pre-determined time period.

At 808b, if a change is detected, then the operational mode of the integrated charger mode is modified. For example, the integrated charger is modified from a high AC mode to a low AC mode, or vice-versa, based on whether the input AC voltage is now above or below the pre-determined threshold, respectively.

At 810b, for the updated mode, an updated configuration is selected for the integrated charger 302a. The selection can be based in accordance with the selection factors, as described at acts 812a-830a of FIG. 8A. For example, if the operational mode is modified to a high AC mode at act 808b, then the appropriate configuration is selected based on acts 812a-818a. Alternatively, if the operational mode is modified to a low AC mode at act 808b, then the appropriate configuration is selected based on acts 822a-830a.

At act 806b, if no change is detected in the input AC voltage, then the no change in the operational mode is required (e.g., low AC mode versus high AC mode). Accordingly, the method can proceed directly to 812b.

At 812b, a further determination is made as to whether there is a change in the available input power, or the required output power demand (e.g., for charger plug 308 and/or DC port 310).

For example, this can include determining that the: (i) input AC power declined below, or otherwise exceeded the required output power demand; (ii) detecting the battery 304b is low on stored power, or is below a pre-determined threshold or is otherwise depleted; (iii) detecting an increased power demand from the charger plug 308 and/or DC port 310, etc. In other words, act 812b involve detecting any change that would necessitate changing the configuration of the integrated charger 302a.

If so, at 814b, an updated configuration is selected for the current operational mode. The updated configuration can be selected using the configuration selection factors described at acts 816a, 824a and 828a of FIG. 8A for a given operational mode. At 816b, the integrated charger 302a is operated in the updated configuration. Method 800b can return to act 804b to continue monitoring input AC supply parameters.

In some examples, acts 812b and 814b can be integrated directly into act 810b. For example, at act 810b, when selected an updated configuration for the new mode—the system may initially determine if there is a change in input power (act 812b), and select an updated configuration on this basis (act 814b).

(ii) Example Method for Operating Integrated Charger in AC Output Charging Mode

Reference is now made to FIG. 8C, which shows an example method 800c for operating the integrated charger 302a in an AC output charging mode (FIGS. 5V-5Y). Method 800c can be performed by the controller 450.

At 802c, one or more conditions for activating the AC charging mode are monitored. For instance, the AC charging mode can be activated to provide grid support for an overloaded AC grid, coupled to AC port 306. Accordingly, an activation condition can involve determining that the coupled AC grid is experiencing a fault, or requires additional support. This can be determined in various manners. For example, sensors 410 can be used to determine a reduction of the input AC supply below a pre-determined threshold, thereby indicating a grid fault. Otherwise, a request for grid support can be received at the controller 450, e.g., from an external controller or operator. Accordingly, the request can be an activation condition.

In other examples, the activation condition can relate to a need to charge an AC load, coupled to AC port 306. This is another use case for the AC charging mode, and is useful for charging eVs compatible with level “2” chargers. The need to charge an AC load can be identified, for example, based on detecting an AC load coupled to AC port 306. In other cases, a request can be detected via the AC port 306 (via control cables running through the port).

In some examples, an additional condition for activating the AC charging mode is ensuring that the integrated charger is not already operating in a DC charging mode (as discussed above). This prevents inadvertently operating the integrated charger in the AC mode, while the charger is in a DC mode. In other cases, this may not be a necessary condition.

At 804c, it is determined whether the activation condition(s) are satisfied. If not, the method may end at 806c, or otherwise, the integrated charger 302a can resume normal operations.

Otherwise, at 808c, an AC charging mode configuration (FIGS. 5V-5Y) is selected. The configuration can be selected based on one or more configuration selection factors for the AC charging mode.

By way of example, the selection factors can include: (i) determining whether a high voltage or low voltage AC output is required (see e.g., definition of corresponding high and low input AC voltage, as provided above)—if a low AC voltage output is desired, then one of the configurations of FIG. 5V or 5W are selected. Otherwise, if a high voltage output is desired, the configurations of FIG. 5X or 5Y are selected. The desired voltage level can be determined based on pre-defined information provided to controller 450, or using sensors 414. The AC/DC converter 402 can also be controlled to boost-up or buck-down the voltage as required, for more fine precision; (ii) in either case, further determining whether there is sufficient battery charge to provide AC charging—if so, then the configurations of FIG. 5V or 5X can be selected, respectively. Otherwise, the configurations of FIG. 5W or 5Y can be selected. The configurations of FIGS. 5W and 5Y supplement the battery output with additional power from the charger plug 308 and/or the DC port 310. To this end, an additional act that may performed, prior to act 808c is determining the AC output power requirements. The AC output power requirements can help determine if the battery output power needs to be supplemented with additional power from the charger plug 308 and/or the DC port 310.

In some examples, only the charger plug 308 and/or DC port 310 can be used to output AC power, without the battery being used. For example, this may be performed if the battery is depleted.

At 810c, the integrated charger 302a is operated in the selected AC charging mode configuration.

(iii) Example Method for Operating Integrated Charger in Battery Re-Charging Mode

Reference is now made to FIG. 8D, which shows an example method 800d for operating the integrated charger 302a in a battery re-charging mode (FIGS. 5P-5U). Method 800d can be performed by the controller 450.

In some examples, method 800d is performed while the integrated charger 302a is not in-use. For example, the battery can be re-charged while the integrated charger 302a is not being used to charge other external systems.

At 802d, the battery state of charge (SoC) is monitored. The battery state of charged can be monitored using various methods. For example, the controller 450 can communicate with a battery management system (BMS) of the battery 304b, which can communicate SoC information. In other examples, sensors around the battery are used to monitor the amount of charge discharged overtime, by the battery.

In some examples, the monitoring can happen continuously in the background. In other examples, the monitoring can only occur when the system is non-active, e.g., integrated charger is not operating in DC or AC charging modes.

At 804d, it is determined whether the battery SoC is below a pre-determined threshold. For example, this threshold can simply be “zero”, or any other selected threshold. The threshold can be pre-defined in the controller 450.

If not, then at 806d, the integrated charger 806c can continue normal operations (e.g., methods 800a-800c, or 800e-800f).

Otherwise, at 808d, a configuration is selected for the battery re-charging mode (FIGS. 5P-5U). The configuration can be selected based on one or more configuration selection factors for the battery re-charging mode.

By way of example, the selection factors can include: (i) determining whether an input AC supply is available—if so, one of the configurations in FIGS. 5P-5S is selected, which rely on input AC power to re-charge the battery. Otherwise, one of the configuration of FIGS. 5T-5U are selected (or a combination thereof), which do not rely on input AC power. The type of configuration can be selected based on available power supply from charger plug 308 and/or DC port 310; (ii) if AC input power is available, further determining whether the input AC power is high or low input AC power—if high input AC power is available, one of the configurations in FIGS. 5P-5Q is selected. Otherwise, the configurations of FIGS. 5R-5S are selected for low input AC power; and/or (iii) in either case, if input AC power is available, also determining whether there is sufficient power to re-charge the battery—if so, then the AC power can be relied on exclusively (FIGS. 5P and 5R). Otherwise, the battery can be re-charged using additional power sources (FIGS. 5Q and 5S).

At 810d, the integrated charger 302a is operated in the selected battery re-charging mode. Act 810d can be performed while the integrated charger is non-operational, so as to avoid interrupting any current activity.

(iv) Example Method of Operating Integrated Charger In DC Power Sharing Configuration

Reference is now made to FIG. 8E, which shows an example method 800e for operating the integrated charger 302a in a DC power sharing configuration. Method 800e can be performed by controller 450.

To this end, the DC power sharing configuration can be used to receive or transmit DC power, via DC port 310. For example, power can be received or transmitted from other integrated chargers coupled to DC port 310, or otherwise, other external DC power sources or loads. Various operation modes of the integrated charger can use a DC power sharing configuration, whereby the DC port switch 416 is closed (see e.g., FIGS. 5C, 5D, 5E, 5F, etc.).

At 802e, the integrated charger may be operated in an initial configuration mode that does not use DC power sharing. That is, any configuration where the DC port 310 is inactive, including configurations where the DC port switch 416 is open.

At 804e, controller 450 can monitor for one or more trigger events to perform DC power sharing, via DC port 310. In general, there are two types of trigger events: (i) trigger events for drawing, or receiving DC power from DC port 310; and (ii) trigger events for supplying, or outputting DC power from DC port 310.

In respect of trigger events for drawing DC power from DC port 310, this may involve determining that additional DC power is required to operate the integrated charger 302a. In other words, determining that the current available power does not satisfy the required power demand. For example, in the configurations of FIGS. 5C and 5D, power from AC port 306 is insufficient to meet the power demands of charger plug 308. Accordingly, additional DC power is drawn from DC port 310. Similar configurations are exemplified for other operation modes in FIGS. 5H, 5S, 5W, etc.

In respect of trigger events for outputting DC power from DC port 310, this can involve detecting that an external DC load is coupled to the DC port 310, and requires DC power. The external DC load can include other integrated chargers (FIG. 9C). In some examples, the trigger event can involve receiving a request from the external DC load for DC power. The request can be received by controller 450.

At 806e, a determination is made whether a trigger event was detected. If not, then the method can return to act 802e. Otherwise, at act 808e, the DC port switch 416 can be closed—or otherwise, the DC port 310 can be used without varying the switch. At 810e, the integrated charger 302a is operated in an updated configuration mode that includes DC power sharing.

It should be noted that, the DC port switch 416 may also be closed constantly. This can allow controlling the power flow between multiple integrated chargers.

(v) Example Method for Operating Integrated Charger in One or More Operational Modes

Reference is now made to FIG. 8F, which shows an example method 800f for operating the integrated charger 302a in one or more operation modes. Method 800f can be performed by controller 450.

At 802f, controller 450 can monitor for charging demands. For example, these can include demands to provide DC charging via charging plug 308 and/or DC port 310. These can also include demands to provide AC charging, via AC port 306.

At 804f, a determination is made as to whether a charging demand was received. If not, then the method can go to act 802d in method 800d, to determine whether the battery requires re-charging.

Otherwise, at act 806f, it is determined whether the charging demand is a DC or AC charging demand. If DC charging, then the integrated charger 302a can be operated for DC charging, and the method may proceed to act 802a in method 800a. Otherwise, if the charging demand is for AC charging, then method can proceed to 808c in method 800c to operate in an AC charging mode. In some examples, determining whether an AC demand is received, at act 806f, can involve performing act 802c to determine whether the one or more activation conditions are satisfied for the AC charging mode.

### V. Example Multi-Integrated Charger Systems and Associated Example Hardware Architectures for Integrated Chargers

Reference is now made to FIG. 9C, which shows a simplified block diagram for an example multi-integrated electric charging system 900. Concurrent reference is also made to FIG. 9A, which shows a schematic diagram of the system 900 and to FIG. 9E, which shows a simplified circuit diagram of the system 900.

As shown, the multi-integrated charging system 900 can include two or more integrated chargers 302₁ and 302₂, which are coupled together. The integrated chargers 302 can be coupled in sequence (e.g., daisy-chained), via their respective DC ports 310. For example, a DC bus link 902 can couple the respective DC ports 310, such that the integrated chargers 302₁, 302₂ are connected in-series. As shown in FIG. 9E, the DC port switch 416—inside each integrated charger 302—is closed to enable DC power flow.

As noted previously, the DC port 310 allows for power sharing between multiple integrated chargers 302₁ and 302₂. Various example use cases for DC port 310 were previously discussed with reference to configurations in FIG. 5.

By way of example, in one use cases, one of the integrated chargers 302 may need greater input power, to satisfy high output charging requirements. For instance, the charger plug 308, of integrated charger 302₁, may require a greater power output to service a connected EV. Accordingly, integrated charger 302₁ can draw additional DC power from integrated charger 302₂. For example, the additional DC power is drawn from the battery 304b of integrated charger 302₂, or otherwise the input AC supply from AC port 306₂ for integrated charger 302₂. The same may apply, vice-versa, to accommodate a greater power output from the charger plug 308 of integrated charger 302₂.

In other example use case, power sharing can facilitate re-charging of a battery 304b, of one of the integrated chargers 302. For example, the battery 304b in integrated charger 302₁, can be re-charged using power from integrated charger 302₂.

To this end, with power sharing—the DC link voltage in each integrated charger 302 must be controlled at a suitable level to ensure efficiency of the entire system. That is, the common DC bus voltage 414 in each integrated charger 302₁ and 302₂ should be substantially equal (e.g., ±10 VDC). This stabilization can occur via the respective controllers 450.

In some examples, controllers 450₁ and 450₂ may communicate with each other. That is, a communication link can be established between the controllers 450. This can allow the controllers 450 to coordinate and synchronize operations of the integrated chargers 302.

Examples of control information that can be exchanged between controllers 450 include, for example: (i) transmitting/receiving requests for additional DC power (see e.g., method 800e for cases where DC power sharing can be requested); (ii) providing information on available power that can be shared, e.g., in response to a received request—this can assist in power share planning; (iii) exchanging data about corresponding DC bus 414 voltage—this can enable each integrated charger 302 to synchronize their DC bus voltages to facilitate power sharing.

To this end, the DC bus voltage can be adjusted by controlling the voltage output of one or more of converters 402-406, depending on which converters are active, at a given time instance. Further, data about the existing DC bus voltage, for each charger, can also be determined based on the known voltage output settings of one or more converters 402-406. In other cases, the existing DC bus voltage is determined using sensors (e.g., voltage sensors) coupled to the DC bus 414, and in communication with controller 450.

In at least one example, a controller hierarchy is established between controllers 450₁ and 450₂. For example, controller 450₁ can be designated as the master or primary controller, while the controller 450₂ is designated as the servant or secondary controller.

In this setup, the primary controller aggregates data from its integrated charger. The primary controller also communicates with the secondary controller to aggregate data about its integrated charger. The primary controller then synchronizes operations between the two integrated chargers. For example, the primary controller generates and transmits control commands to the secondary controller to synchronize operations. The secondary controller can then execute the received control commands. For instance, the control command may instruct the secondary controller to control its respective converters 402-406 to stabilize the DC bus 414 to a desired voltage. More generally, the primary controller can also control its own integrated charger to achieve synchronized operations.

Referring back to FIG. 9C, the AC port 306—of each integrated charger 302₁ and 302₂— may be connected to the same input AC power supply. For instance, each integrated charger 302 can couple to the same electric grid input. Each integrated charger 302 can also connect to the same transformer subsystem 154 (FIG. 1B).

In other examples, as shown in FIG. 9D, each AC port 306 can couple to a different input AC power supply and/or transformer subsystem 154 (902a and 902b in FIG. 9D). In this example, the grid supplies 902a, 902b can have different voltages but should be isolated from each other. One example use case is that, in many commercial locations in North America, there may be single phase 240V supply and a three-phase 120V to 600V supply. By interconnecting the two supplies, the batteries inside the integrated chargers 302 can still be used to power the loads of both supplies to maximize the utilization of the batteries.

Referring briefly to FIG. 9B, which shows another schematic diagram of the system 900, as described previously with reference to FIG. 3A, the integrated charging systems 302 can be used to supply AC power to EVs compatible with level “2” AC charging and to support other systems requiring power, for example buildings 940, by providing power to an AC power grid via an AC bus 428, and to a level “2” integrated charging system 302, via an AC bus 428. The integrated charging systems 302 can supply AC power to an AC power grid when, for example, utilization of the integrated charging systems 302 for DCFC is low and/or when the AC power grid is experiencing a fault.

Referring now to FIG. 10, which shows an example hardware architecture for an integrated charger 302d. The hardware architecture of integrated charger 302d can further enable multi-integrated charger systems.

Integrated charger 302d is analogous to integrated charger 302c (FIG. 7B), however the integrated charger 302d now includes the switch port 312 (see e.g., switch port 312 in FIG. 3A). Switch port 312 is coupled to the switch network 750, e.g., via switch port bus 1050.

Switch port 312 can facilitate scalability of the integrated charger 302d. For example, similar to DC port 310—the switch port 312 can couple to other switch ports 312, of other integrated chargers 302. In some examples switch port switch 706 can be opened or closed to engage, or disengage the switch port 312.

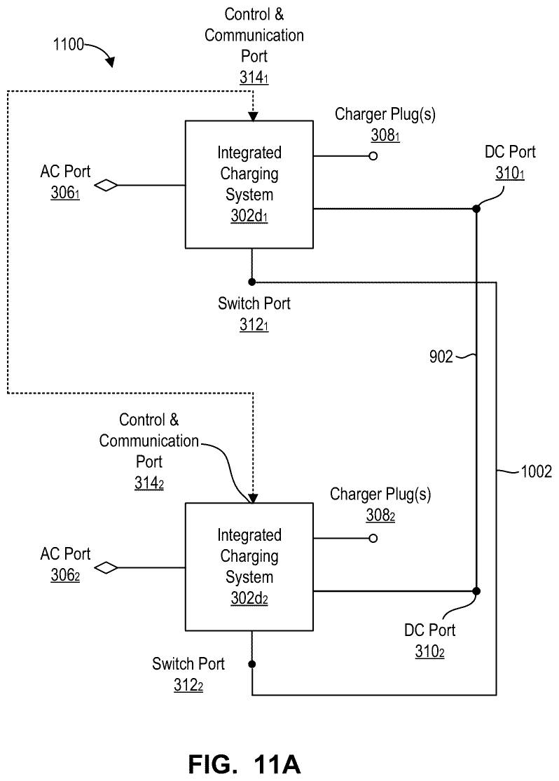

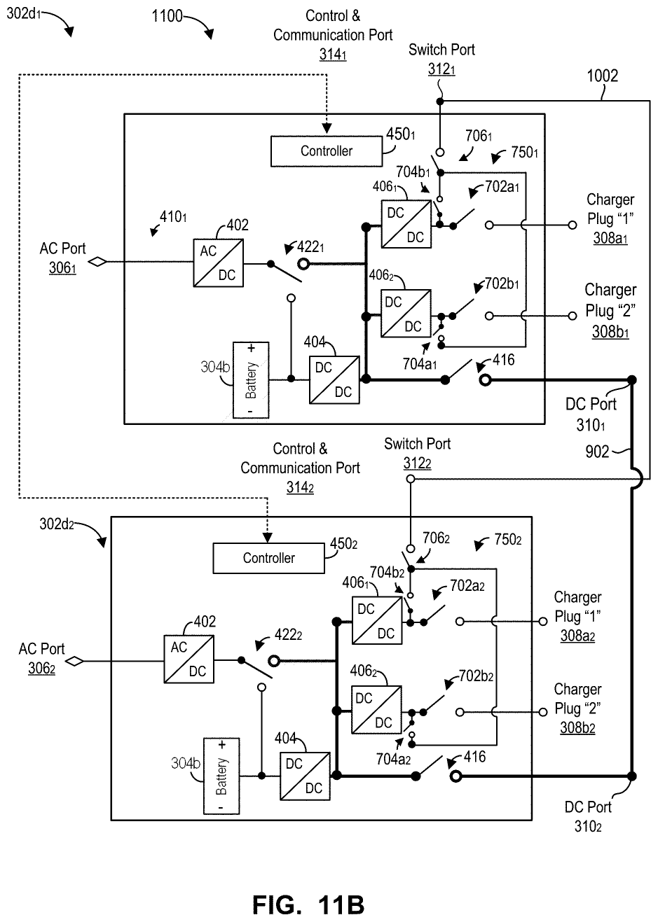

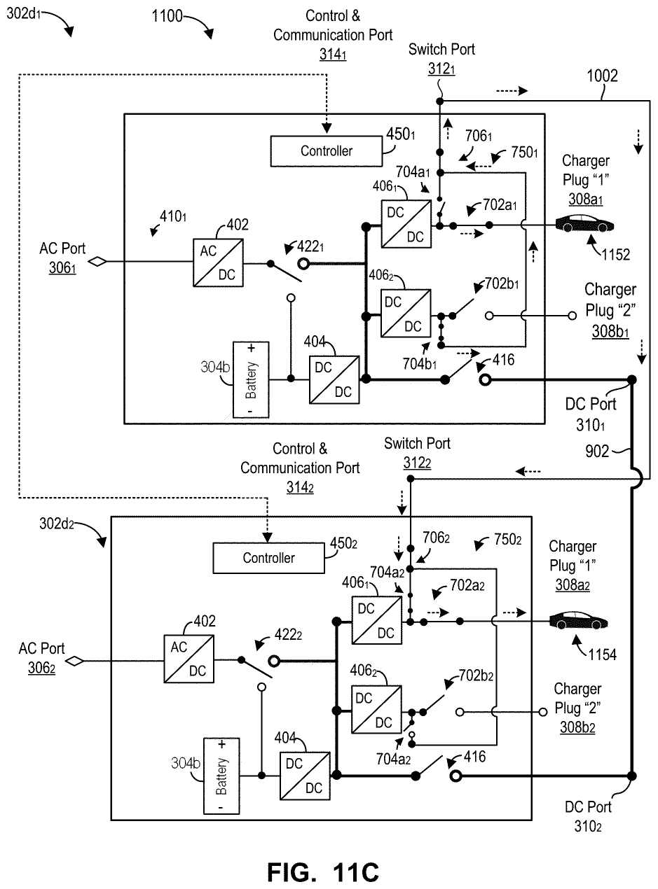

Reference is now made to FIGS. 11A-11C, which shows another example multi-integrated charging system 1100.

In this example, in addition to, or in the alternative, to coupling the DC ports 310—charging systems 302 are also coupled via their respective switch ports 312. This may enable enhanced power sharing between multiple integrated chargers 302.

In more detail, by connecting the integrated chargers 302 at their switch ports 312, the systems 1100 can also flexible direct power between different DC/DC charging converters 406, to different charging plugs 308.

To this end, the switch networks 750₁ and 750₂, of each integrated charger 302₁ and 302₂, may be operated in different switch network configurations. Different switch network configurations can achieve different power sharing outcomes. For example, different switch network configurations make it possible to have additive cumulative power output at plugs 308₁-308ₙ.

To illustrate one example use case for power sharing via the switch port 312—reference is made to FIG. 11C. As shown, a first EV 1152 is plugged-into charger plug “1” 308a₁, of first integrated charger 302d₁. Further, a second EV 1154 is plugged-into charger plug “1” 308a₂, of second integrated charger 302d₂.

In this example, the first EV 1152 is charged using only power the first integrated charger 302d₁. In other words, as per default operation—the corresponding charger plug switch 702a₁ is closed to connect DC/DC converter 406₁ to charger plug “1” 308a₁. In this manner, the first EV 1152 is charged using DC/DC converter 406₁.

In contrast to the first EV 1152, however, the second EV 1154 may have a higher power demand requirement. In particular, it may be insufficient to power the second EV 1154 using only power from the corresponding DC/DC charger 406₁. Rather, power sharing may be necessary. That is, the second EV 1154 may need additional power from the first integrated charger 302d₁.

Accordingly, to accommodate for the second EV 1154, the switch configuration of switch networks 750₁ and 750₂ is modified. More particularly, the switch network configuration is modified such that the second EV 1154 not only couples to its respective DC/DC converter 406₁, but also couples to the DC/DC charger 406₂ in the first integrated charger 302₁.

For example, the following switch network configuration can be used: (i) first, the switch port switches 706₁ and 706₂, in each integrated charger 302, may be closed. This couples together the integrated chargers 302 via the switch port link 1002; (ii) second, inside the first integrated charger 302₁—switch 704a₁ is closed. This couples the DC/DC converter 406₂ inside the first integrated charger 302₁, to the switch port 3121; (iii) third, inside the second integrated charger 302₂—switches 704b₂ and 702a₂ are closed. This couples the second EV 1154 to the switch port 312₂, as well as to the DC/DC converter 406₁ inside the second integrated charger 302₂.

Accordingly, in this manner, the second EV 1154 receives increased power from both the DC/DC converter 406₂ inside the first integrated charger 302₁, as well as DC/DC converter 406₁ inside second integrated charger 302₂.

To this end, different subsets of integrated charging systems 302d can be combined, and linked through their respective switch networks 750 and DC switches.

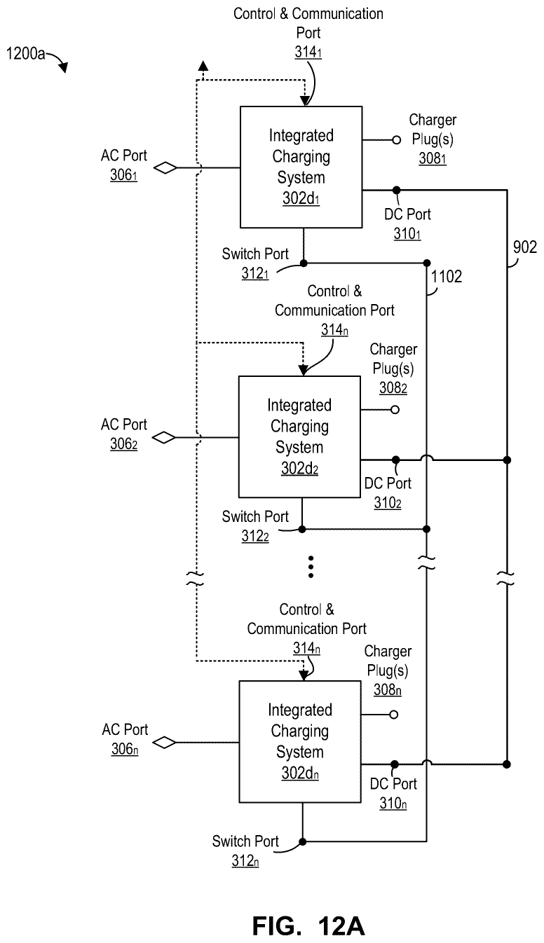

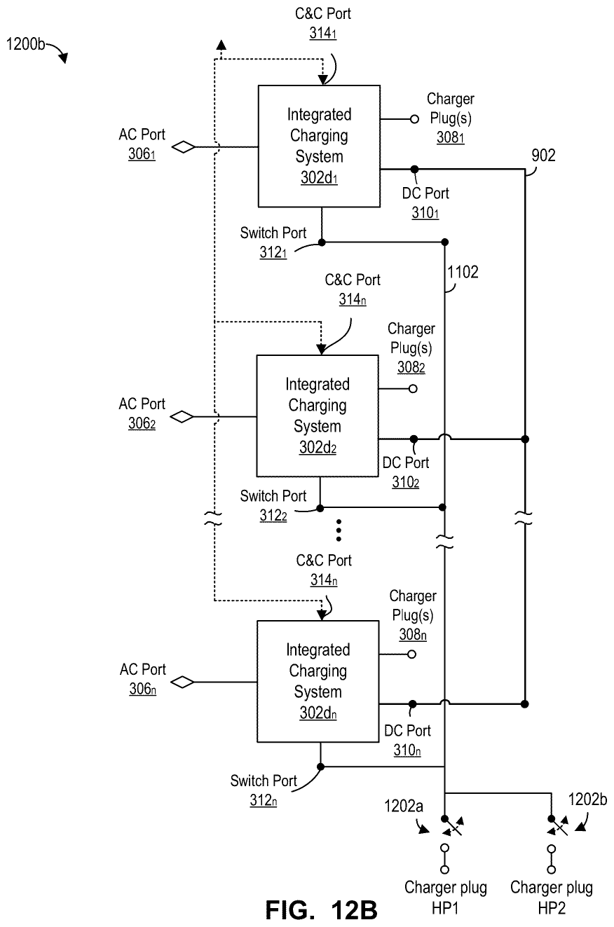

In some examples, depending on the expected maximum output power, the cable size of the charger plug 308 may need to be selected properly. In at least one example, for the case with N integrated chargers 302 interconnected as shown in FIG. 12A, the maximum charging power may be the sum of two integrated chargers 308d. That is, each charger plug 380 can be designed to only handle combined output of two integrated chargers sharing power. Accordingly, only a maximum of four DC/DC converters 404 can be grouped through the switch network 750, assuming the switch network connects two DC/DC converters.

In at least one example, charger plugs 308 may not be designed to handle higher charging power output. In this case, as shown in FIG. 12B, additional high power charger plugs 1202a, 1202b can be added to the system. For the case with N integrated chargers, the high power plugs 1202a, 1202b can be sized to support the maximum power of all charging modules.

### VI. Example Method for Operating Multi-Integrated Charger System

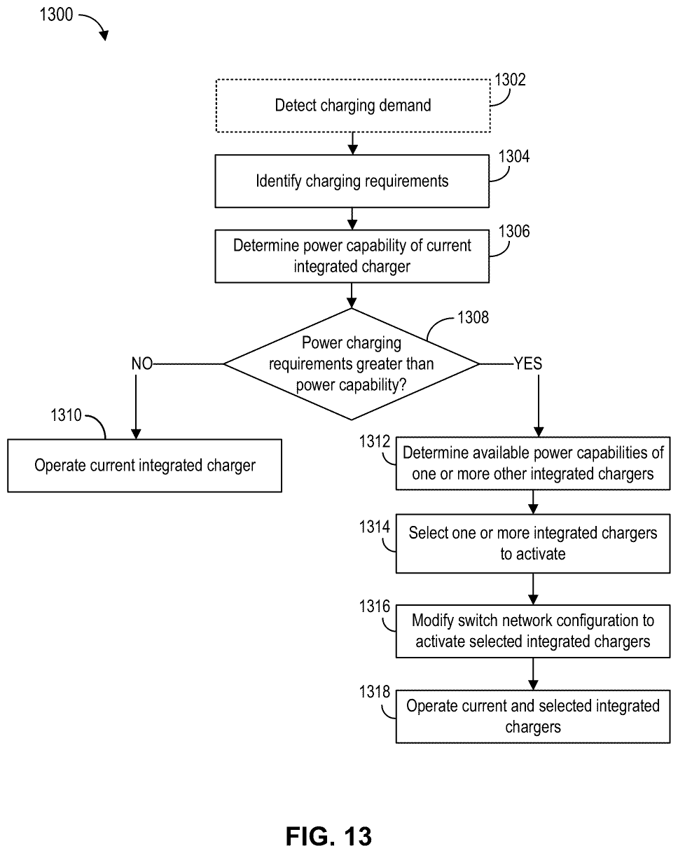

Reference is now made to FIG. 13, which shows an example method 1300 for operating multi-integrated charger systems (e.g., as shown in FIGS. 11-12). Method 1300 can be performed by a controller 450.

At 1302, in some examples, a charging demand is received (or detected) by an integrated charger 302 at a charger plug 308.

At 1304, the charging requirements are identified for the charging demand. For example, this can include determining the necessary output DC voltage, and necessary power output level from charger plug 308.

At 1306, the power capability of the integrated charger 302—associated with the charger plug 308—are determined. For example, this can involve determining how much AC power is available from AC port 306 of the integrated charger, and the state of charge of battery 304b.

The available AC power can be determined based on external information communicated to controller 450, or otherwise using one or more sensors 410 (FIGS. 4A and 4B). The battery state of charge can be determined by communicate with a battery management system (BMS) of battery subsystem 304b and/or using one or more sensors positioned around the battery 304b.

At 1308, a determination is made as to whether the power charging requirements are greater than the charger's power capability. If this is the case, then additional DC power, from other integrated chargers 302, may be required.

If the determination at 1308 is negative, then no DC power sharing is performed—and at act 1310, only the existing integrated charger is used.

Otherwise, at 1312, the available power capabilities of one or more other integrated chargers—coupled via DC port 310 and/or switch port 312—are determined. For example, the power capabilities can be communicated from the respective controllers 450, of these integrated chargers.

At 1314, based on act 1312, one or more integrated chargers 1312 are selected for activation, to meet the power charging requirements. For example, one or more integrated chargers that have sufficient available power capability are selected.

At 1316, the switch network configuration is modified to re-route power from the selected integrated chargers to the target charger plug 308.

At 1318, the current and selected integrated chargers are operated, e.g., by their respective controllers.

### VII. Example Applications of Multi-Integrated Charger Systems

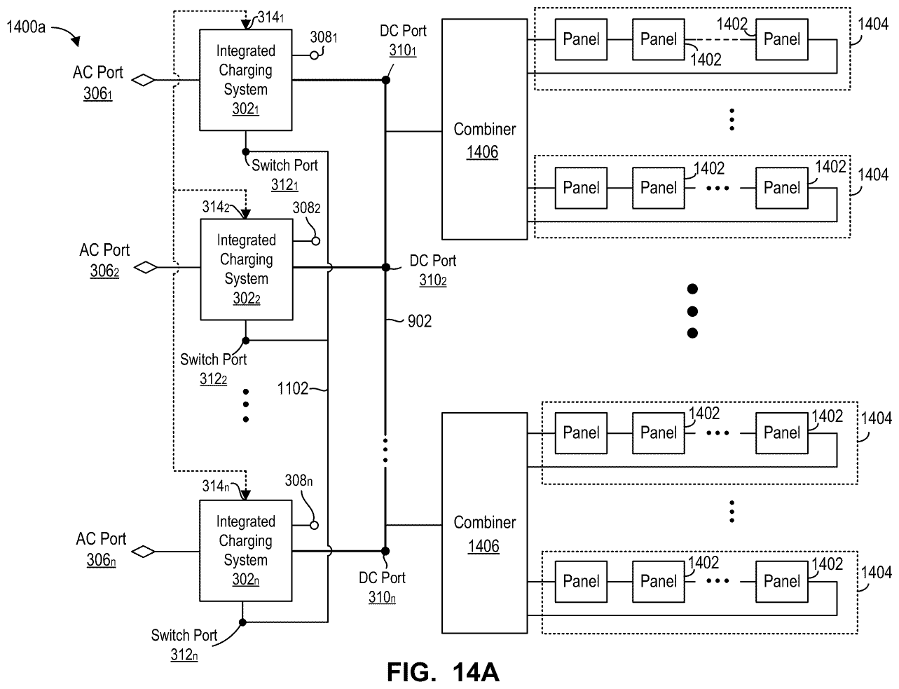

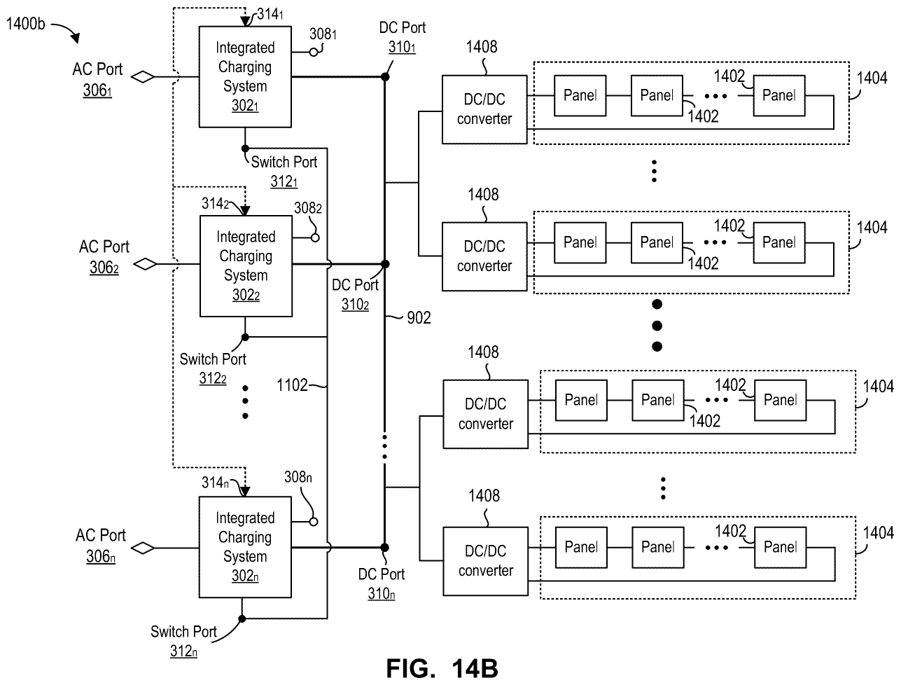

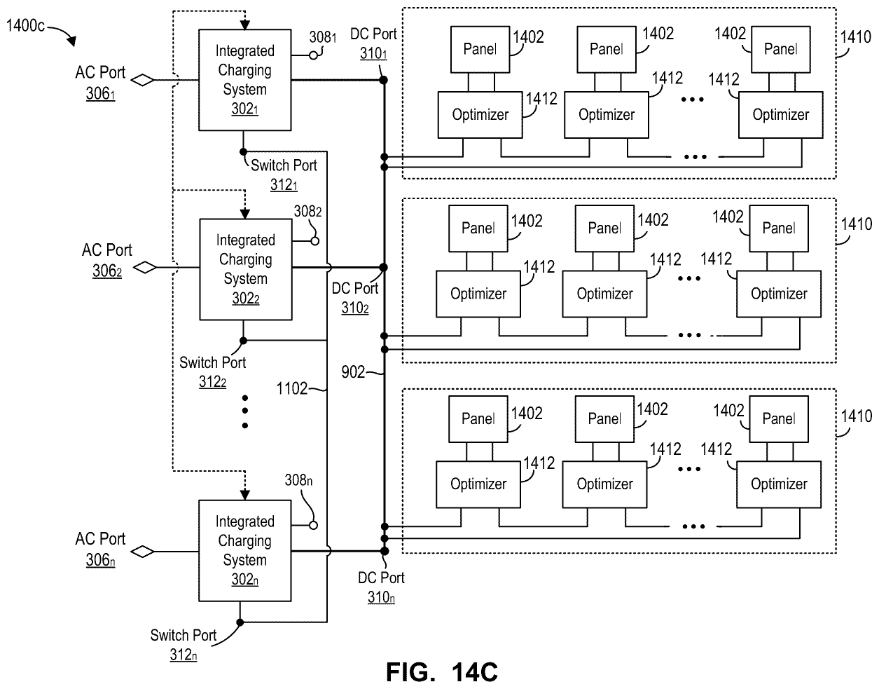

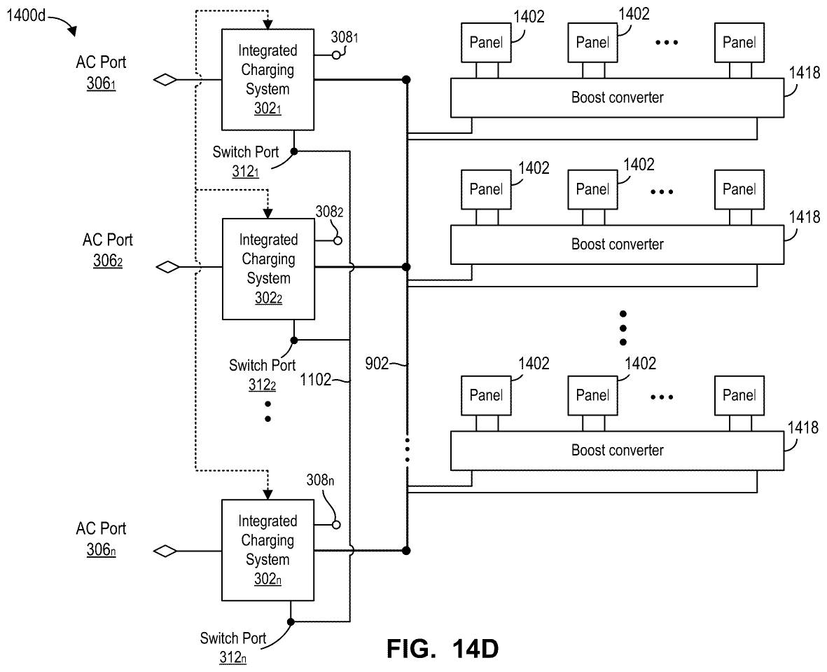

Reference is now made to FIGS. 14A-14D, which show various example applications for a multi-integrated charger system. The exemplified systems allow for DC power sharing, using a common DC bus 902.

More particularly with a stable DC link available, the multi-integrated charger architecture can be directly coupled with additional solar PV systems at the DC link 902. The solar PV panels can be connected to the DC link through various methods.

For example, FIG. 14A shows an example system 1400a that directly connects solar panels 1402 in series to form a PV string 1404. Multiple PV strings 1404 can be connected in parallel through a combiner 1406, which then connects to the DC link 902. The panels 1402 can provide additional DC power to one or more of the integrated charters 302₁-302ₙ.

FIG. 14B another example system 1400b that uses power converters to coupled PV systems with integrated chargers 302. This architecture adopts DC-DC converter 1408 to interface each solar string 1404. The strings 1404 are then paralleled and connected to the DC link 902.

FIG. 14C shows still another example system 1400c with integration of solar PV systems 1402. In this example, optimizers 1412 connect solar panels 1402 in series. With this approach, the PV string 1410 will have a stable voltage regardless of the voltages of the panels 1402. As such, the PV system will not affect the operation of the integrated chargers 302.

It should be noted that system 1400c only shows an example of the PV optimizer-based solution which only connects one solar panel 1402 with one optimizer 1412. In other examples, one optimizer 1412 can also be used to connect multiple solar panels 1402 in series.

FIG. 14D shows still yet another example system 1400d for integration of solar PV systems 1402. In this example, power electronics 1418 couple solar panels 1402 with the DC link 902. With this approach one or multiple solar panels 1402 can be connected to a DC/DC boost converter 1418, which boosts the voltages of the solar panels to the voltage of the DC link. This ensures a stable DC link voltage within each integrated charger 302.

### VIII. Example Controller Systems for Multiple Integrated Chargers

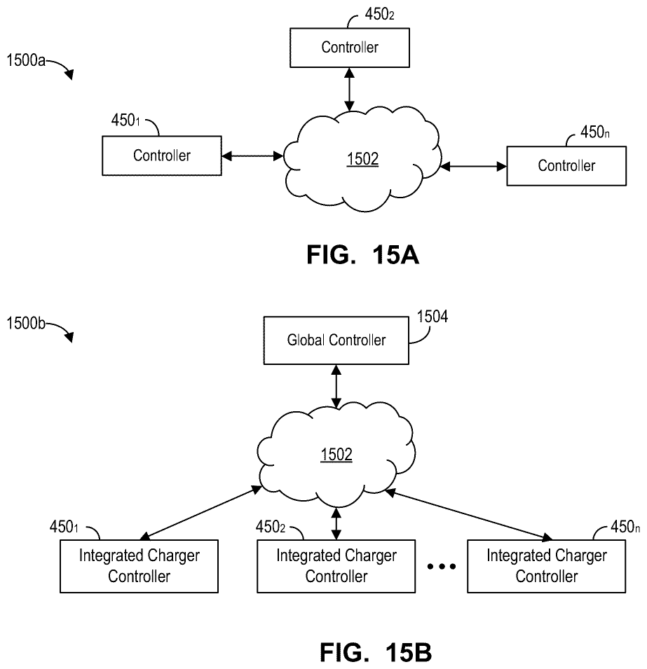

Reference is now made to FIGS. 15A-15B, which show example controller systems 1500a, 1500b for multi-integrated charging systems. The controller systems 1500a, 1500b can be used for coordinating control between multiple coupled integrated chargers (see e.g., FIGS. 9-14).

FIG. 15A shows a first example system 1500a that includes a plurality of controllers 450₁-450ₙ, each associated with a different integrated charger 302. This may be referred to herein as a distributed controller architecture.

In this example, the controllers 450 communicate via network 1502. In this example, coordination is effected through distributed communication between multiple controller 450. In some cases, as described above, one or more controllers can be designated as the primary, master controllers, while the other controllers can be designated as secondary, server controllers.

FIG. 15B is another example controller system 1500b for multiple integrated chargers. This system can be referred to herein as a centralized controller architecture. In this example, a global controller 1504 is provided which manages and coordinates operation of multiple local, integrated charger controllers 450₁-450ₙ.

Network 1502 may be a wired or wireless network connection. In some examples, network 1502 can be connected to the internet. Typically, the connection between network 1502 and the Internet may be made via a firewall server (not shown). In some cases, there may be multiple links or firewalls, or both, between network 1502 and the Internet. Some organizations may operate multiple networks 1502 or virtual networks 1502, which can be internetworked or isolated. These have been omitted for ease of illustration, however it will be understood that the teachings herein can be applied to such systems. Network 1502 may be constructed from one or more computer network technologies, such as IEEE 802.3 (Ethernet), IEEE 802.11 and similar technologies.

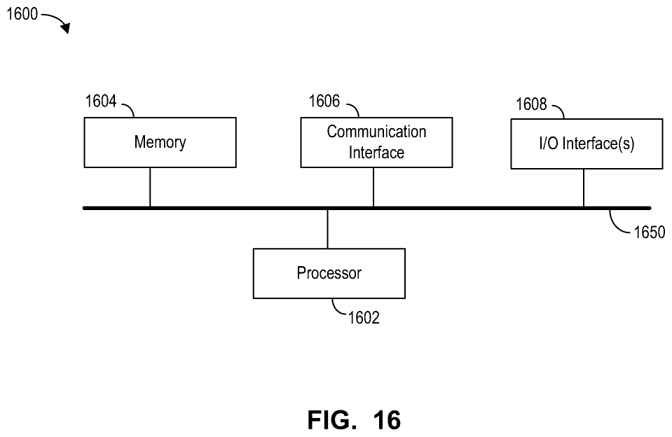

FIG. 16 is a simplified hardware block diagram for an example integrated charger controller 1600. The illustrated hardware block diagram can apply to both local controllers 450 inside integrated chargers 302, as well as to the global controller 1504.

As shown, the controller 1600 includes a processor 1602 coupled, via data bus 1650, to one or more of a memory 1604, communication interface 1606 and one or more I/O interface(s) 1608.

Processor 1602 is a computer processor, such as a general purpose microprocessor. In some other cases, processor 1602 may be a field programmable gate array, application specific integrated circuit, microcontroller, or other suitable computer processor. While only a single processor 1602 is exemplified, it will be understood that processor 1602 may comprise any number of processors (e.g., parallel processors, etc.). Accordingly, reference to processor 1602 performing a function or operation may be understood to refer to any number or subset of processors 1602 performing that function or operation, concurrently, partially concurrently and/or non-concurrently.

Processor 1602 is also coupled, via a computer data bus, to memory 1604. Memory 1604 may include both volatile and non-volatile memory. Non-volatile memory stores computer programs consisting of computer-executable instructions, which may be loaded into volatile memory for execution by processor 1602 as needed. It will be understood by those of skill in the art that references herein to a controller as carrying out a function or acting in a particular way imply that processor 1602 is executing instructions (e.g., a software program) stored in memory 1604 and possibly transmitting or receiving inputs and outputs via one or more interface. Memory 1604 may also store data input to, or output from, processor 1602 in the course of executing the computer-executable instructions.

Communication interface 1606 is one or more data network interface, such as an IEEE 802.3 or IEEE 802.11 interface, for communication over a network (e.g. network 1502).

I/O interface(s) 1608 can be any interface used to couple controller 450 to other systems, devices and electrical hardware (e.g., power converters, switches, etc.). Control and data signals can be transmitted and received via the I/O interface(s) 1608.

Various embodiments in accordance with the teachings herein are described herein to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

It should also be noted that the terms “coupled” or “coupling” as used herein can have several different meanings depending in the context in which these terms are used. For example, the terms coupled or coupling can have a mechanical, fluidic or electrical connotation. For example, as used herein, the terms coupled or coupling can indicate that two elements or devices can be directly connected to one another or connected to one another through one or more intermediate elements or devices via an electrical or magnetic signal, electrical connection, an electrical element or a mechanical element depending on the particular context. Furthermore coupled electrical elements may send and/or receive data.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a group of elements are said to ‘collectively’ perform an act where that act is performed by any one of the elements in the group, or performed cooperatively by two or more (or all) elements in the group.

As used herein and in the claims, a first element is said to be “received” in a second element where at least a portion of the first element is received in the second element unless specifically stated otherwise.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Exemplary communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The example systems and methods described herein may be implemented as a combination of hardware or software. In some cases, the examples described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

Some elements that are used to implement at least part of the systems, methods, and devices described herein may be implemented via software that is written in a high-level procedural language such as object-oriented programming. The program code may be written in C++, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having at least one processor, an operating system, and the associated hardware and software that is used to implement the functionality of at least one of the methods described herein. The software program code, when read by the device, configures the device to operate in a new, specific, and predefined manner (e.g., as a specific-purpose computer) in order to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. An integrated electric charging system, comprising:
an energy storage subsystem for storing direct current (DC) power;
a charging subsystem coupled to the energy storage subsystem and comprising:
a common DC bus;
one or more power converters, each power converter having a DC side couplable to the common DC bus, the one or more power converters being operable to maintain a voltage of the common DC bus at a pre-defined DC voltage level; and
at least one operational switch interposed between the one or more power converters, wherein the operational switch varies an operational mode of the integrated charging system; and
at least one port coupled to the charging subsystem and operable for discharging or receiving one or more of direct current (DC) and alternating current (AC) power.

2. The system of claim 1, wherein the at least one port includes an AC port and one or more DC ports, wherein,
the AC port is couplable to one of an AC power supply or AC load, and
the one or more DC ports is couplable to one of a DC power supply or a DC load.

3. The system of claim 2, wherein one or more DC ports include a charging DC port and a DC power sharing port.

4. The system of claim 3, wherein the one or more power converters include at least one AC/DC converter, and one or more DC/DC converters.

5. The system of claim 4, wherein the one or more power converters include at least one AC/DC converter, one or more first DC/DC converters and a second DC/DC converter.

6. The system of claim 5, wherein the at least one AC/DC converter comprises an AC side and a DC side, wherein,
the AC side is coupled to the AC port, and the DC side is coupled to the at least one operational switch.

7. The system of claim 3, wherein the one or more first DC/DC converters comprises a first DC side and a second DC side, wherein,
the first DC side is coupled to the common DC bus, and the second DC side is coupled to the charging DC port via a charger-specific DC bus.

8. The system of claim 7, wherein the one or more first DC/DC converters comprise two or more first DC/DC converters each coupled to a respective charging DC port via the charger-specific DC bus.

9. The system of claim 8, wherein a switch network couples together the charging-specific DC busses for one or more charging DC ports, and wherein,
the switch network has a switch network configuration that is adjustable to re-route DC power from a second DC side of one or more of the plurality of first DC/DC converters to another charger-specific DC bus.

10. The system of any one of claim 9, wherein the one or more ports further includes a switch port coupled to the switch network, and the switch port is couplable to the switch network of other integrated electric charging systems.

11. The system of claim 6, wherein the second DC/DC converter comprises a first DC side and a second DC side, wherein,
the first DC side is coupled to the energy storage subsystem, and the second DC side is coupled to the common DC bus.

12. The system of claim 6, wherein the operational switch is adjustable between a first closed position and a second closed position, wherein,
in the first closed position, the operational switch couples the at least one AC/DC converter to the common DC bus; and
in the second closed position, the operational switch couples the at least one AC/DC converter in parallel to the energy storage subsystem.

13. The system of claim 1, wherein the system is operational in one of: (i) one or more DC charging modes, (ii) an AC charging mode, and (iii) a re-charging mode.

14. The system of claim 13, wherein the one or more DC charging modes comprise: (i) a first DC charging mode using a high input AC voltage, and (ii) a second DC charging mode using a low input AC voltage mode.

15. The system of claim 14, wherein in the first DC charging mode, the charging subsystem receives input AC power from the AC port, and discharges DC power from the one or more DC ports, the system operating in the first DC charging mode when the input AC voltage is above a pre-determined threshold.

16. The system of claim 13, wherein the first DC charging mode, the operational switch is in the first closed position.

17. The system of claim 15, wherein first charging mode includes one or more configurations which use DC power stored in the energy storage subsystem to compensate for low input AC power.

18. The system of claim 15, wherein in the second DC charging mode the charging subsystem discharges DC power from the one or more DC ports, the system being operated in the second DC charging mode when the input AC voltage is below a pre-determined threshold.

19. The system of claim 18, wherein in the second DC charging mode the operational switch is in one of the second closed position or an open position.

20. The system of claim 11, wherein in the AC charging mode, the charging subsystem discharges AC power from the at least one AC port.

21. The system of claim 3, wherein the DC sharing port is coupled to external DC loads and DC power sources.

22. The system of claim 21, wherein the DC sharing power couples the system to other integrated charging systems via a DC link to allow for DC power sharing.

23. The system of claim 21, wherein the DC link is coupled to one or more PV systems.

24. The system of claim 1, wherein the energy storage subsystem comprises one or more rechargeable battery cells.

25. The system of claim 1, further comprising a controller coupled to the one or more power converters and the at least one operational switch.

26. (canceled)

27. An integrated electric charging system, comprising:
one or more energy storage subsystems for storing direct current (DC) power;
a charging subsystem coupled to the one or more energy storage subsystems and comprising:
a common DC bus;
one or more power converters, each power converter having a DC side couplable to the common DC bus, the one or more power converters being operable to maintain a voltage of the common DC bus at a pre-defined DC voltage level; and
at least one operational switch interposed between the one or more power converters, wherein the operational switch varies an operational mode of the integrated charging system; and
at least one port coupled to the charging subsystem and operable for discharging or receiving one or more of direct current (DC) and alternating current (AC) power; and
a controller coupled to the one or more power converters and the at least one operational switch.

28. The system of claim 27, wherein the common DC bus comprises a stable DC voltage bus.

29. The system of claim 27, wherein at least one energy storage subsystem of the one or more energy storage subsystems is coupled to the charging subsystem via the common DC bus.

30. The system of claim 27 operable to inject power into an electric grid, wherein the electric grid comprises one of a single phase 240V supply and a three-phase supply supplying voltage operating in a range comprising of 120V to 600V.

31. The system of claim 27, wherein the at least one port coupled to the charging subsystem comprises one or more AC ports and wherein the system is operable to discharge AC power from at least one energy storage subsystem from the one or more energy storage subsystems to the electric grid via the one or more AC ports.

32. The system of claim 27, wherein the at least one port coupled to the charging subsystem comprises one or more DC ports, and at least one DC port of the one or more DC ports comprises DC power sharing port coupled to one or more photovoltaic systems via a DC link.

33. The system of claim 29 is operable to draw DC power from a battery of an electric vehicle, convert the DC power via the one or more power converters and supply an AC power to an electric grid via the one or more AC ports.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. A multi-integrated electric charging system comprising:
two or more electric charging systems according to claim 1, wherein the DC common bus of each of the two or more electric charging systems couples to the DC common bus one or more other electric charging systems.
